(19) United States
(12) Patent Application Publication
(10) Pub. No.: US 2005/0108045 A1
(43) Pub. Date: May 19, 2005

(54) Method of network hospital of reclassification of diseases that have been made a diagnosis

(76) Inventors: Jiao Gong, Arcadia, CA (US); Wei Jiang, Arcadia, CA (US)

Correspondence Address: JIAO GONG, 411 S. 3RD AVE #B, ARCADIA, CA, 91006, US

(21) Appl. No.: 10/714,312

(22) Filed: Nov. 17, 2003

(51) Int. Cl. G06F 17/60

(52) U.S. Cl. 705/2

(57) ABSTRACT

This invention relates to a kind of innovative technology, i.e. adopt computer FD, keyboard operating system to express the health information in the software dictionary via screen and make health result obtained. Input the disease, symptom, subtype, treatment principle, knocking code of formula, keyboard and key position for selecting and enquiring personal health condition and finding the treatment scheme which belongs to word coding technology. Through code and enquiry on the screen, medical scientific innovative system is formed to carry out the re-classified treatment to the same disease, different symptom by intelligentization. The word coding character and keyboard character by using coding method is realized to be corresponding with information shown on the screen in the structure.

### BACKGROUND OF INVENTION

The patent for invention “A Method of Network Hospital of Reclassification of Diseases That Have Been Made a Diagnosis” is invented and innovated according to the “Examination Standard for the Invention Related to Computer” issued by USPTO in 1996. This invention belongs to a series of the specific operational procedures executed on a computer or by using a computer, which convert the following items into code: 40 kinds of diseases, symptoms of 40 kinds of diseases, symptoms of reclassification of 40 kinds of diseases, classification and classification principle of treatment of 40 kinds of diseases, as well as the label of prescription of health complementary products of treating 40 kinds of diseases, and the label of prescription of health complementary products of treating 30 kinds of reclassification of diseases. Through clicking the keyboard and key mapping to call out and inquire about the different symptom, health information of different classification of every individual so as to receive the treatment result of every individual, which meets the needs of American for the health service of individualization. This invention belongs to the technology of method of the literal code and is the method of legal subject.

The invention involves in a kind of innovative technology that uses the floppy disk and keyboard operation system of computer to display the information of the software data and dictionary on the display and to convert the graphic and literal information of the following items into code: disease, symptom, classification, prescription label. Through clicking the code (keyboard and key mapping) to call out and inquire about the individual health information to consult the contents about the different symptom, classification, individualization therapeutic methods of same kind of disease. Through coding, inquire about and consult the contents of individual health and therapeutic methods on the display.

In 1996, USPTO issued “Examination Standard for the Invention Related to Computer”. The examination standard of object and functional description of patent application is a functional material and character of computer program and data structure and etc., which are the information that can be fetched by a computer. If containing a data structure that has built a functional or structural relationship between data and object that fulfills the program functions, the carrier that can be fetched by a computer will be regarded as an object that belongs to an object legally protected by the patent law. And also, if containing a data structure that has built a functional or structural relationship between data and object that fulfills the program functions, an object that can be fetched by a computer will be one of kinds of legally protected objects. The encoding method feature of graphics and character in this patent has a one-to-one correspondence with the keyboard feature, definition of every key mapping, and position of each key mapping in the entire key mapping in the use of encoding method, which meets the requirements of “Examination Standard for the Invention Related to Computer”.

In 1821, Charlbs Babbage invented the first computer. In 1975, Stephen Jobs and Steve Wozniak invented the personal computer with display, built-in keyboard and magnetic disc storage, which is called as Apple. This invention made the computer popular all over the world. For some special reason, people link the computers to share information. Since 1990's, the computer has bee widely used in the society and commerce and people have built up the Internet. Using computer, server and router, people handle the business of Internet, which makes information pass unimpeded. These networks, organizations and computers form a world of Internet. The change and technical innovation of Internet changes life style of people and also changes our world.

The Internet and computer have entered every field of the society, commerce and family and the time when people sit before the computer is increasingly longer than before. How to know health state of people by themselves through computer and Internet is the general requirement of people brought out by network culture. People need the “network” with the real significance.

The consulting systems for health in the Internet can be classified to two classifications. The first classification is the consulting systems for health that replace the fax function. And second classification is the consulting systems for health that replace the consultation system. These systems are short of the innovation and increase of the original function of computer program and the Internet, which has little advantage comparing with the orthodox method.

### BRIEF SUMMARY OF THE INVENTION

The America Common Law 103-417, the Edible Complementary Goods Law 1994 and Congressional ruling point out: that to promote the health state of American people is the first matter of the country; American people's need to get the knowledge and information of a long time health is increasing ceaselessly and people pay more and more attention to themselves' health state; combined with medical care, to promote the health and life style with health and to increase man's life span; To reduce hospitalization costs is the most important to the future and economic advance of the country; To appropriately supplemental nutrition to reduce the chronic diseases and reduce the medical care expenses; health's eating and drinking perhaps does not have to spend expensive hospitalization costs and avoid the unnecessary operation. These law articles are exactly the basis for invention of patent “A Method of Network Hospital of reclassification of Diseases That Have Been Made a Diagnosis”.

There are differences among human bodies and among diseases. For this reason, people have the needs of individualization health service. People's constitutions are different. When people suffer from same disease, their classification and symptom are also different. To scientifically reclassification according to the specific condition of the individual is the important task of medicine research of America and also is the need of American people for health. This is a problem that this patent tries to probe into and solve.

The following is the important invention to nonobviousness: to make reclassification to disease with confirmed diagnosis by the network and computer intelligence, using computer intelligence to select combined goods of health complementary goods according to symptom of individual and prescribe the right remedy for an illness. This patent will solve several important difficult problems in the fields of medical and pharmacological science in America, which are problems that American people want to solve but do not solve. The United States patent law uses the nonobviousness and requires the patent have a enough practicability and importance. In the practices of patent judgment, American court creates and formulates the innovation standard to surpass and to go beyond novelty evaluation.

383 U.S.1. 148 USPQ, 459 (1966) of America Supreme Court explains who to judge the nonobviousness of a patent according to Clause 103 of America Patent Law. To take the difficult problem that people want to solve but do not solve in a long time and other people's unsuccessfulness as a kind of mark: indicia This patent for invention can meet the requirements of America Patent Law.

### BRIEF DESCRIPTION OF THE SEVERAL VIEWS OF THE DRAWING TABLE OF CONTENTS

Table 1 The Member Form for Applying for Membership in Network Hospital
Table 2 The table of an account in member's own words
Table 3 The confirmation for the disease that is diagnosed by the doctor and you admit to suffer from
Table 4-Table 43 The reconfirmation for one of 40 kinds of diseases
Table 44-Table 83 The reconfirmation for symptom selection and reclassification of one of 40 kinds of diseases
Table 84-Table 123 The reconfirmation for reclassification and principle of treatment of one of 40 kinds of diseases
Table 124 The intellectualized treatment program of after reclassification to Macula resolving and acne
Table 125-Table 164 The health complementary goods label of treatment being correspondence with 40 kinds of diseases

Table 165-Table 194 The health complementary goods label of treatment being correspondence with 30 kinds of diseases

TABLE 1
The Member Form for Applying for
Membership in Network Hospital

| E-mail | | Real Name (complete it according to |
|---|---|---|
| | | standard format;) |
| Sex | | Date of Birth |
| Nationality | | Real and detailed address of the family |
| Telephone | | Passport Number |
| Fax | | Contacting people |
| Name in Computer | | Password |
| Do you aeree to | YES | Determinate number of the member |
| the agreement? | NO | |

TABLE 2
The table of an account in member's own words
I would like to answer the following questions:

| | |
|---|---|
| 1. | Where do you feel unwell in your body and |
| | what kind of disease do you suffer from? |
| 2. | Which hospital or doctor made a definite |
| | diagnosis for the disease you suffer from? |
| 3. | What kind of disease you suffered from did |
| | they diagnose? |
| 4. | When did you begin to suffer from the |
| | disease? |
| 5. | What cardinal symptom do you have? |
| 6. | What therapeutic methods or what kind of |
| | medicine did you use for treating your |
| | disease? |
| | What about the curative effect? |
| 7. | What kind of other diseases did you suffer |
| | from before? |
| 8. | Would you like to accept this network |
| | hospital's treatment and advice about |
| | health? |

TABLE 3
The diagnosis of the doctor and your acknowledgement for the disease you suffer from

| | | | | | | | |
|---|---|---|---|---|---|---|---|
| A1 | Macula | A2 | Senile | A3 | Anemia | A4 | Neurasthenia |
| | Resolving and acne | | cretinism | | | | |
| A5 | Arthritis | A6 | Tracheal | A7 | Vaginitis | A8 | Long |
| | | | catarrh | | | | Term apocamnosis |
| A9 | Rheum | A10 | Coronary | A11 | Diabetes | A12 | Dermatosis |
| | | | Heart disease | | | | |
| A13 | Elevated | A14 | Decline of | A15 | Cholecystitis | A16 | Edema |
| | Blood fat | | Sexual function | | | | |
| A17 | Traumatic | A18 | Hemorrhoid | A19 | Hepatitis | A20 | Hypertension |
| | injury | | | | | | |
| A21 | Diarrhea | A22 | Pain | A23 | Nephritis | A24 | Dyspepsia |
| A25 | Climacteric | A26 | Headache | A27 | Osteoporosis | A28 | Obesity |
| | syndrome | | | | | | |
| A29 | Hyperplasia | A30 | Cough | A31 | Stomach | A32 | Menalgia |
| | of mammary glands | | | | pain | | |
| A33 | Prostatic | A34 | Haryngitis | A35 | Hyperosteogeny | A36 | Rhinitis |
| | hyperplasia | | | | | | |
| A37 | Sequela of | A38 | Presenility | A39 | Low grade | A40 | Carbuncle |
| | apoplexy | | | | fever | | And sore |

TABLE 4
The acknowledgement of macula resolving and acne

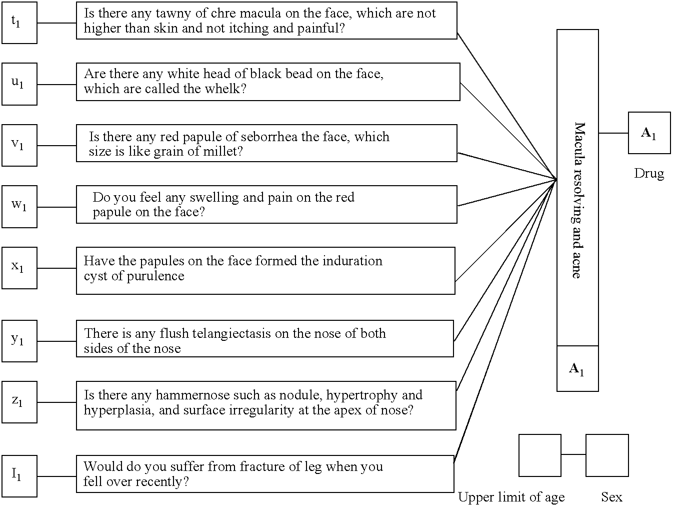

TABLE 5
The acknowledgement of senile cretinism

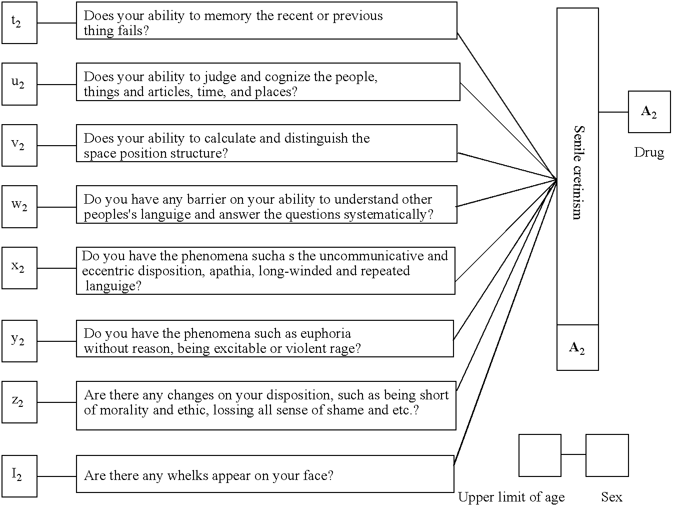

TABLE 6
The acknowledgement of anemia

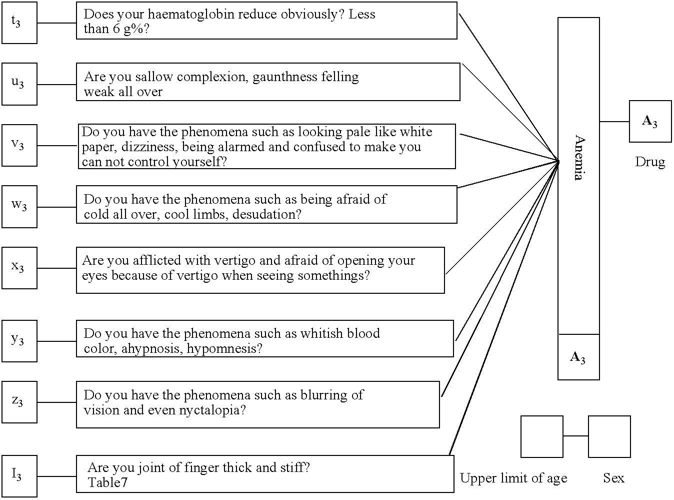

TABLE 7
The acknowledgement of neurasthenia

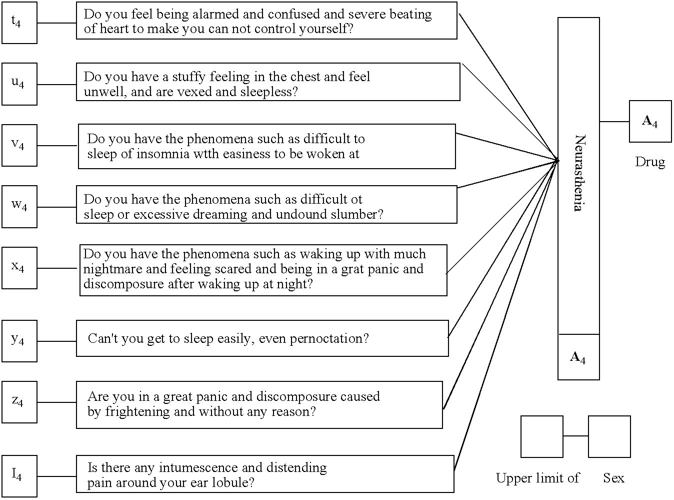

TABLE 8
The acknowledgement of arthritis

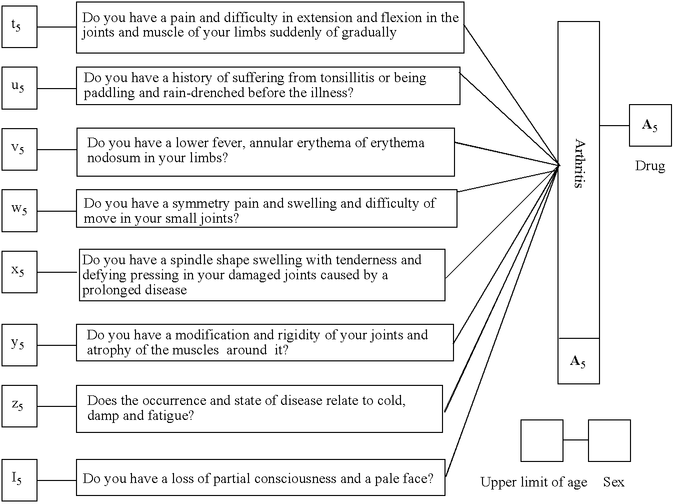

TABLE 9
The acknowledgement of tracheal catarrh

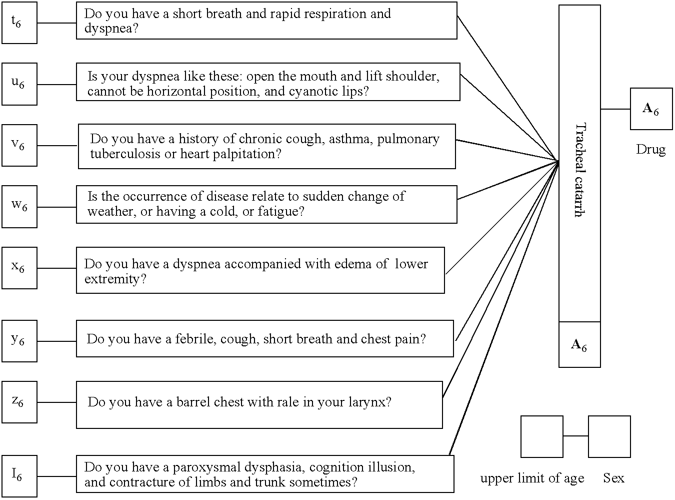

TABLE 10
The acknowledgement of vaginitis

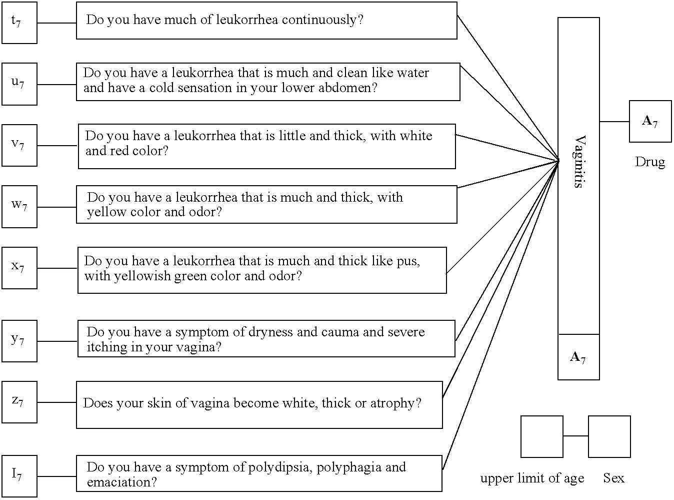

TABLE 11
The acknowledgement of long term apocamnosis

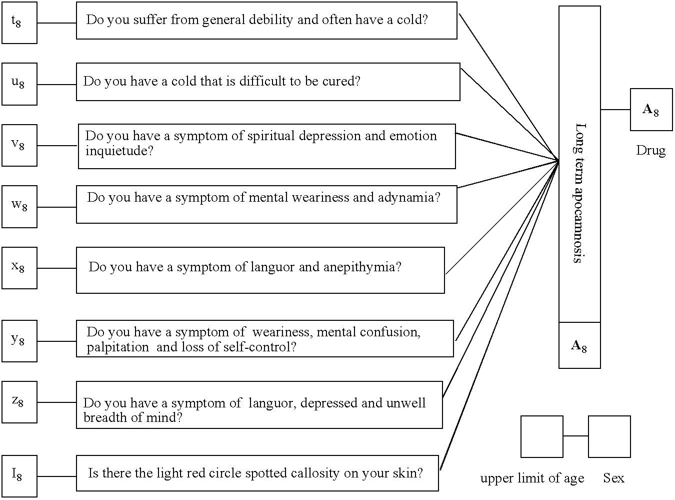

TABLE 12
The acknowledgement of rheum

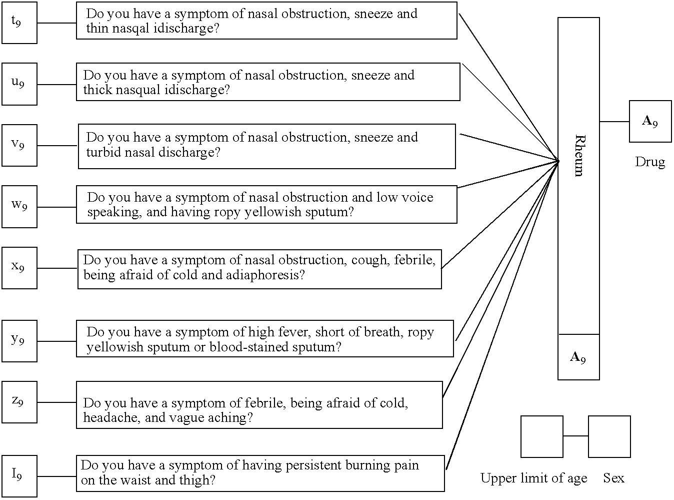

TABLE 13
The acknowledgement of coronary heart disease

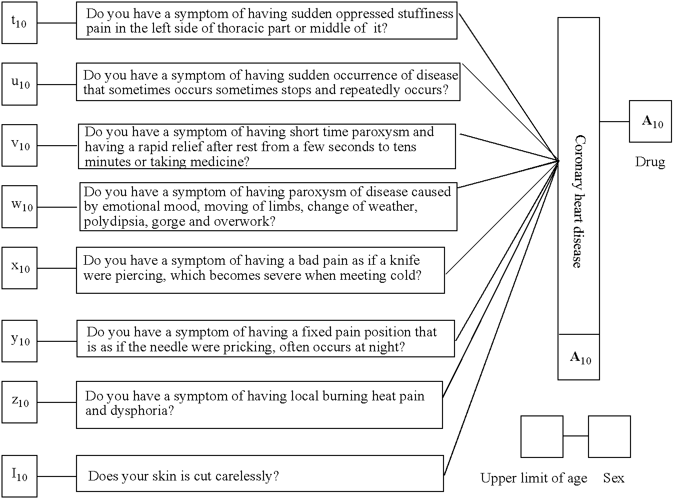

TABLE 14
The acknowledgement of diabetes

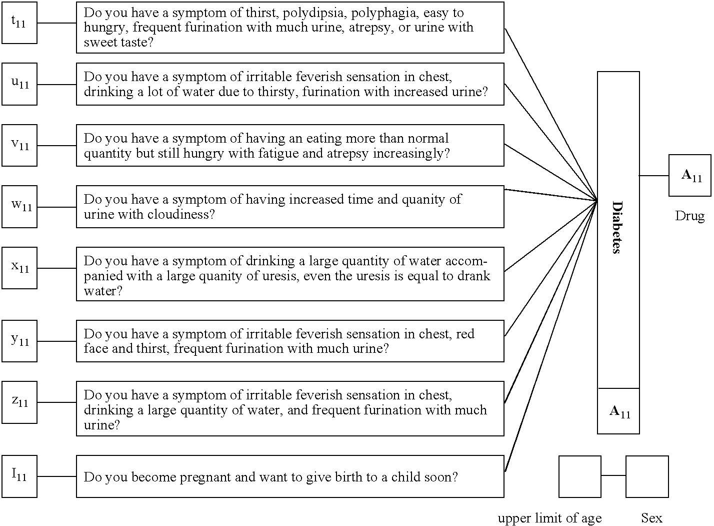

TABLE 15
The acknowledgement of dermatosis

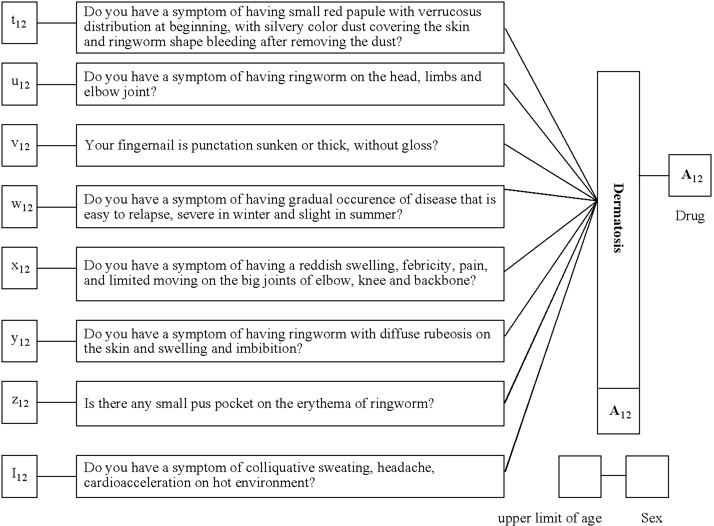

TABLE 16
The acknowledgement of elevated blood fat

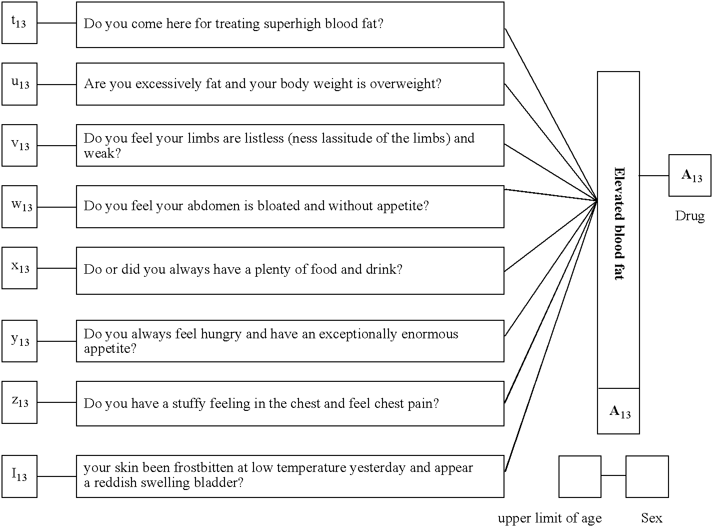

TABLE 17
The acknowledgement of decline of sexual function

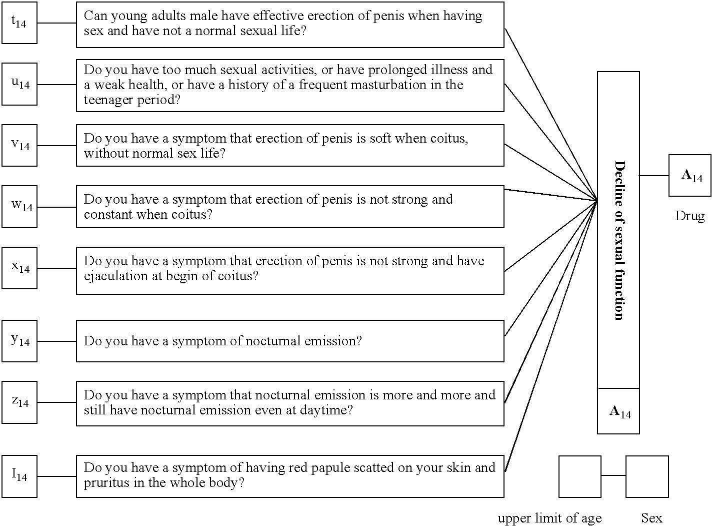

TABLE 18
The acknowledgement of cholecystitis

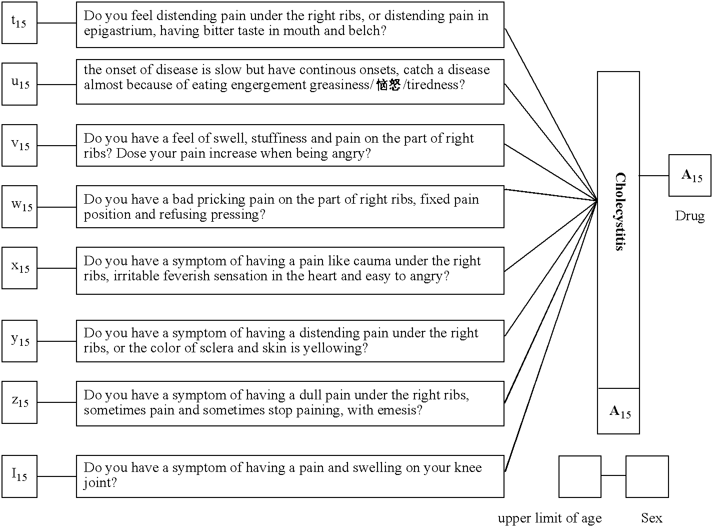

TABLE 19
The acknowledgement of edema

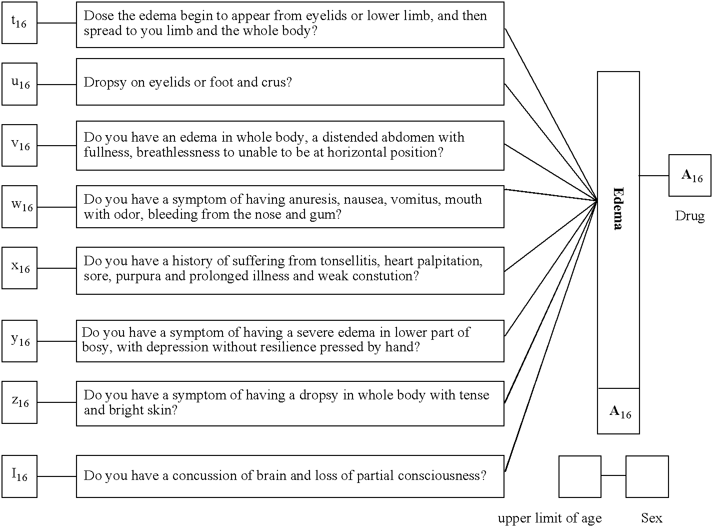

TABLE 20
The acknowledgement of traumatic injury

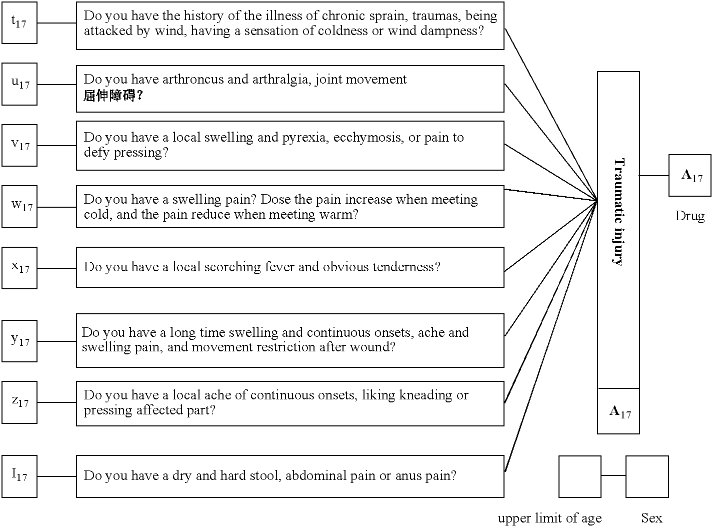

TABLE 21
The acknowledgement of hemorrhoid

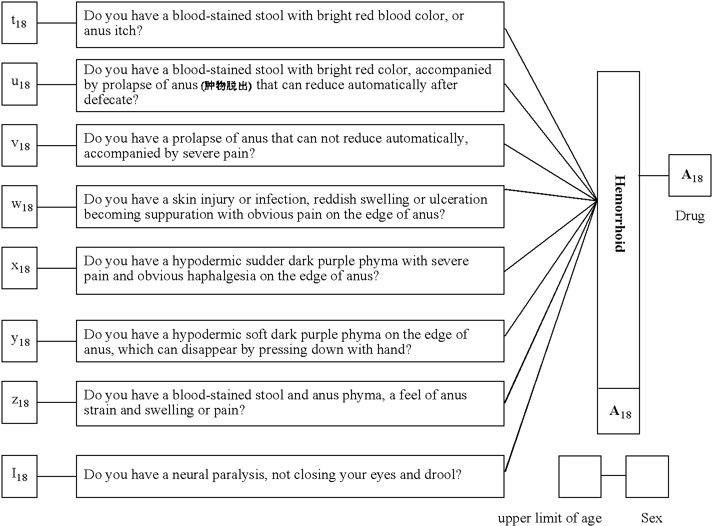

TABLE 22
The acknowledgement of hepatitis

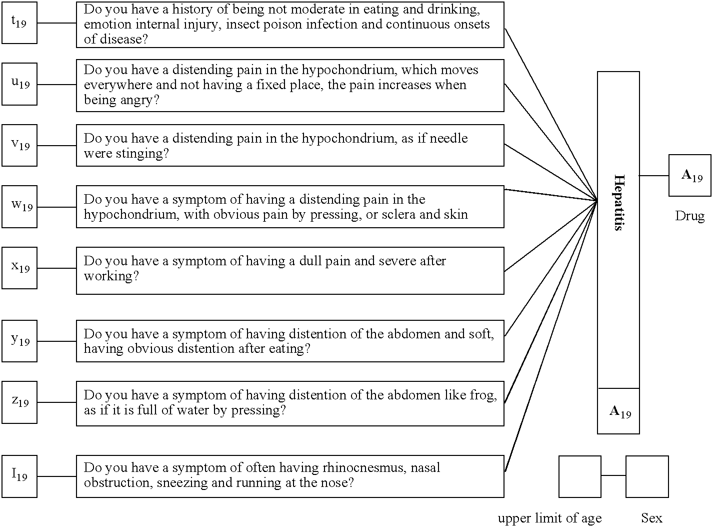

TABLE 23
The acknowledgement of hypertension

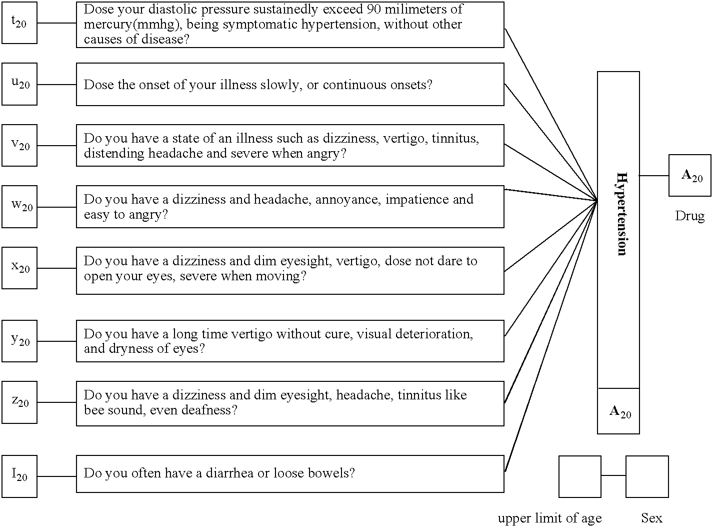

TABLE 24
The acknowledgement of diarrhea

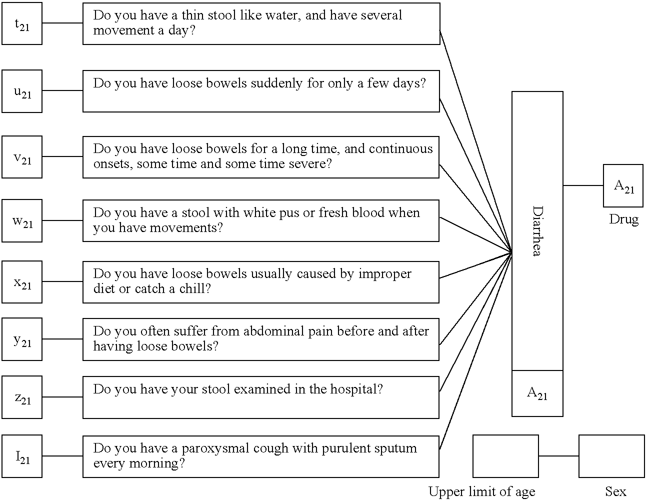

TABLE 25
The acknowledgement of nephritis

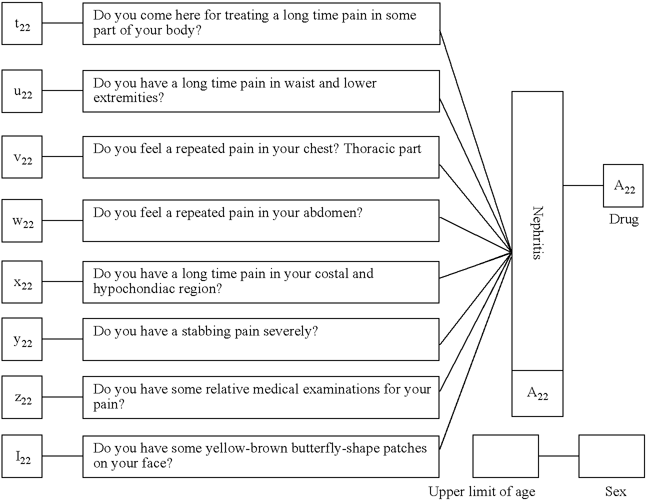

TABLE 26
The acknowledgement of pain

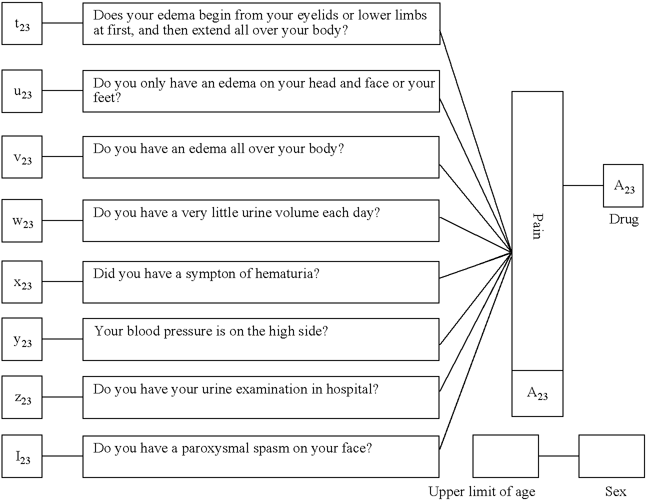

TABLE 27
The acknowledgement of dyspepsia

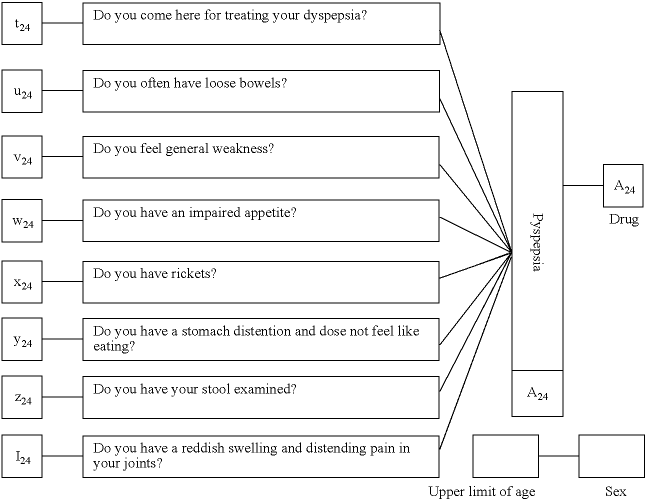

TABLE 28
The acknowledgement of climacteric syndrome

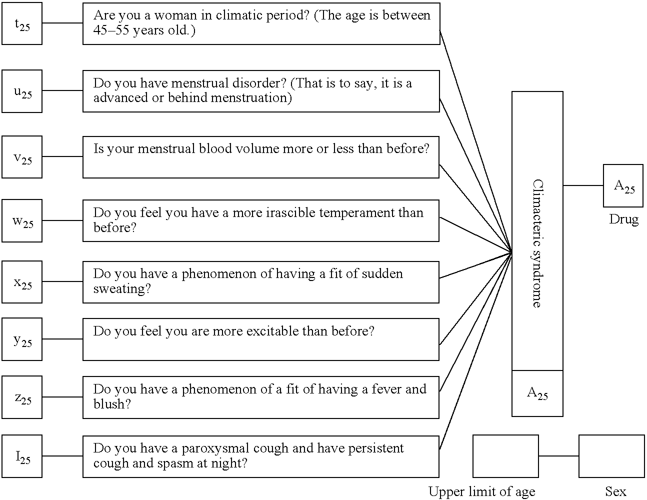

TABLE 29
The acknowledgement of headache

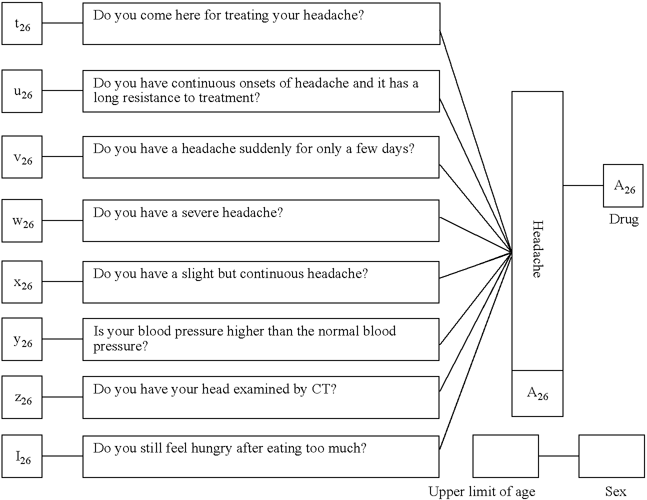

TABLE 30
The acknowledgement of osteoporosis

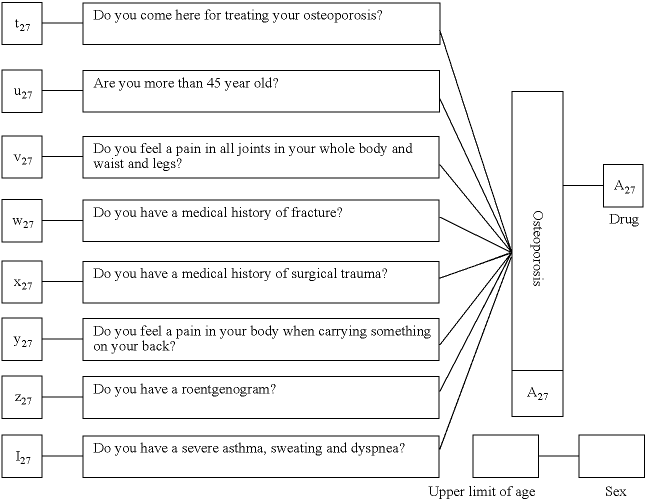

TABLE 31
The acknowledgement of obesity

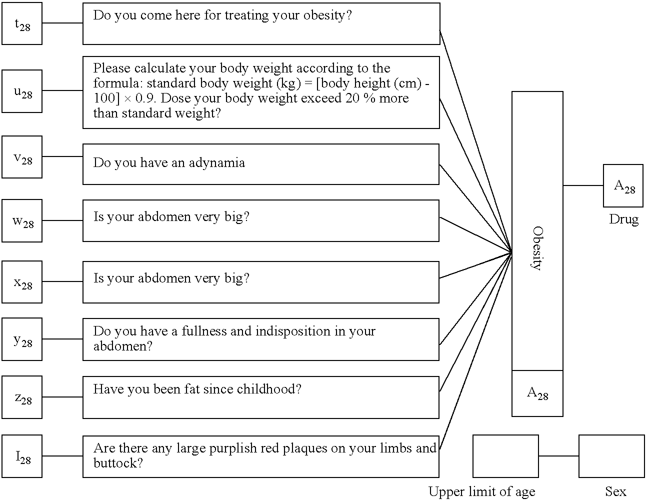

TABLE 32
The acknowledgement of hyperplasia of mammary glands

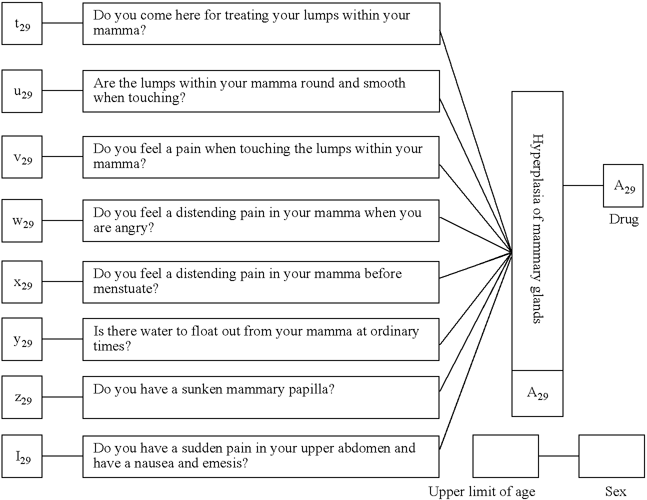

TABLE 33
The acknowledgement of cough

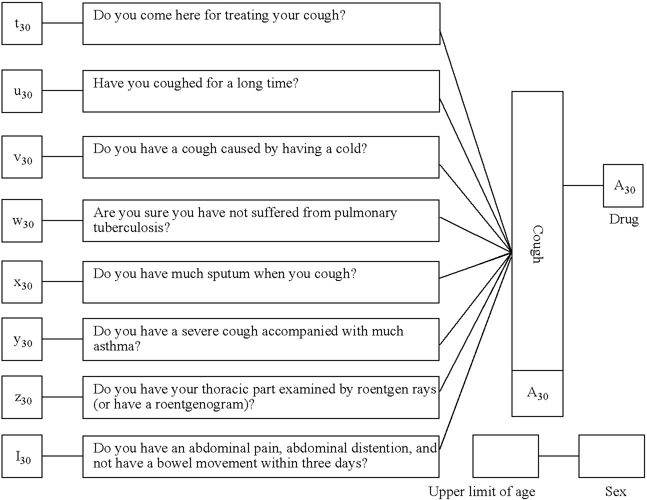

TABLE 34
The acknowledgement of stomach pain

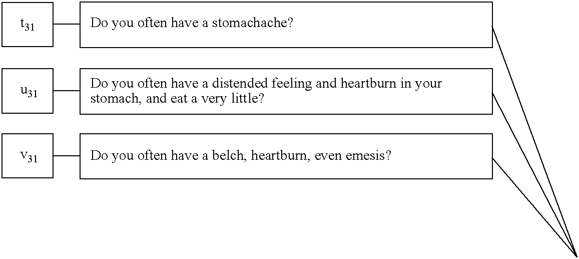

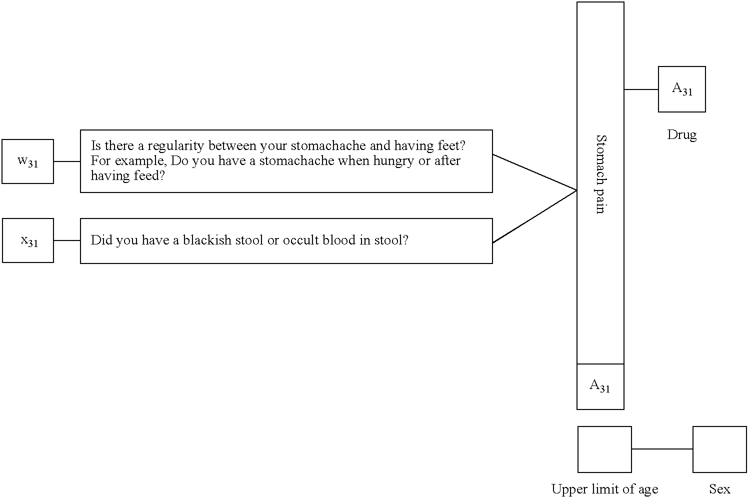

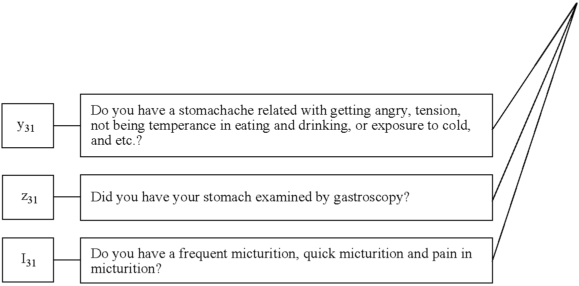

TABLE 35
The acknowledgement of menalgia

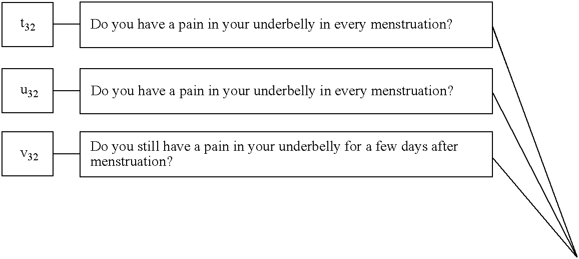

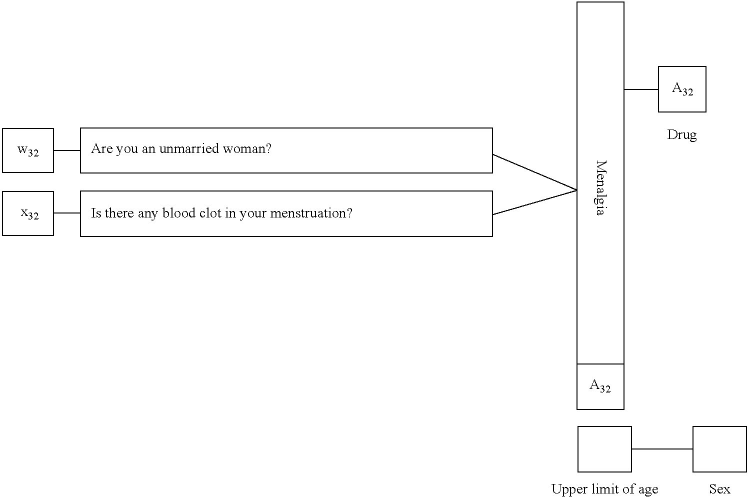

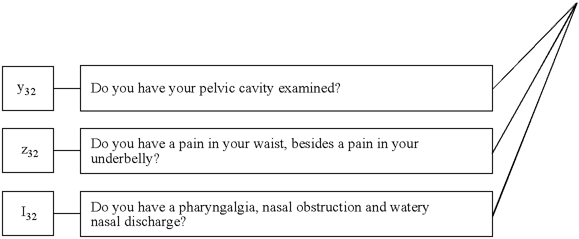

TABLE 36
The acknowledgement of prostatic hyperplasia

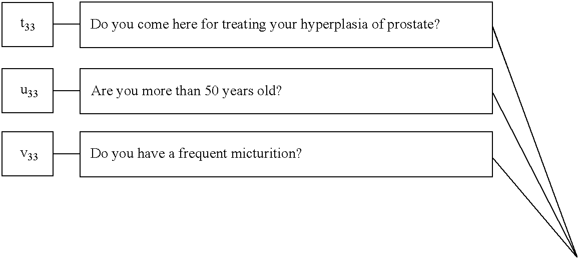

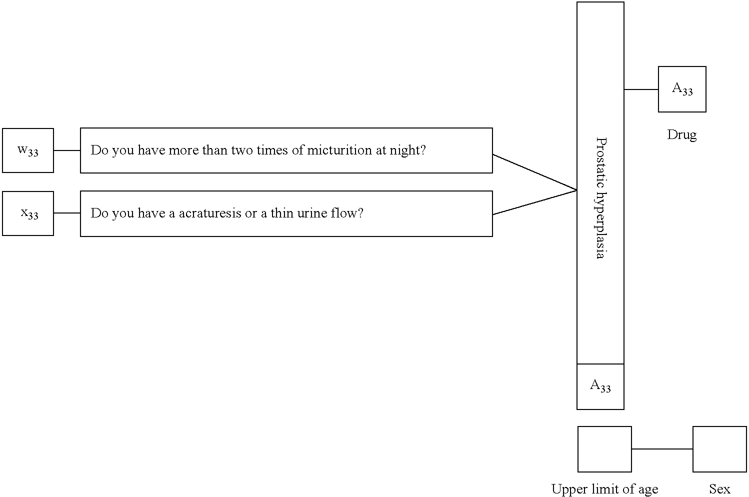

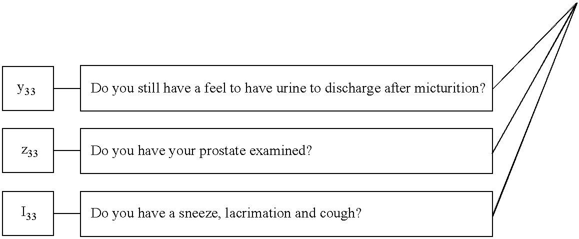

TABLE 37
The acknowledgement of haryngitis

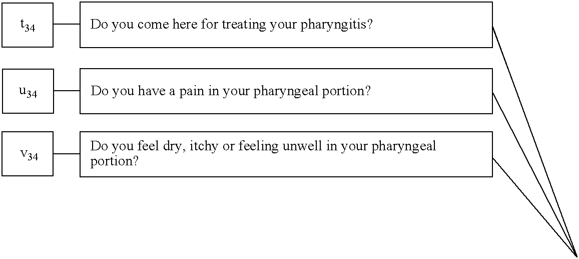

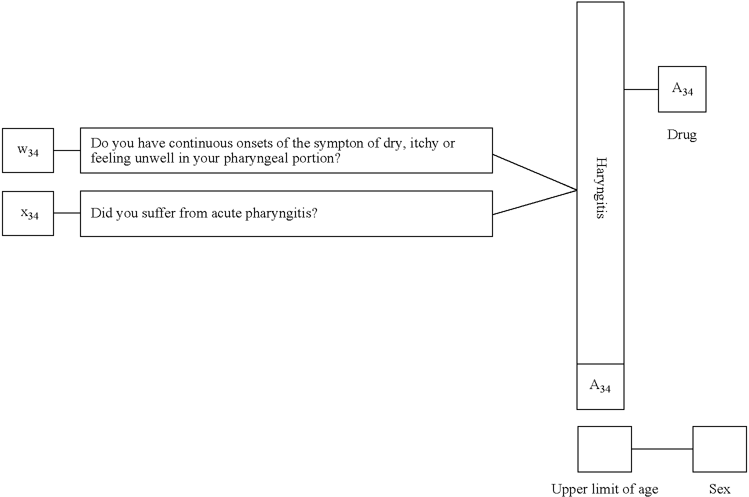

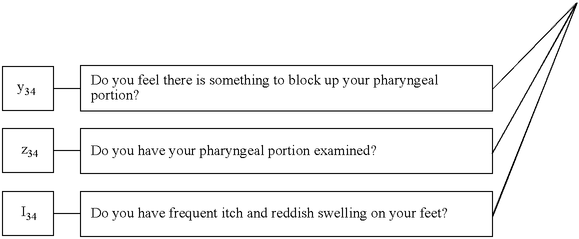

TABLE 38
The acknowledgement of hyperosteogeny

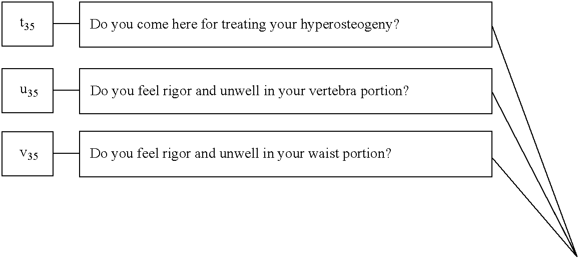

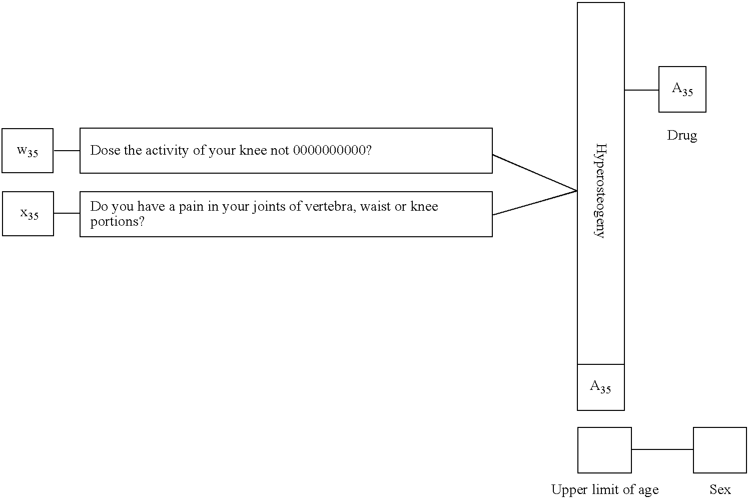

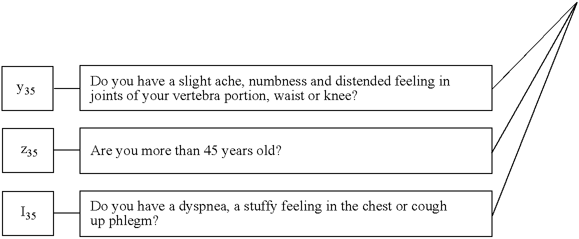

TABLE 39
The acknowledgement of rhinitis

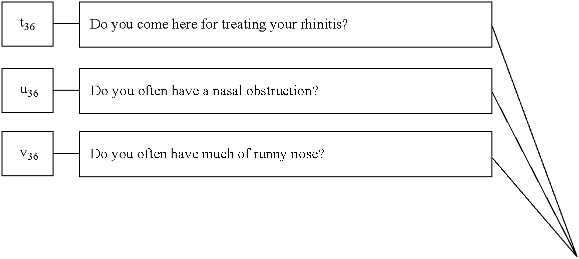

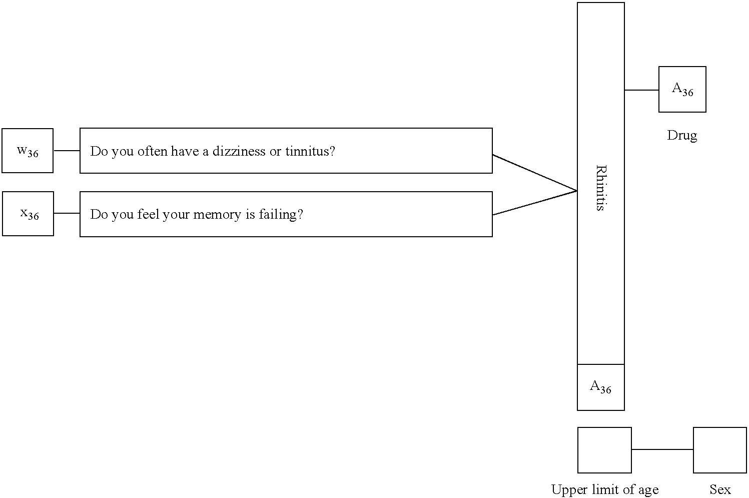

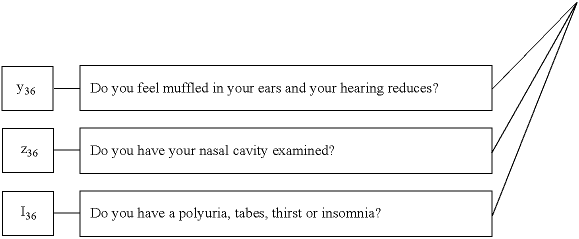

TABLE 40
The acknowledgement of sequela of apoplexy

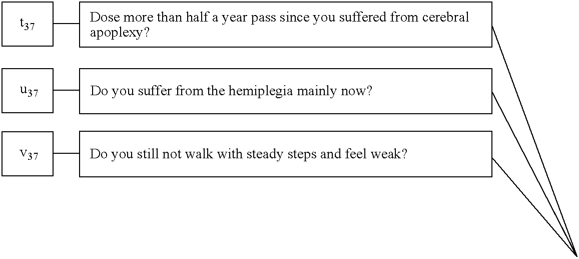

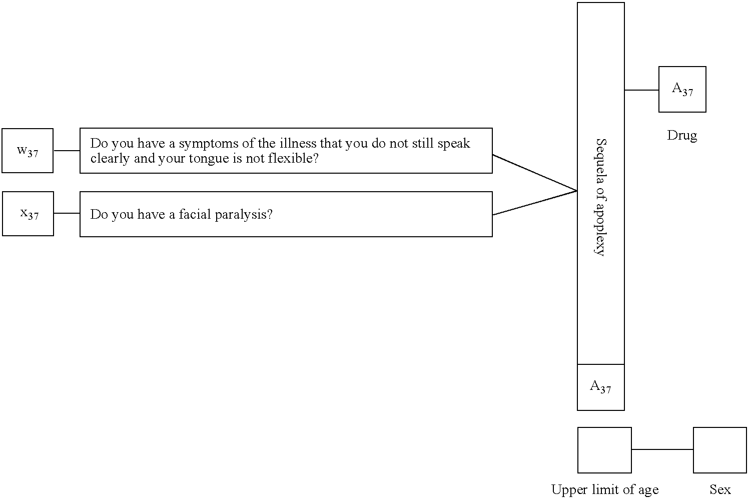

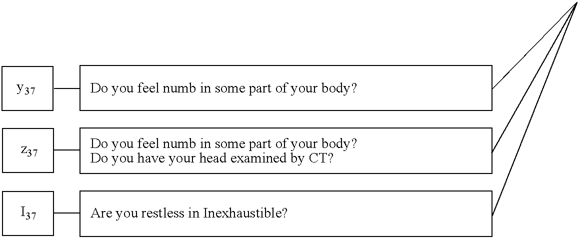

TABLE 41
The acknowledgement of presenility

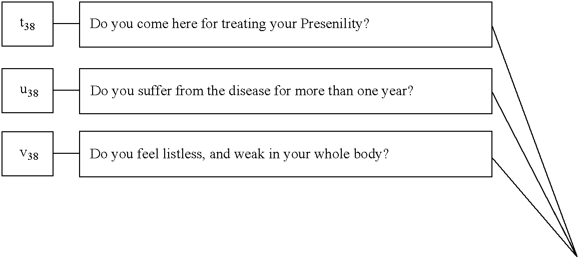

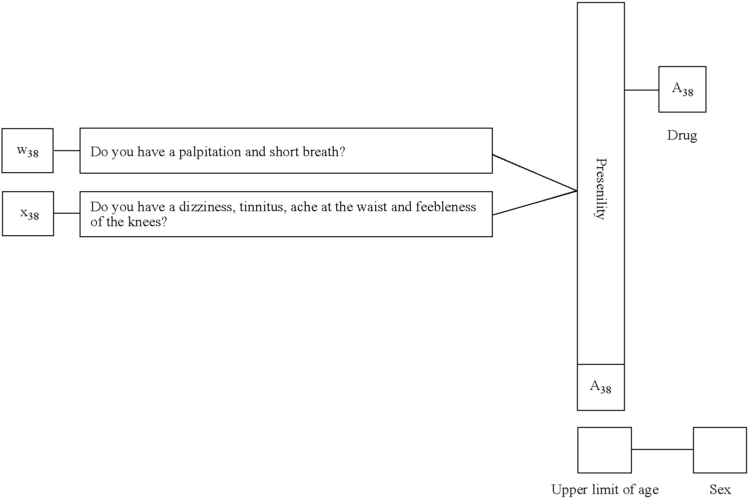

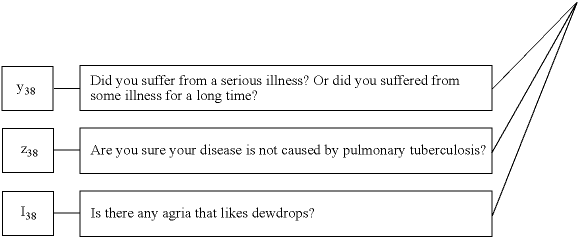

TABLE 42
The acknowledgement of lower grade fever

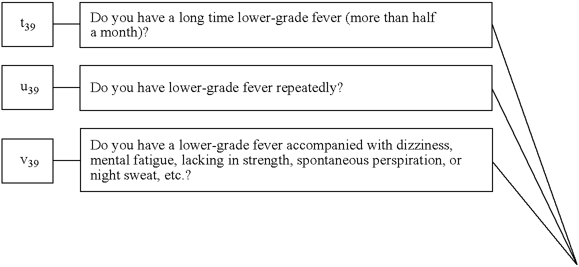

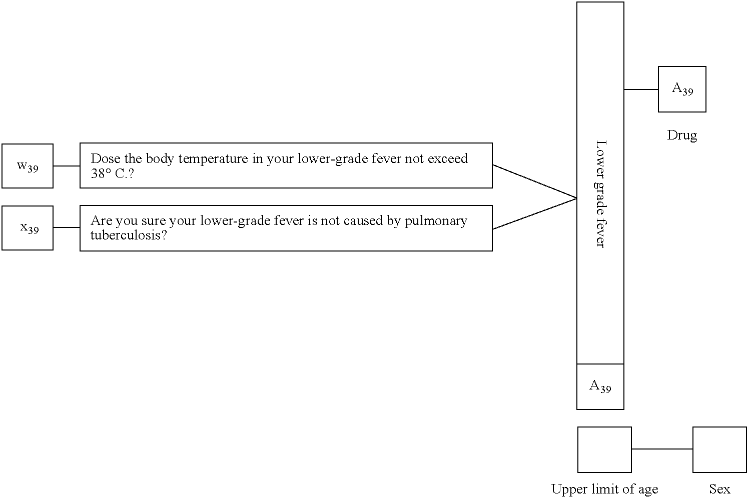

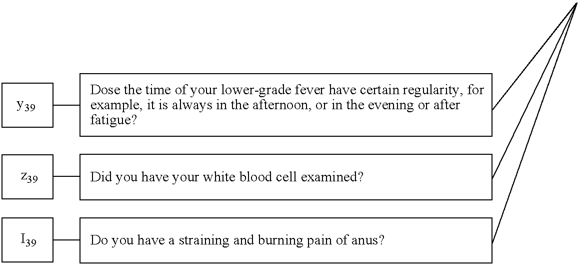

TABLE 43
The acknowledgement of carbuncle and sore

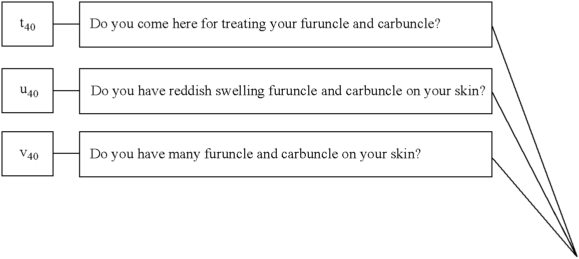

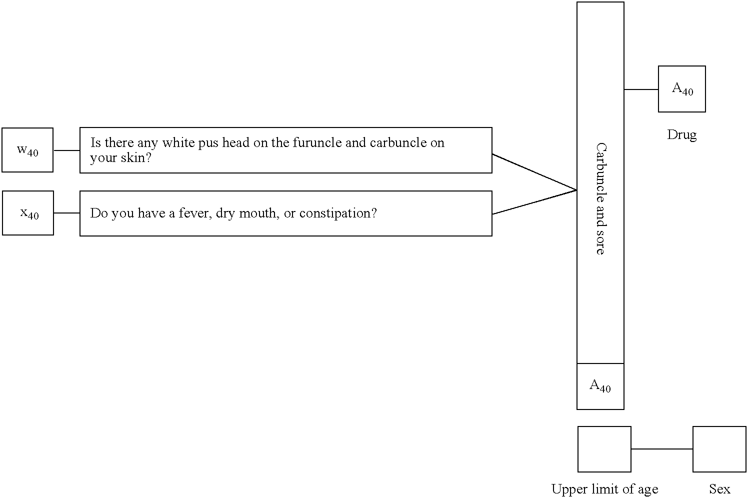

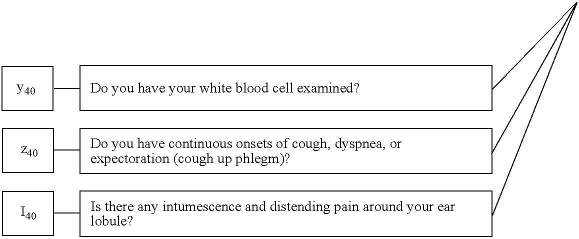

TABLE 44
Confirmation of detail classification of macula resolving and acne

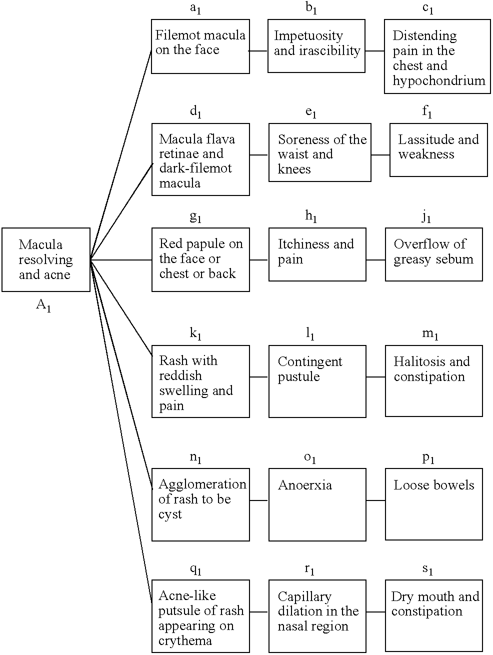

TABLE 45
Confirmation of detail classification of senile cretinism

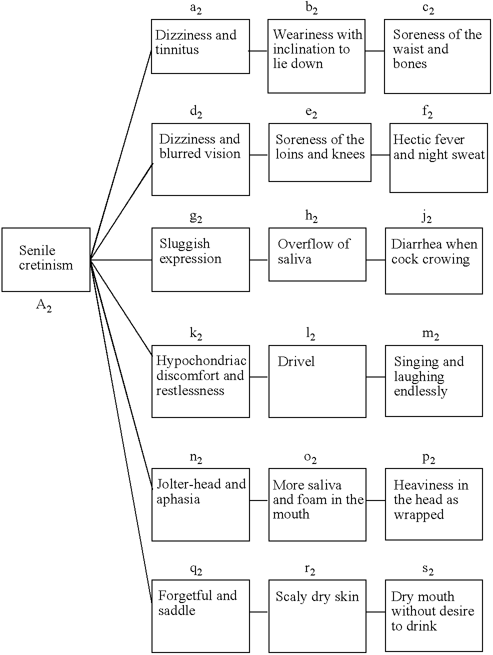

TABLE 46
Confirmation of detail classification of anemia

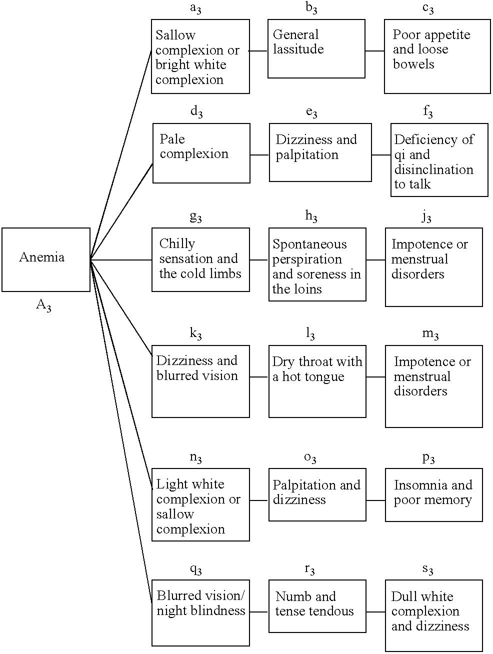

TABLE 47
Confirmation of detail classification of neurasthenia

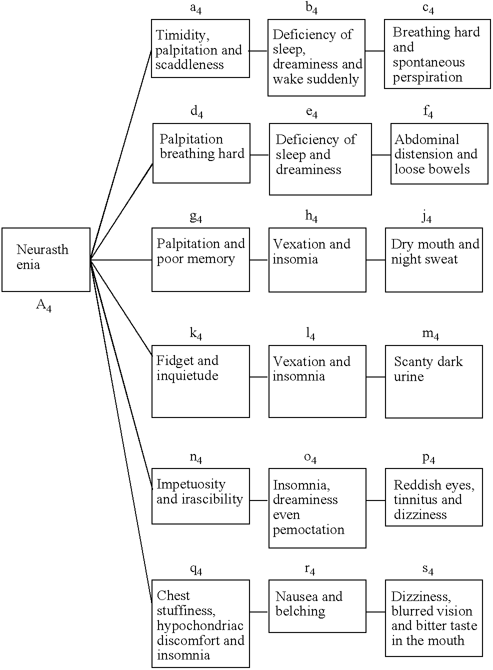

TABLE 48
Confirmation of detail classification of arthritis

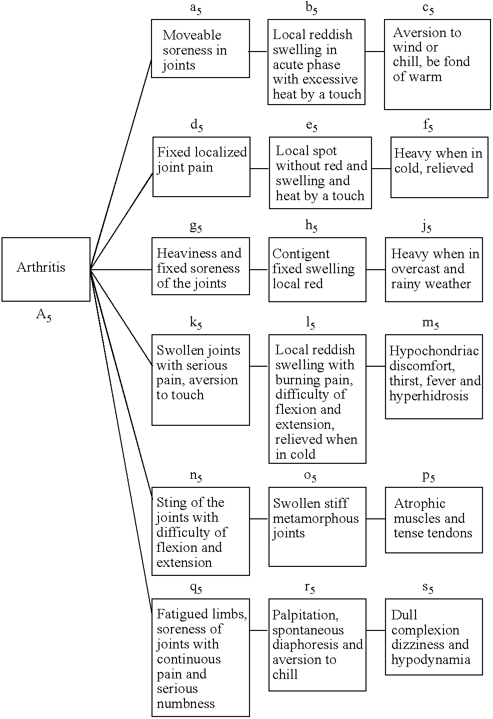

TABLE 49
Confirmation of detail classification of tracheal catarrh

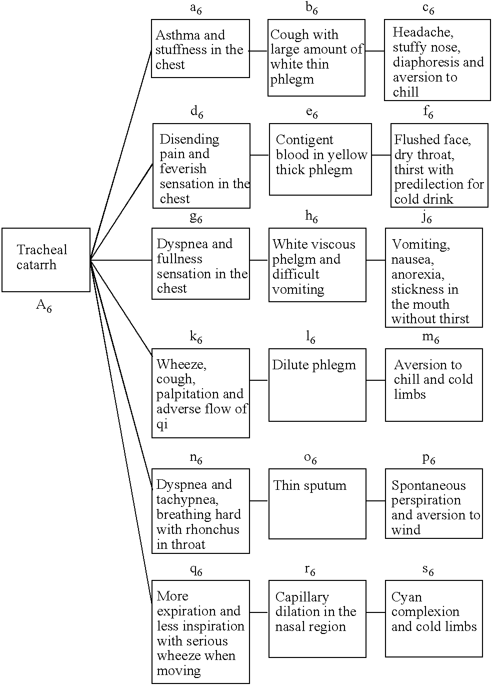

TABLE 50
Confirmation of detail classification of vaginitis

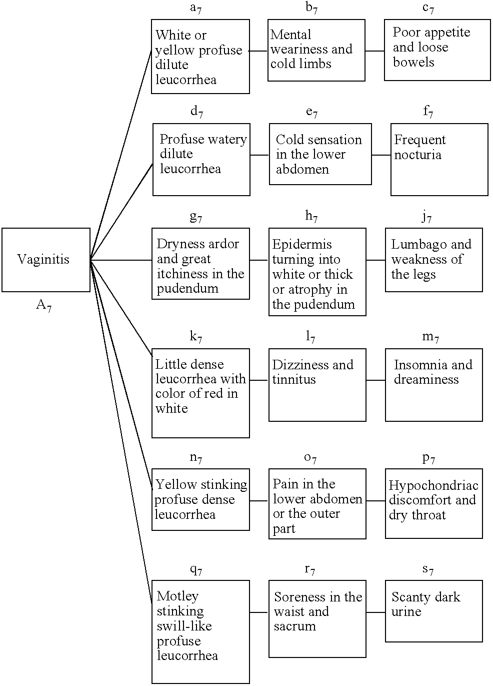

TABLE 51
Confirmation of detail classification of long term apocamnosis

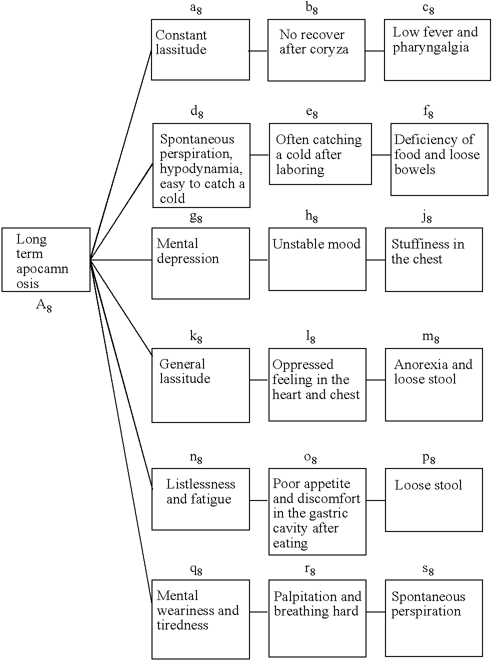

TABLE 52
Confirmation of detail classification of rheum

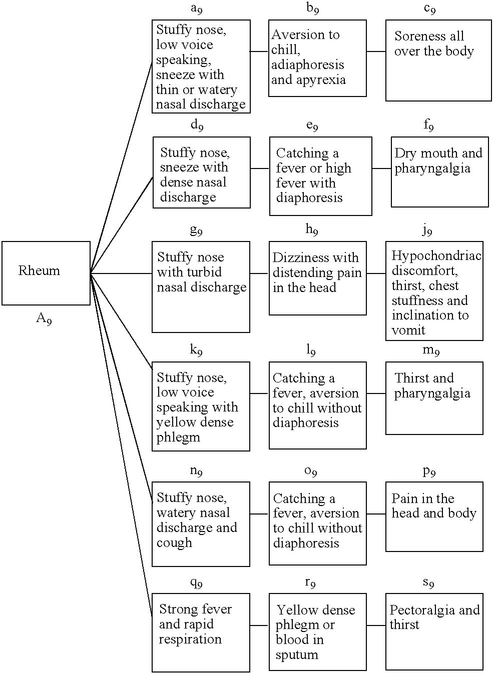

TABLE 53
Confirmation of detail classification of coronary heart disease

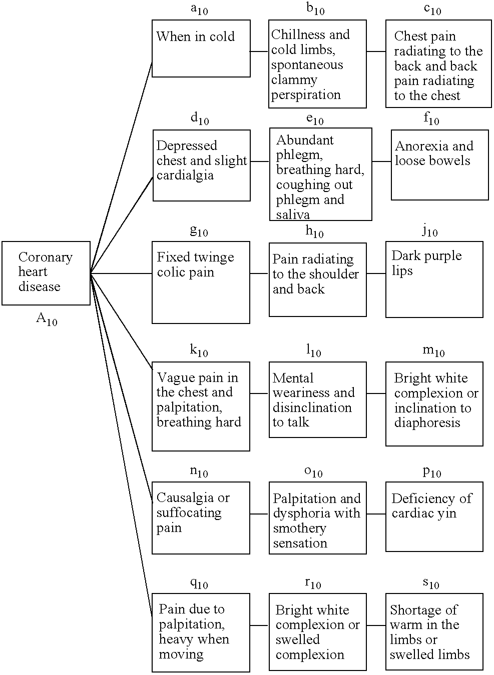

TABLE 54
Confirmation of detail classification of diabetes

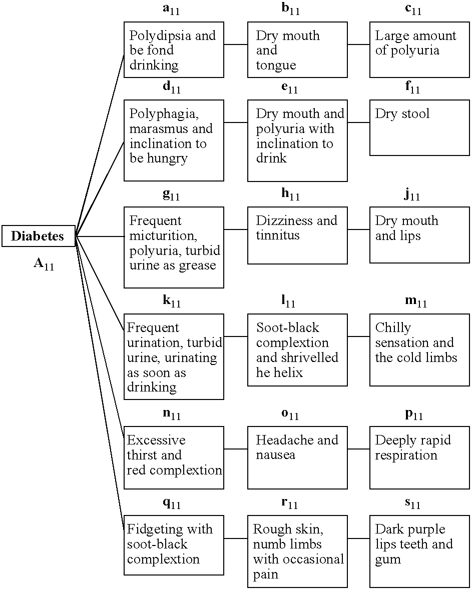

TABLE 55
Confirmation of detail classification of dermatosis

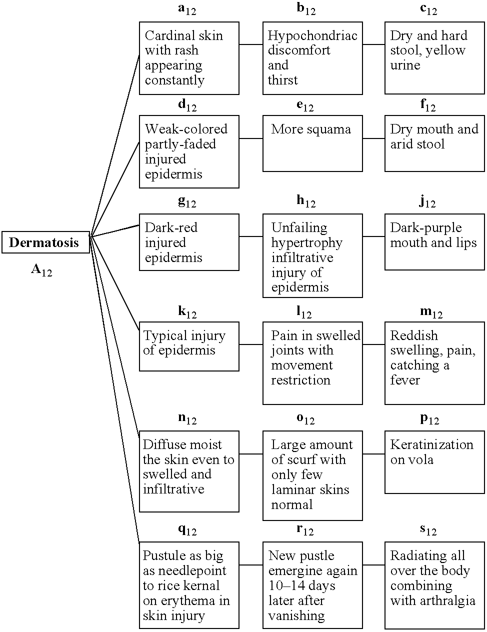

TABLE 56
Confirmation of detail classification of elevated blood fat

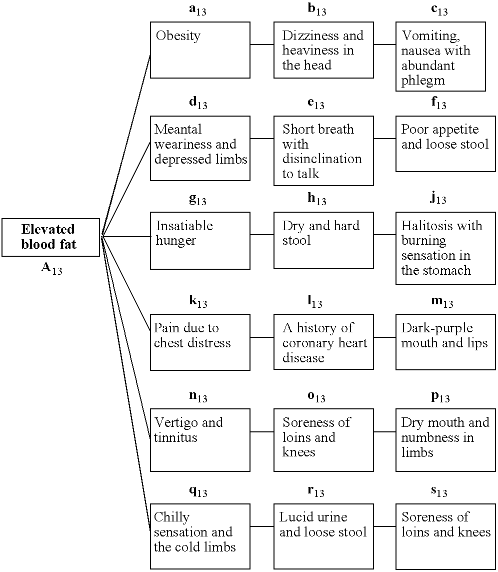

TABLE 57
Confirmation of detail classification of decline of sexual function

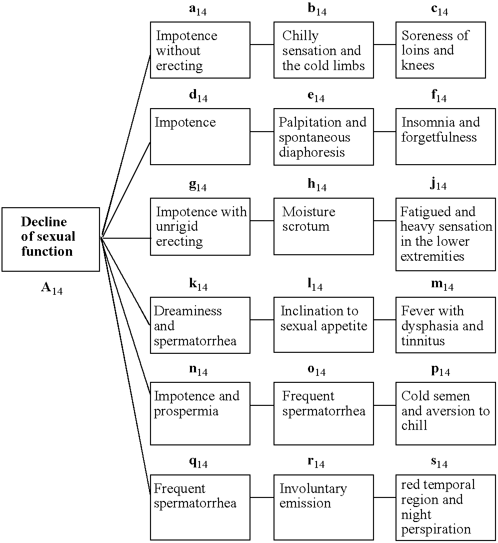

TABLE 58
Confirmation of detail classification of cholecystitis

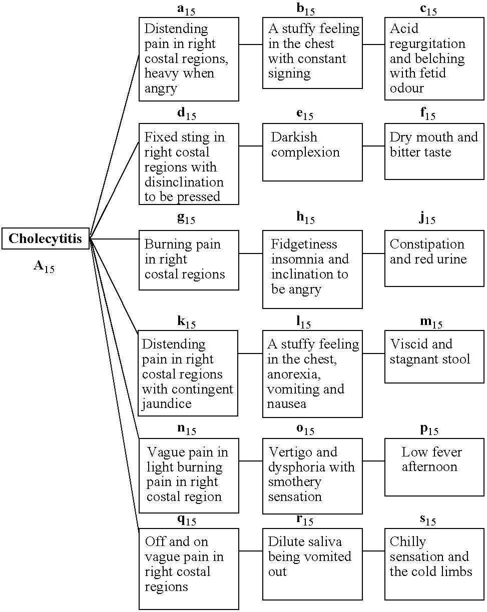

TABLE 59
Confirmation of detail classification of edema

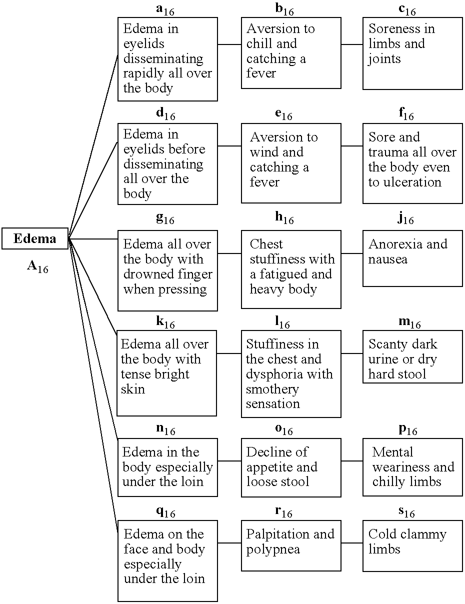

TABLE 60
Confirmation of detail classification of traumatic injury

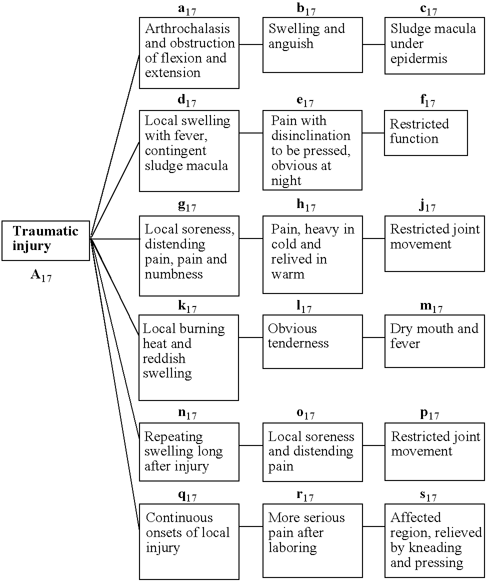

TABLE 61
Confirmation of detail classification of hemorrhoid

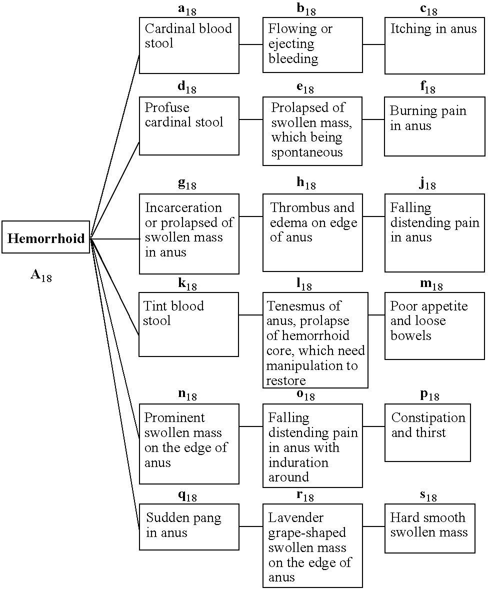

TABLE 62
Confirmation of detail classification of hepatitis

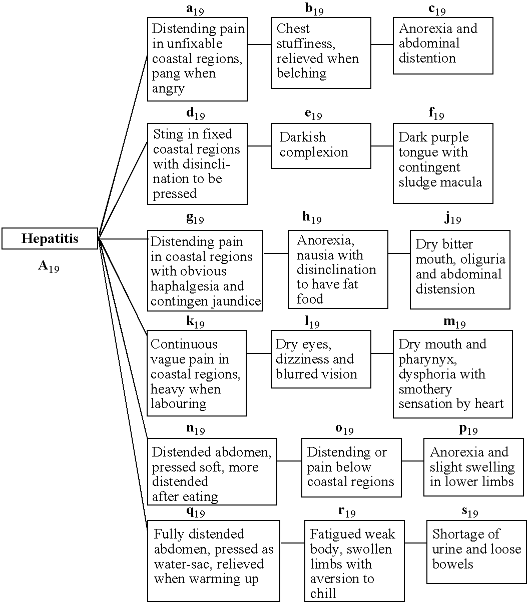

TABLE 63
Confirmation of detail classification of hypertension

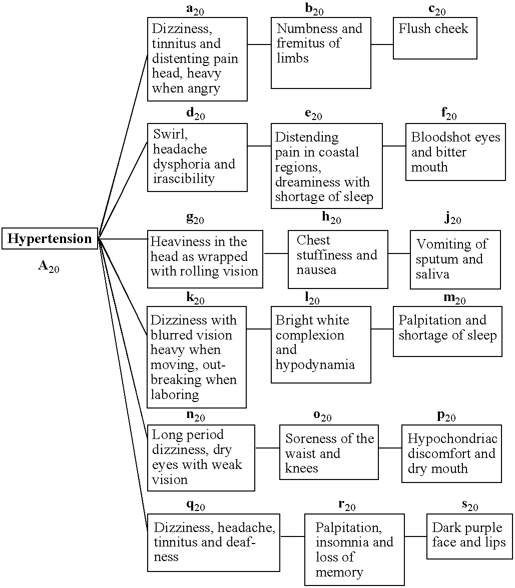

TABLE 64
Confirmation of detail classification of diarrhea

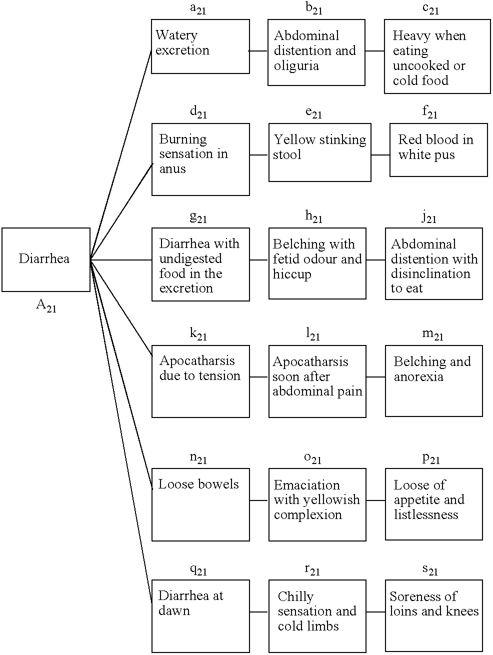

TABLE 65
Confirmation of detail classification of pain

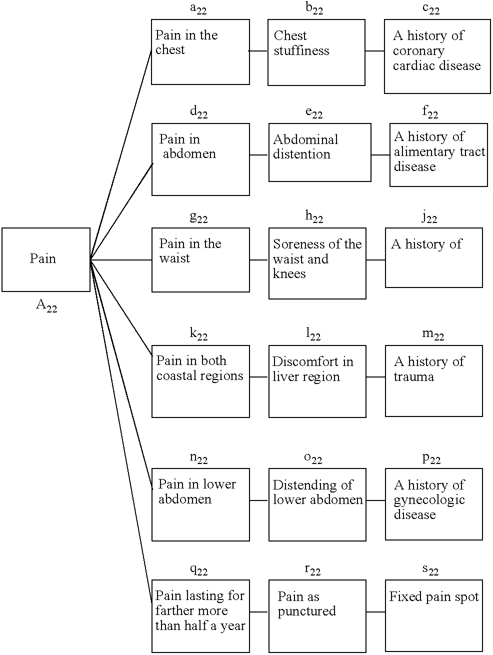

TABLE 66
Confirmation of detail classification of nephritis

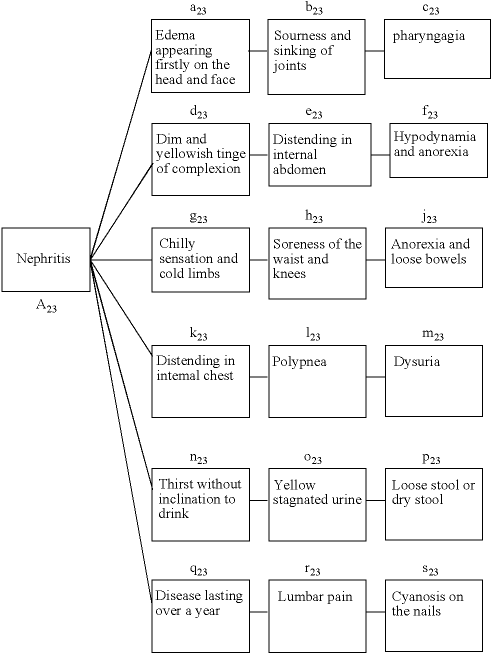

TABLE 67
Confirmation of detail classification of dyspepsia

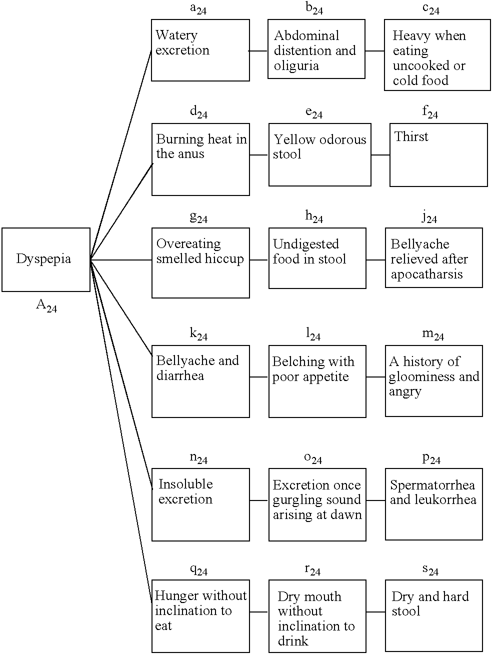

TABLE 68
Confirmation of detail classification of climacteric syndrome

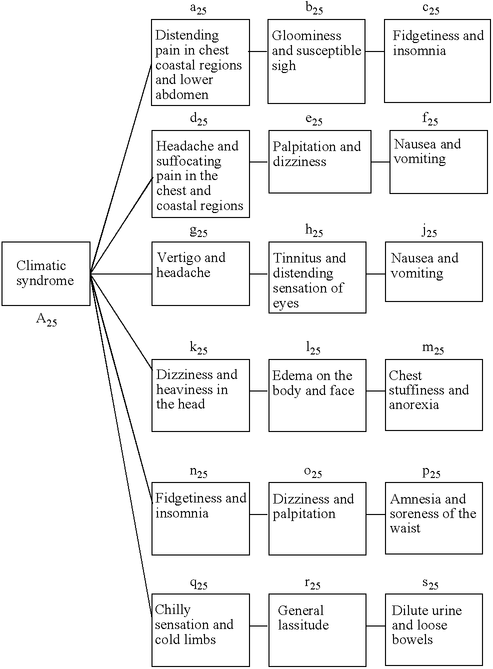

TABLE 69
Confirmation of detail classification of headache

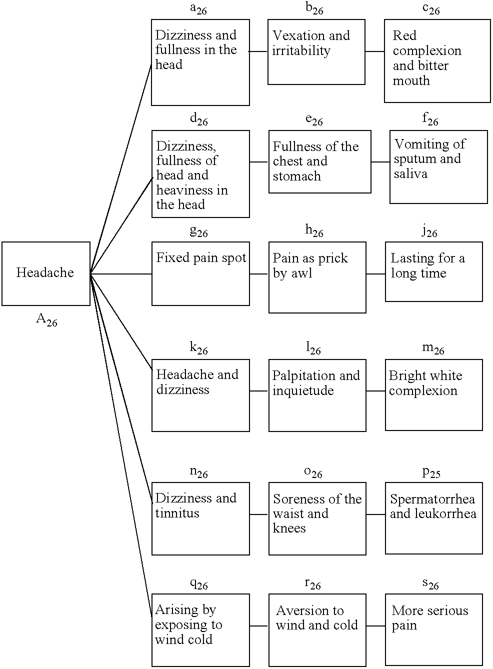

TABLE 70
Confirmation of detail classification of osteoporosis

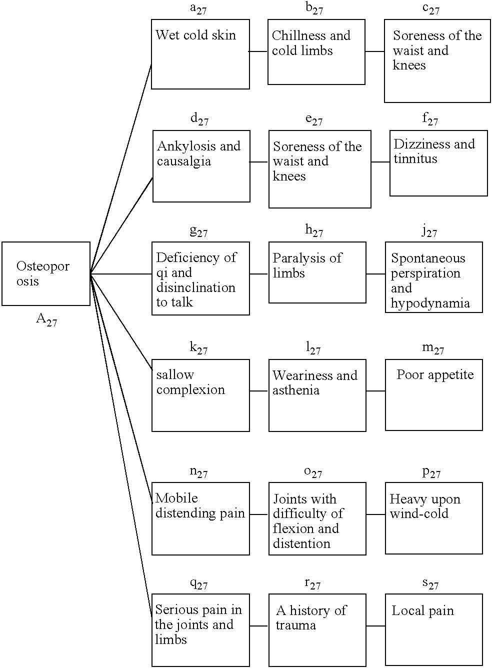

TABLE 71
Confirmation of detail classification of obesity

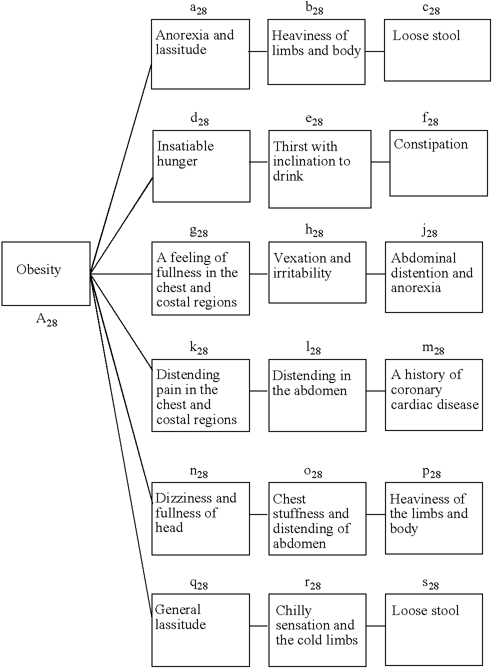

TABLE 72
Confirmation of detail classification of hyperplasia of mammary glands

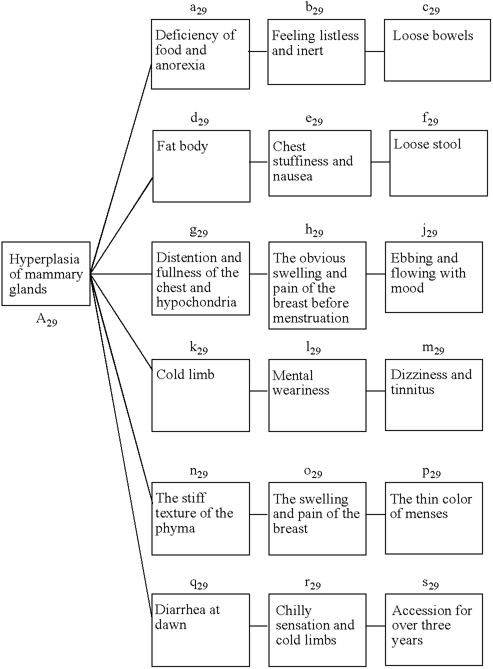

TABLE 73
Confirmation of detail classification of cough

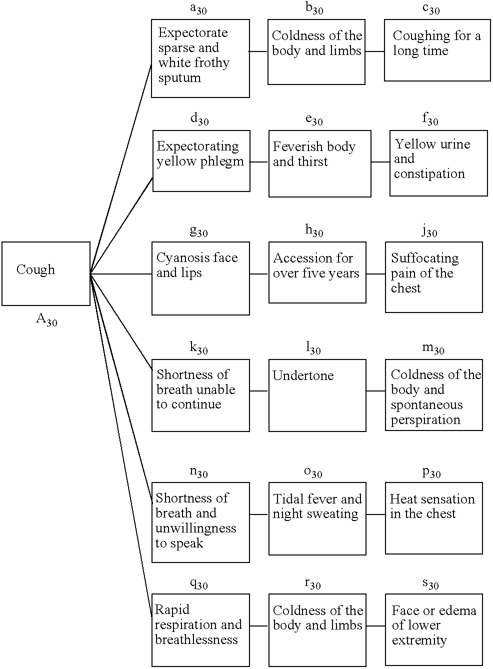

TABLE 74
Confirmation of detail classification of stomach pain

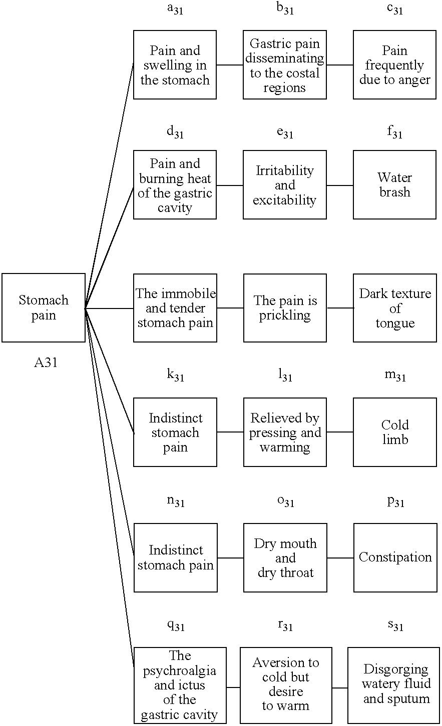

TABLE 75
Confirmation of detail classification of menalgia

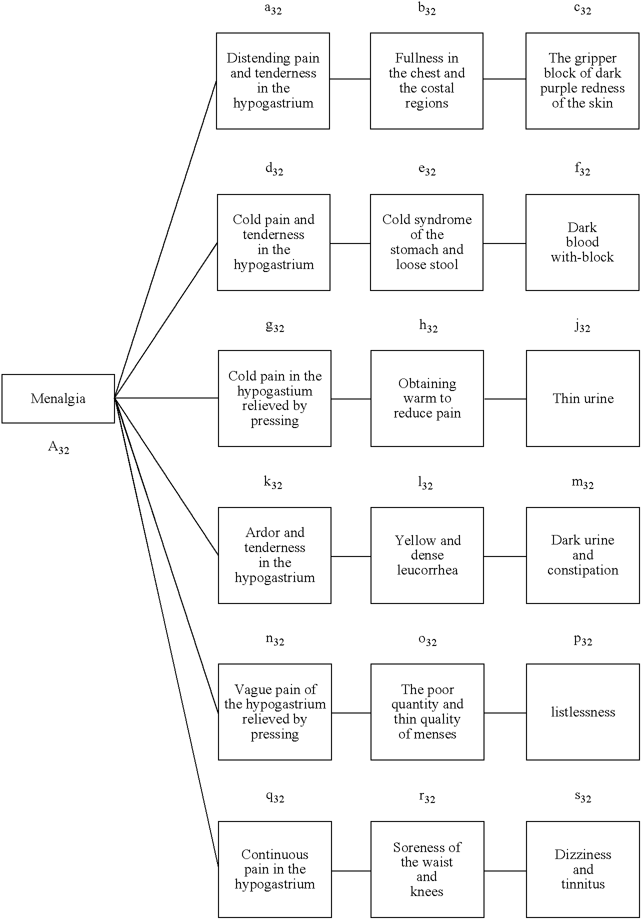

TABLE 76
Confirmation of detail classification of prostatic hyperplasia

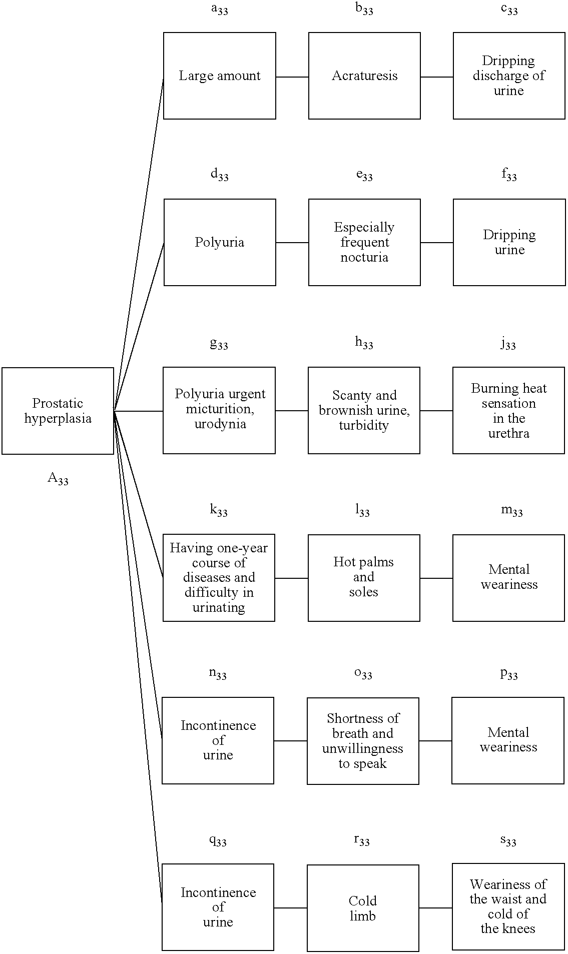

TABLE 77
Confirmation of detail classification of haryngitis

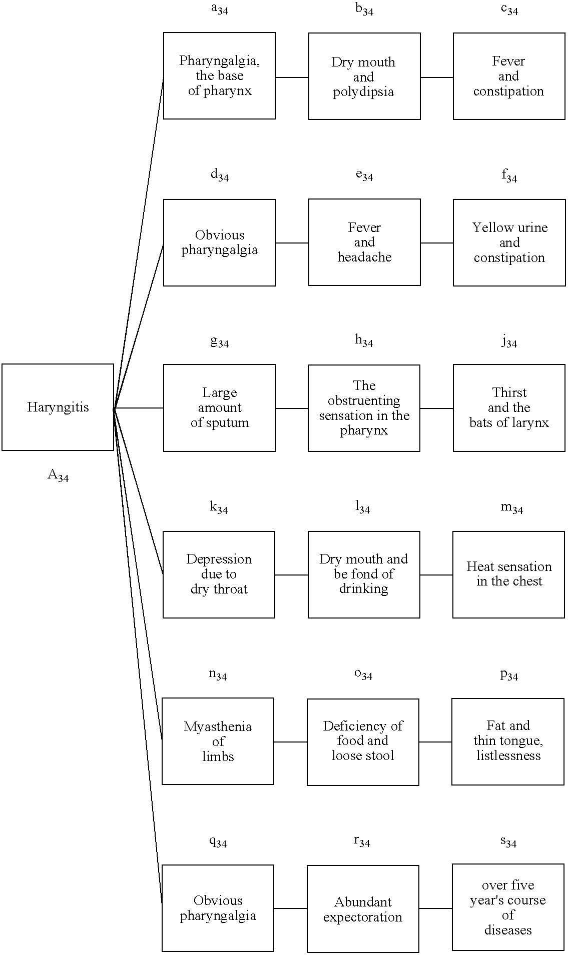

TABLE 78
Confirmation of detail classification of hyperosteogeny

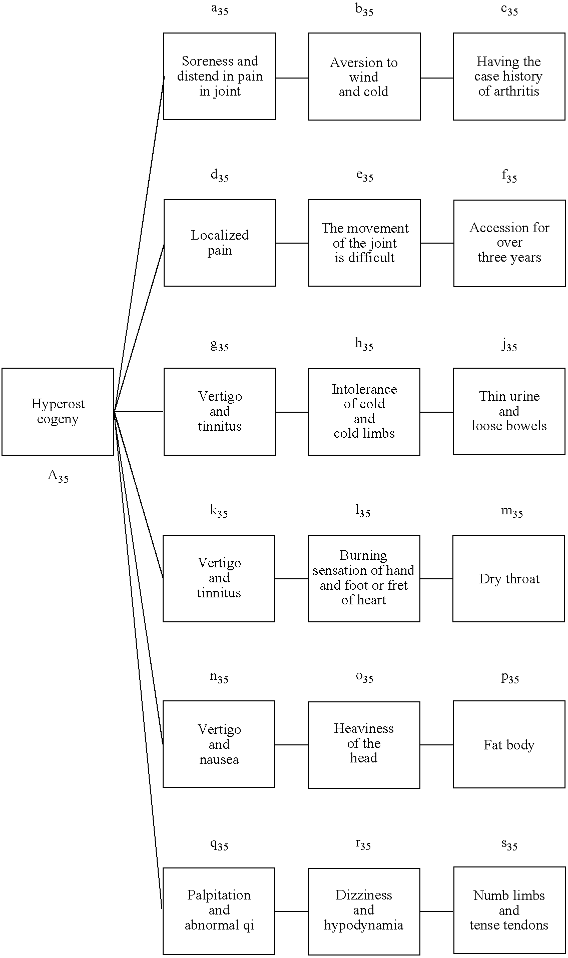

TABLE 79
Confirmation of detail classification of rhinitis

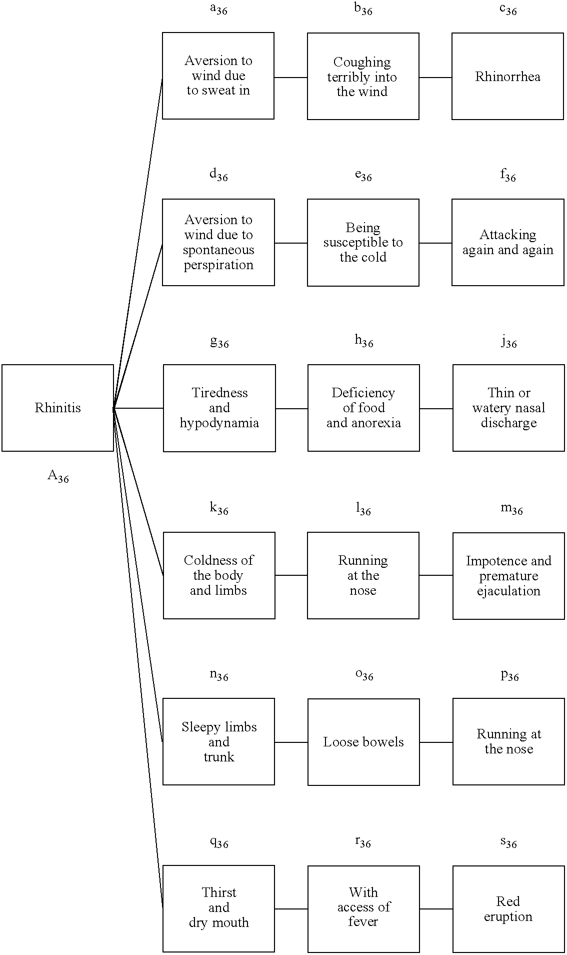

TABLE 80
Confirmation of detail classification of sequela of apoplexy

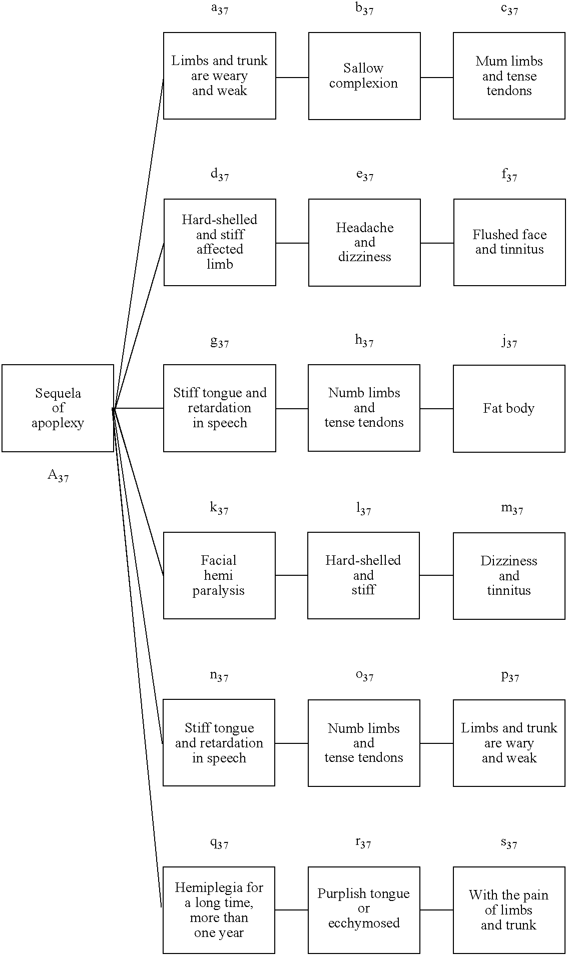

TABLE 81
Confirmation of detail classification of presenility

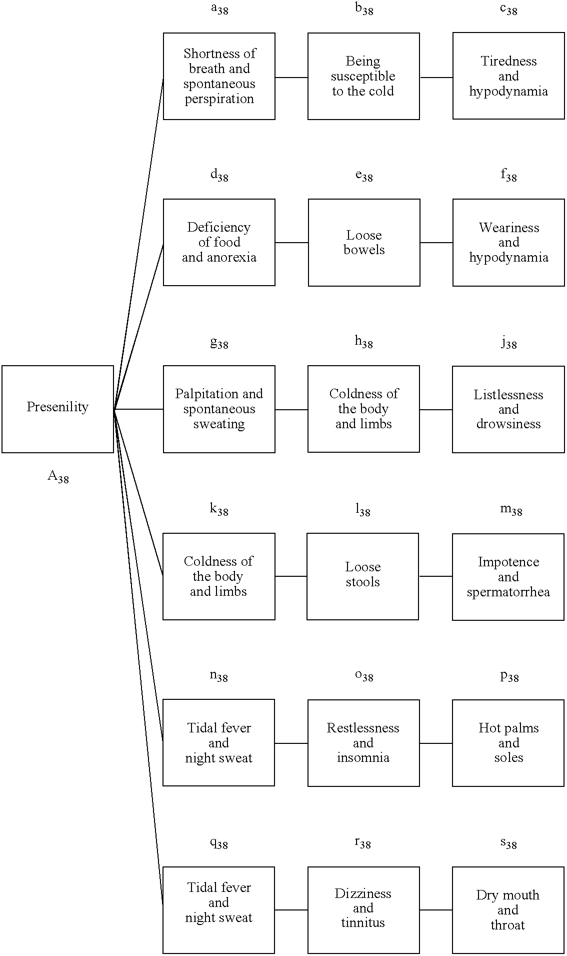

TABLE 82
Confirmation of detail classification of lower grade fever

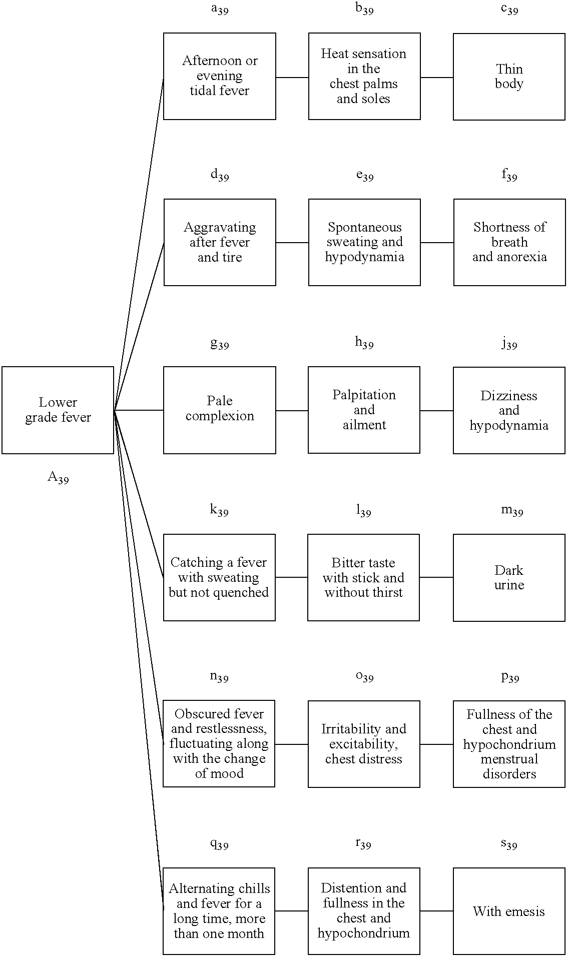

TABLE 83
Confirmation of detail classification of carbuncle and sore

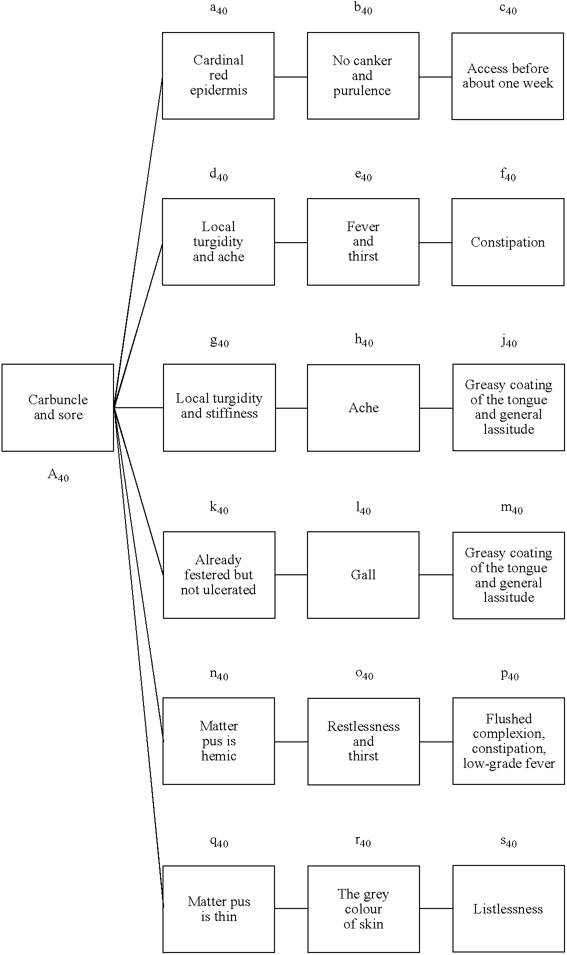

TABLE 84
Detail classification and health treatment principle of macula
resolving and acne

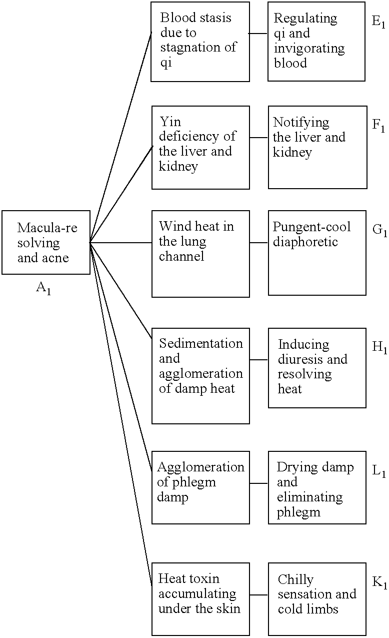

TABLE 85
Detail classification and health treatment principle of senile cretinism

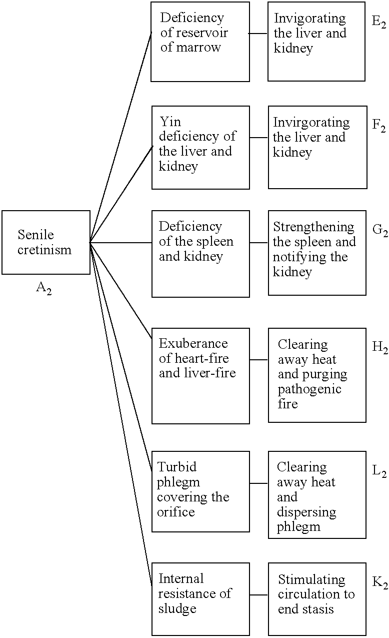

TABLE 86
Detail classification and health treatment principle of anemia

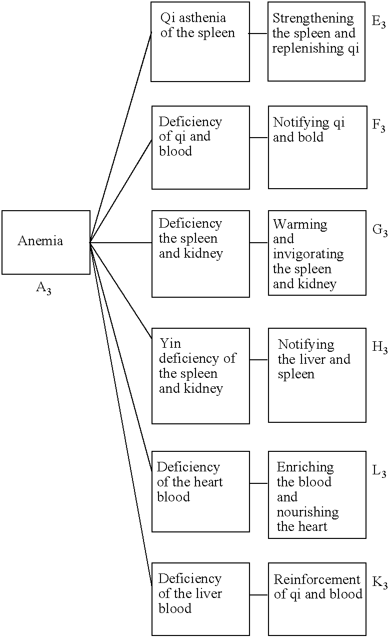

TABLE 87
Detail classification and health treatment principle of neurasthenia

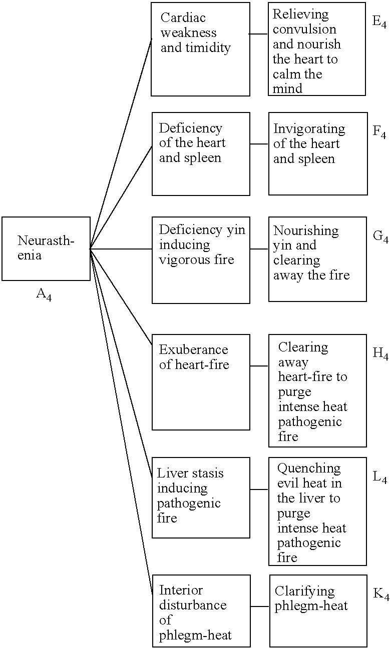

TABLE 88
Detail classification and health treatment principle of arthritis

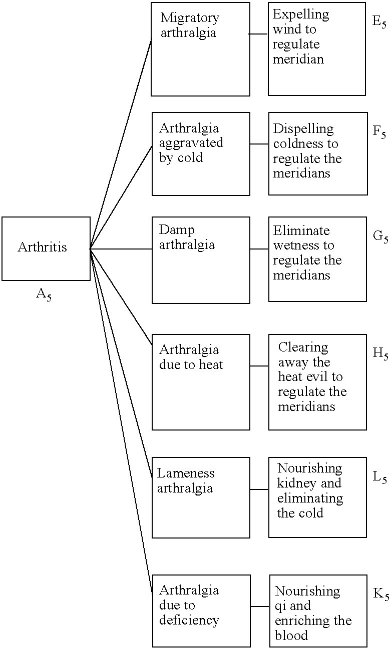

TABLE 89
Detail classification and health treatment principle of tracheal catarrh

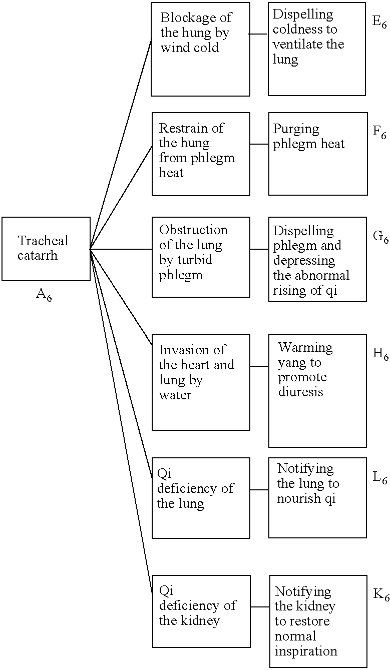

TABLE 90
Detail classification and health treatment principle of vaginitis

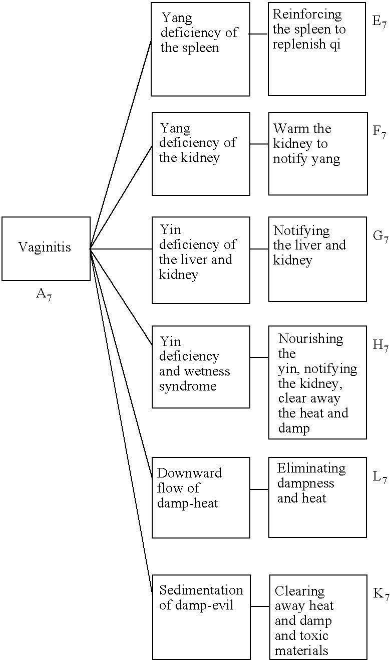

TABLE 91
Detail classification and health treatment principle of long term
apocamnosis

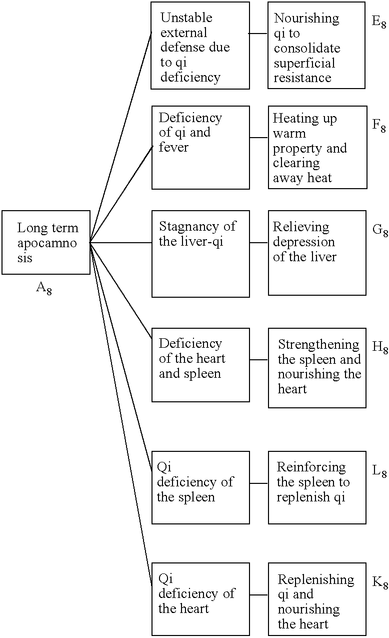

TABLE 92
Detail classification and health treatment principle of rheum

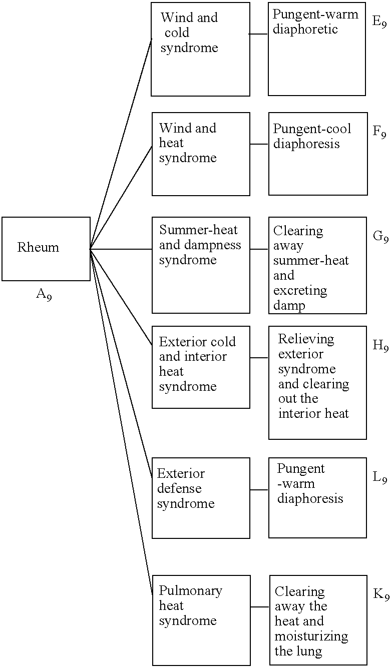

TABLE 93
Detail classification and health treatment principle of coronary heart
disease

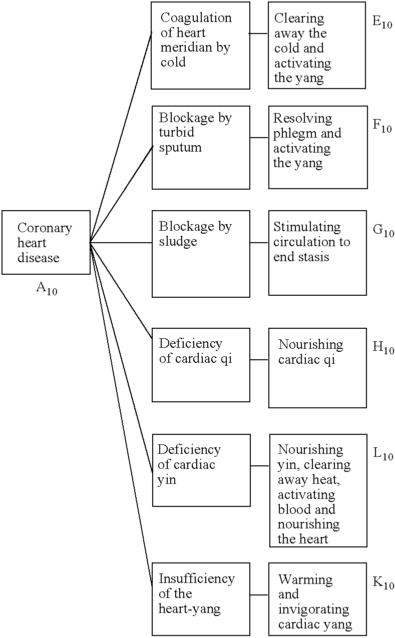

TABLE 94
Detail classification and health treatment principle of diabetes

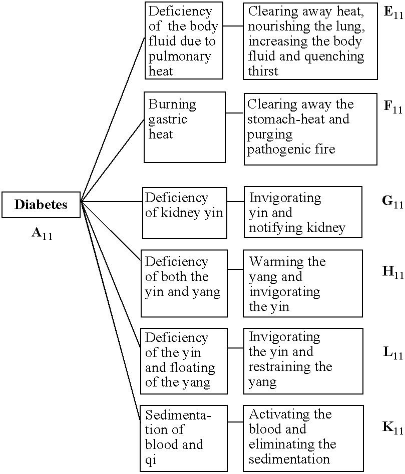

TABLE 95
Detail classification and health treatment principle of dermatosis

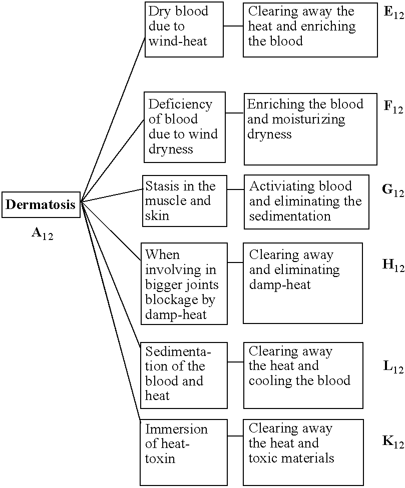

TABLE 96
Detail classification and health treatment principle of
elevated blood fat

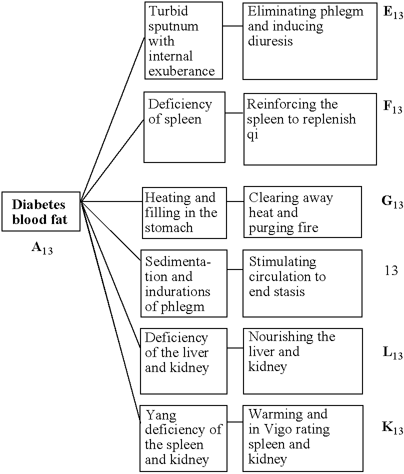

TABLE 97
Detail classification and health treatment principle of
decline of sexual function

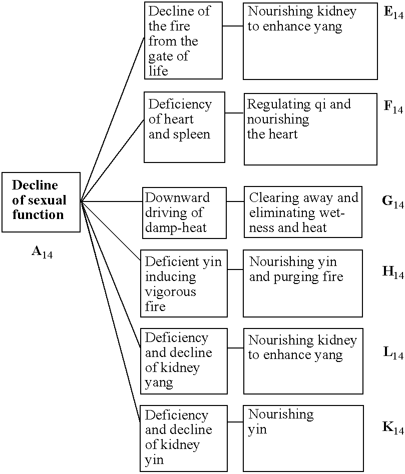

TABLE 98
Detail classification and health treatment
principle of cholecystitis

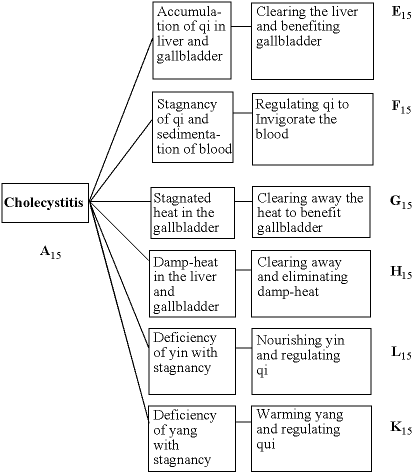

TABLE 99
Detail classification and health treatment principle of edema

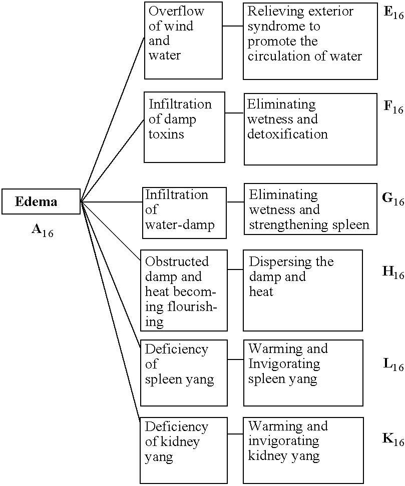

TABLE 100
Detail classification and health treatment principle of
traumatic injury

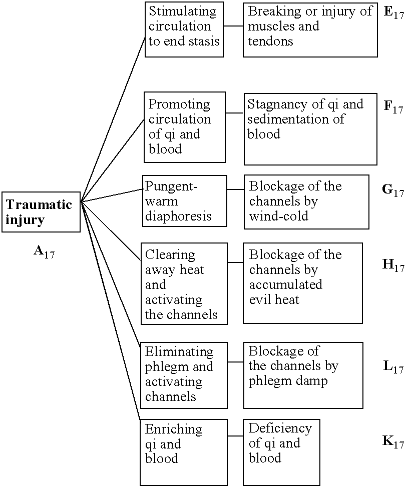

TABLE 101
Detail classification and health treatment principle of hemorrhoid

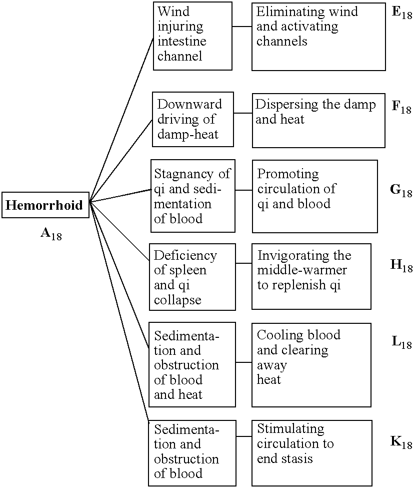

TABLE 102
Detail classification and health treatment principle of hepatitis

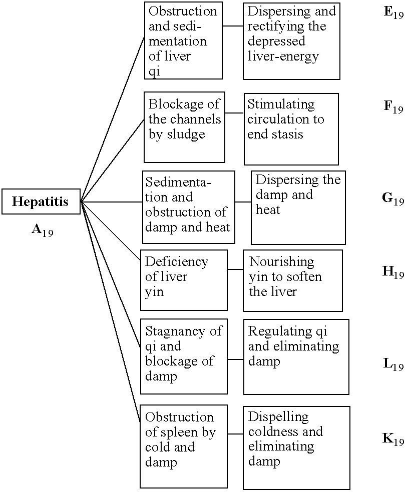

TABLE 103
Detail classification and health treatment principle of hypertension

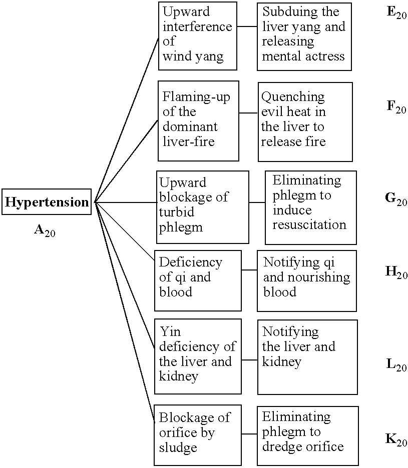

TABLE 104
Detail classification and health treatment principle of diarrhea

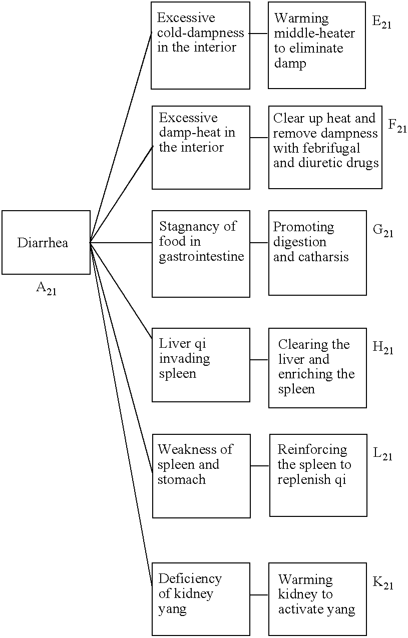

TABLE 105
Detail classification and health treatment principle of pain

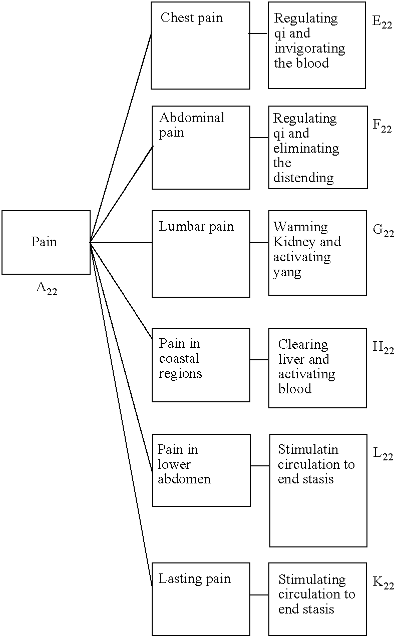

TABLE 106
Detail classification and health treatment principle of nephritis

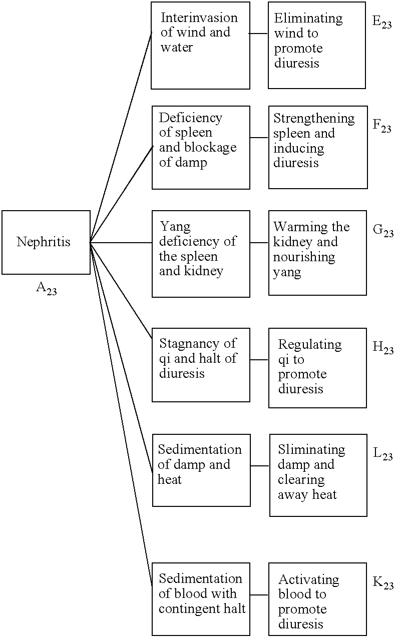

TABLE 107
Detail classification and health treatment principle of dyspepsia

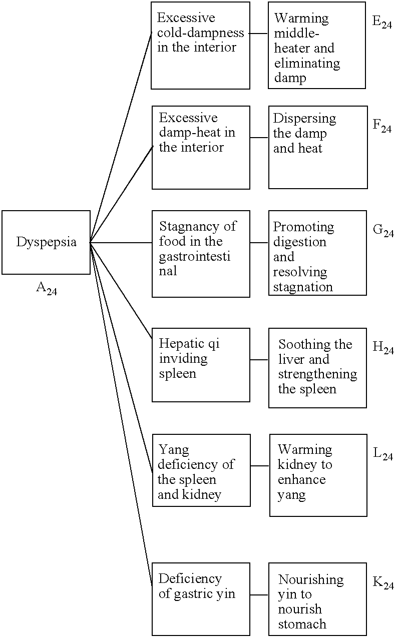

TABLE 108
Detail classification and health treatment principle of climacteric
syndrome

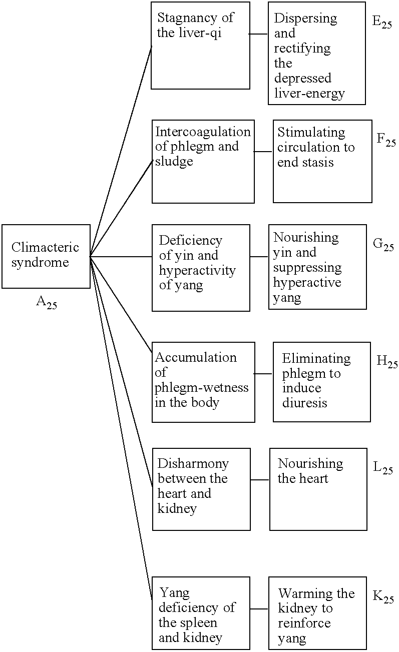

TABLE 109
Detail classification and health treatment principle of headache

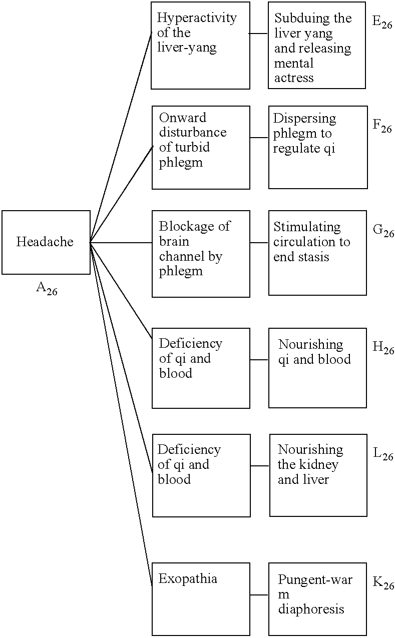

TABLE 110
Detail classification and health treatment principle of osteoporosis

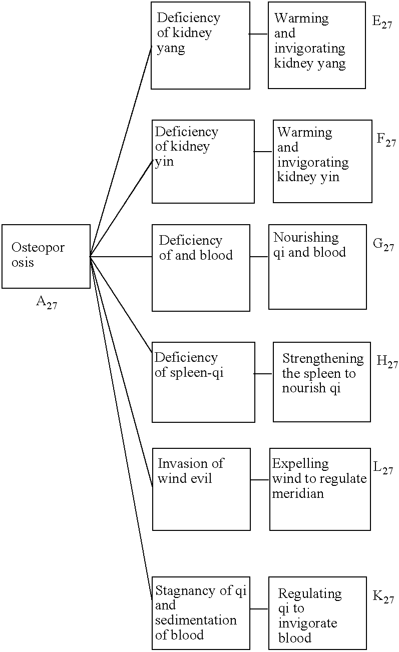

TABLE 111
Detail classification and health treatment principle of obesity

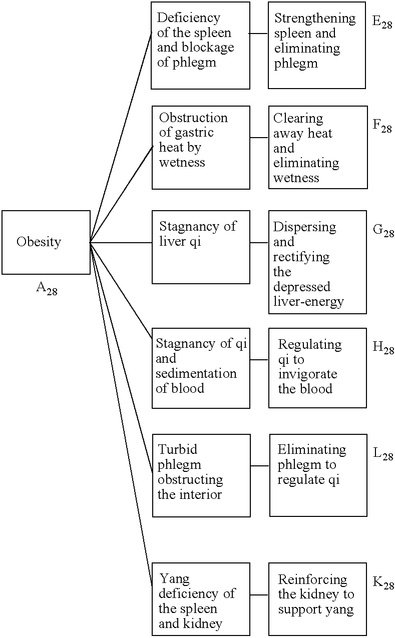

TABLE 112
Detail classification and health treatment principle of hyperplasia of
mammary glands

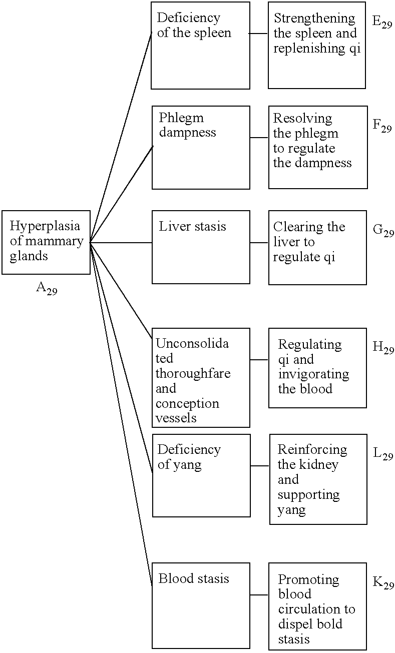

TABLE 113
Detail classification and health treatment principle of cough

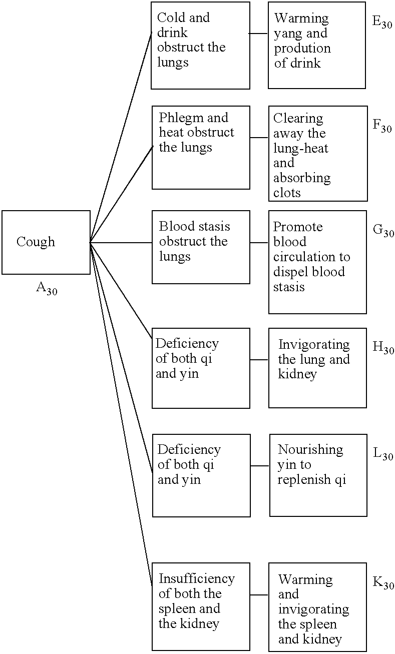

TABLE 114
Detail classification and
health treatment principle of stomach pain

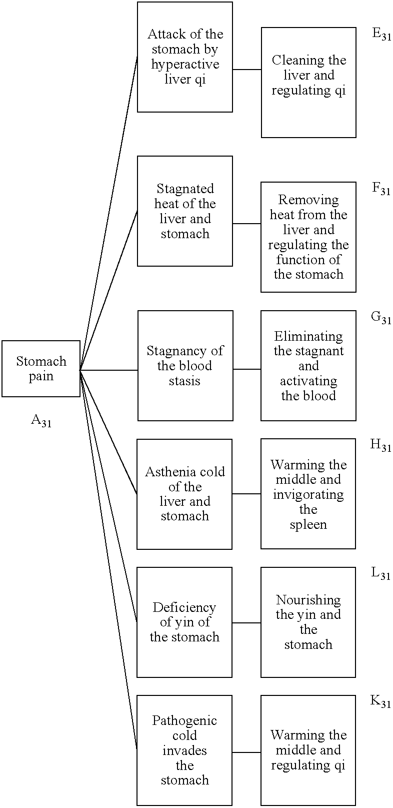

TABLE 115
Detail classification and
health treatment principle of menalgia

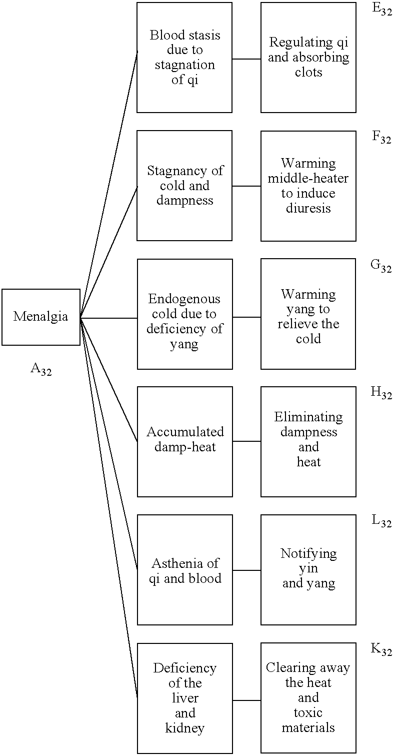

TABLE 116
Detail classification and
health treatment principle of prostatic hyperplasia

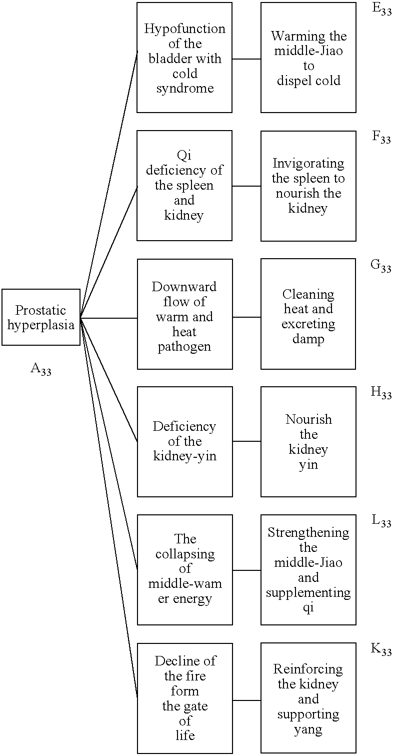

TABLE 117
Detail classification and
health treatment principle of haryngitis

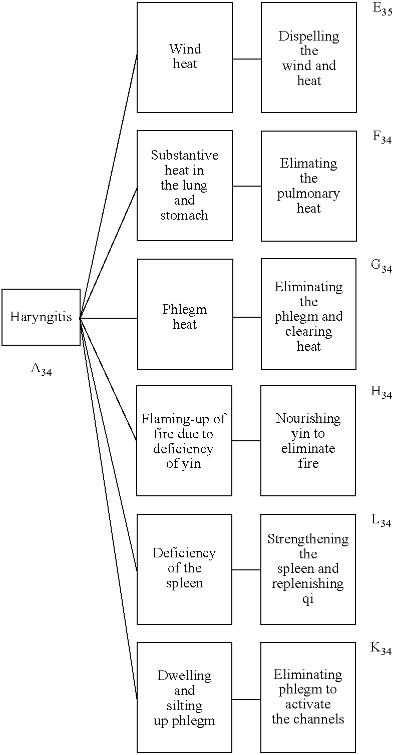

TABLE 118
Detail classification and health
treatment principle of hyperosteogeny

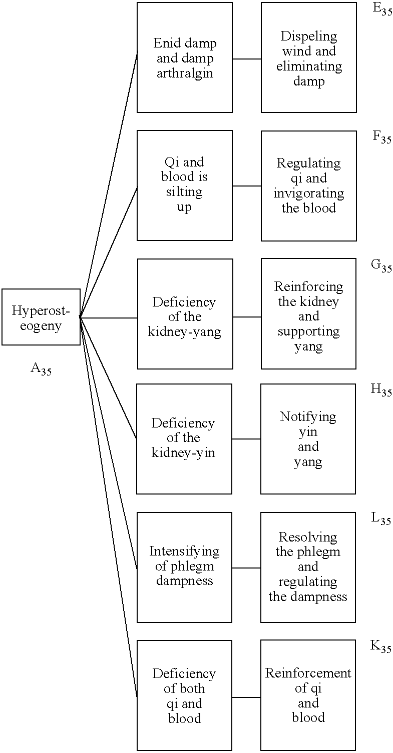

TABLE 119
Detail classification and
health treatment principle of rhinitis

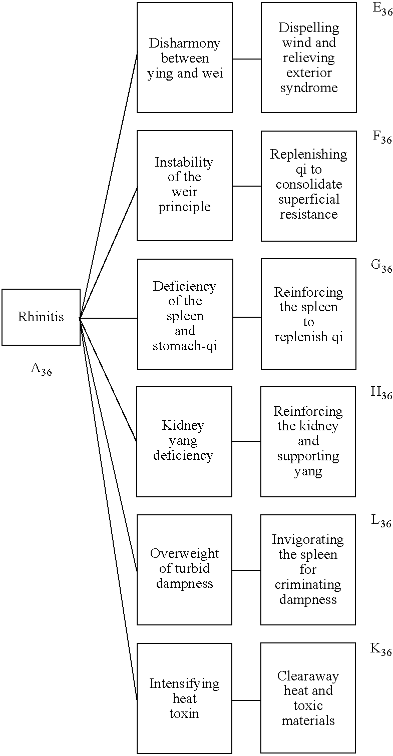

TABLE 120
Detail classification and health
treatment principle of sequela of apoplexy

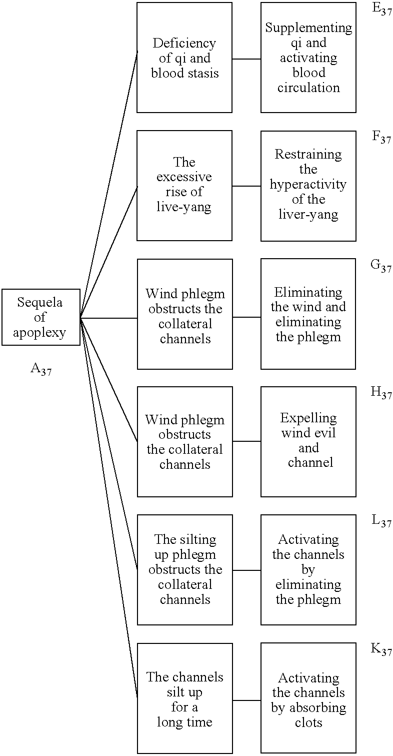

TABLE 121
Detail classification and
health treatment principle of presenility

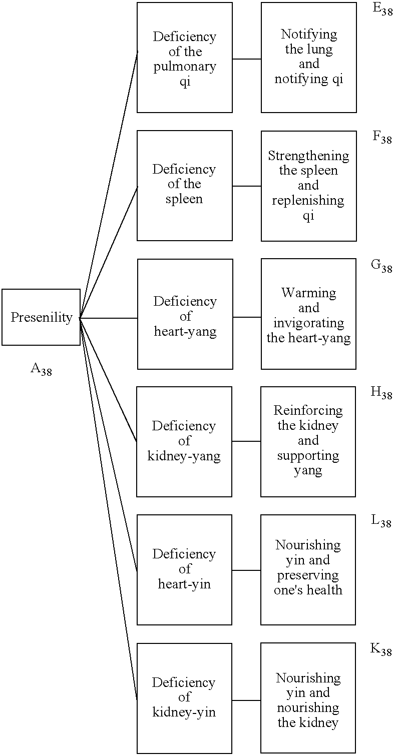

TABLE 122
Detail classification and health
treatment principle of lower grade fever

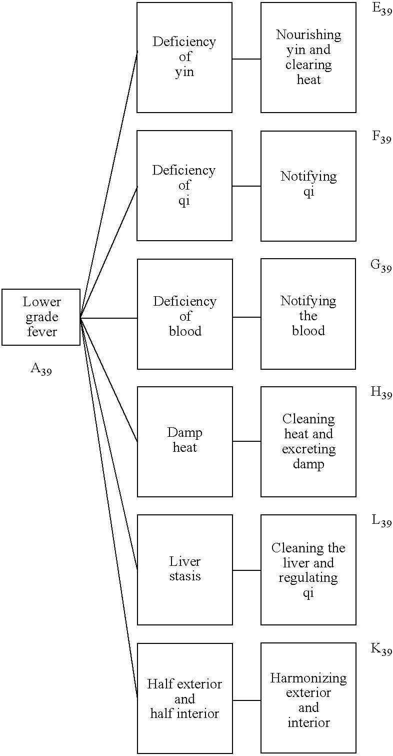

TABLE 123
Detail classification and health
treatment principle of carbuncle and sore

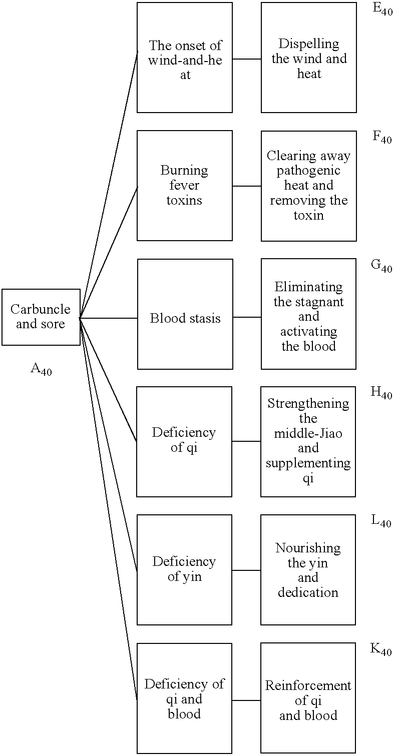

TABLE 124
Intelligent treatment plan after detail classification of macula resolving and acne

| | |
|---|---|
| 1. | a₁b₁ = a₁c₁ = b₁c₁ = a₁b₁c₁ = E₁ = A_{1—1} = B₁₄ |
| 2. | d₁e₁ = d₁f₁ = e₁f₁ = d₁e₁f₁ = F₁ = A₁₋₂ = B₂₄ |
| 3. | g₁h₁ = g₁j₁ = h₁j₁ = g₁h₁j₁ = G₁ = A₁₋₃ = B₂ |
| 4. | k₁l₁ = k₁m₁ = l₁m₁ = k₁l₁m₁ = H₁ = A₁₋₄ = B₄ |
| 5. | n₁o₁ = n₁p₁ = o₁p₁ = n₁o₁p₁ = L₁ = A₁₋₅ = B₂₆ |
| 6. | q₁r₁ = q₁s₁ = r₁s₁ = q₁r₁s₁ = k₁ = A₁₋₆ = B₆ |
| 7. | a₁b₁ = a₁c₁ = b₁c₁ = a₁b₁c₁ = d₁e₁ = d₁f₁ = e₁f₁ = d₁e₁f₁ = E₁F₁ = A₁₋₇ = B₁₄B₂₄ |
| 8. | a₁b₁ = a₁c₁ = b₁c₁ = a₁b₁c₁ = g₁h₁ = g₁j₁ = h₁j₁ = g₁h₁j₁ = E₁G₁ = A₁₋₈ = B₁₄B₂ |
| 9. | a₁b₁ = a₁c₁ = b₁c₁ = a₁b₁c₁ = k₁l₁ = k₁m₁ = l₁m₁ = k₁l₁m₁ = E₁H₁ = A₁₋₉ = B₁₄B₄ |
| 10. | a₁b₁ = a₁c₁ = b₁c₁ = a₁b₁c₁ = n₁o₁ = n₁p₁ = o₁p₁ = n₁o₁p₁ = E₁L₁ = A₁₋₁₀ = B₁₄ B₂₆ |
| 11. | a₁b₁ = a₁c₁ = b₁c₁ = a₁b₁c₁ = q₁r₁ = q₁s₁ = r₁s₁ = q₁r₁s₁ = E₁k₁ = A₁₋₁₁ = B₁₄ B₆ |
| 12. | d₁e₁ = d₁f₁ = e₁f₁ = d₁e₁f₁ = g₁h₁ = g₁j₁ = h₁j₁ = g₁h₁j₁ = F₁G₁ = A₁₋₁₂ = B₂₄ B₂ |
| 13. | d₁e₁ = d₁f₁ = e₁f₁ = d₁e₁f₁ = k₁l₁ = k₁m₁ = l₁m₁ = k₁l₁m₁ = F₁H₁ = A₁₋₁₃ = B₂₄ B₄ |
| 14. | d₁e₁ = d₁f₁ = e₁f₁ = d₁e₁f₁ = n₁o₁ = n₁p₁ = o₁p₁ = n₁o₁p₁ = F₁L₁ = A₁₋₁₄ = B₂₆ B |
| 15. | d₁e₁ = d₁f₁ = e₁f₁ = d₁e₁f₁ = q₁r₁ = q₁s₁ = r₁s₁ = q₁r₁s₁ = F₁k₁ = A₁₋₁₅ = B₂₄ B₆ |
| 16. | g₁h₁ = g₁j₁ = h₁j₁ = g₁h₁j₁ = k₁l₁ = k₁m₁ = l₁m₁ = k₁l₁m₁ = G₁H₁ = A₁₋₁₆ = B₂ B₄ |
| 17. | g₁h₁ = g₁j₁ = h₁j₁ = g₁h₁j₁ = n₁o₁ = n₁p₁ = o₁p₁ = n₁o₁p₁ = G₁L₁ = A₁₋₁₇ = B₂ B₂₆ |
| 18. | g₁h₁ = g₁j₁ = h₁j₁ = g₁h₁j₁ = q₁r₁ = q₁s₁ = r₁s₁ = q₁r₁s₁ = G₁k₁ = A₁₋₁₈ = B₂ B₆ |
| 19. | k₁l₁ = k₁m₁ = l₁m₁ = k₁l₁m₁ = n₁o₁ = n₁p₁ = o₁p₁ = n₁o₁p₁ = H₁L₁ = A₁₋₁₉ = B₄ B₂₆ |
| 20. | k₁l₁ = k₁m₁ = l₁m₁ = k₁l₁m₁ = q₁r₁ = q₁s₁ = r₁s₁ = q₁r₁s₁ = H₁k₁ = A₁₋₂₀ = B₄ B₆ |
| 21. | n₁o₁ = n₁p₁ = o₁p₁ = n₁o₁p₁ = q₁r₁ = q₁s₁ = r₁s₁ = q₁r₁s₁ = L₁k₁ = A₁₋₂₁ = B₂₆ B₆ |
| 22. | a₁b₁ = a₁c₁ = b₁c₁ = a₁b₁c₁ = d₁e₁ = d₁f₁ = e₁f₁ = d₁e₁f₁ = g₁h₁ = g₁j₁ = h₁j₁ = g₁h₁j₁ = |
| | E₁ F₁G₁ = A₁₋₂₂ = B₁₄ B₂ |
| 23. | a₁b₁ = a₁c₁ = b₁c₁ = a₁b₁c₁ = g₁h₁ = g₁j₁ = h₁j₁ = g₁h₁j₁ = k₁l₁ = k₁m₁ = l₁m₁ = k₁l₁m₁ = |
| | E₁G₁H₁ = A₁₋₂₃ = B₂ B₄ |
| 24. | a₁b₁ = a₁c₁ = b₁c₁ = a₁b₁c₁ = k₁l₁ = k₁m₁ = l₁m₁ = k₁l₁m₁ = n₁o₁ = n₁p₁ = o₁p₁ = n₁o₁p₁ = |
| | E₁H₁L₁ = A₁₋₂₄ = B₄ B₂₆ |
| 25. | a₁b₁ = a₁c₁ = b₁c₁ = a₁b₁c₁ = n₁o₁ = n₁p₁ = o₁p₁ = n₁o₁p₁ = q₁r₁ = q₁s₁ = r₁s₁ = q₁r₁s₁ = |
| | E₁L₁k₁ = A₁₋₂₅ = B₂₆ B₆ |
| 26. | d₁e₁ = d₁f₁ = e₁f₁ = d₁e₁f₁ = g₁h₁ = g₁j₁ = h₁j₁ = g₁h₁j₁ = k₁l₁ = k₁m₁ = l₁m₁ = k₁l₁m₁ = |
| | F₁G₁H₁ = A₁₋₂₆ = B₂ B₄ |
| 27. | d₁e₁ = d₁f₁ = e₁f₁ = d₁e₁f₁ = k₁l₁ = k₁m₁ = l₁m₁ = k₁l₁m₁ = n₁o₁ = n₁p₁ = o₁p₁ = n₁o₁p₁ = |
| | F₁H₁L₁ = A₁₋₂₇ = B₄ B₂₆ |
| 28. | d₁e₁ = d₁f₁ = e₁f₁ = d₁e₁f₁ = n₁o₁ = n₁p₁ = o₁p₁ = n₁o₁p₁ = q₁r₁ = q₁s₁ = r₁s₁ = q₁r₁s₁ = |
| | F₁ L₁k₁ = A₁₋₂₈ = B₂₆ B₆ |
| 29. | d₁e₁ = d₁f₁ = e₁f₁ = d₁e₁f₁ = q₁r₁ = q₁s₁ = r₁s₁ = q₁r₁s₁ = a₁b₁ = a₁c₁ = b₁c₁ = a₁b₁c₁ = |
| | F₁E₁ k₁ = A₁₋₂₉ = B₆ B₁₄ |
| 30. | g₁h₁ = g₁j₁ = h₁j₁ = g₁h₁j₁ = k₁l₁ = k₁m₁ = l₁m₁ = k₁l₁m₁ = n₁o₁ = n₁p₁ = o₁p₁ = n₁o₁p₁ = |
| | G₁H₁L₁ = A₁₋₃₀ = B₂ B₄ |
| 31. | g₁h₁ = g₁j₁ = h₁j₁ = g₁h₁j₁ = n₁o₁ = n₁p₁ = o₁p₁ = n₁o₁p₁ = q₁r₁ = q₁s₁ = r₁s₁ = q₁r₁s₁ = |
| | G₁ L₁k₁ = A₁₋₃₁ = B₂ B₆ |
| 32. | g₁h₁ = g₁j₁ = h₁j₁ = g₁h₁j₁ = q₁r₁ = q₁s₁ = r₁s₁ = q₁r₁s₁ = a₁b₁ = a₁c₁ = b₁c₁ = a₁b₁c₁ = |
| | G₁ k₁E₁ = A₁₋₃₂ = B₂ B₆ |
| 33. | g₁h₁ = g₁j₁ = h₁j₁ = g₁h₁j₁ = a₁b₁ = a₁c₁ = b₁c₁ = a₁b₁c₁ = d₁e₁ = d₁f₁ = e₁f₁ = d₁e₁f₁ = |
| | G₁E₁F₁ = A₁₋₃₃ = B₂ B₁₄ |
| 34. | k₁l₁ = k₁m₁ = l₁m₁ = k₁l₁m₁ = n₁o₁ = n₁p₁ = o₁p₁ = n₁o₁p₁ = q₁r₁ = q₁s₁ = r₁s₁ = q₁r₁s₁ = |
| | H₁L₁k₁ = A₁₋₃₄ = B₄ B₆ |
| 35. | k₁l₁ = k₁m₁ = l₁m₁ = k₁l₁m₁ = q₁r₁ = q₁s₁ = r₁s₁ = q₁r₁s₁ = a₁b₁ = a₁c₁ = b₁c₁ = a₁b₁c₁ = |
| | H₁k₁E₁ = A₁₋₃₅ = B₄ B₆ |
| 36. | k₁l₁ = k₁m₁ = l₁m₁ = k₁l₁m₁ = a₁b₁ = a₁c₁ = b₁c₁ = a₁b₁c₁ = d₁e₁ = d₁f₁ = e₁f₁ = d₁e₁f₁ = |
| | H₁E₁F₁ = A₁₋₃₆ = B₄ B₁₄ |
| 37. | k₁l₁ = k₁m₁ = l₁m₁ = k₁l₁m₁ = d₁e₁ = d₁f₁ = e₁f₁ = d₁e₁f₁ = g₁h₁ = g₁j₁ = h₁j₁ = g₁h₁j₁ = |
| | H₁F₁G₁ = A₁₋₃₇ = B₄ B₂ |
| 38. | n₁o₁ = n₁p₁ = o₁p₁ = n₁o₁p₁ = q₁r₁ = q₁s₁ = r₁s₁ = q₁r₁s₁ = a₁b₁ = a₁c₁ = b₁c₁ = a₁b₁c₁ = |
| | L₁k₁E₁ = A₁₋₃₈ = B₂₆ B₆ |
| 39. | n₁o₁ = n₁p₁ = o₁p₁ = n₁o₁p₁ = a₁b₁ = a₁c₁ = b₁c₁ = a₁b₁c₁ = d₁e₁ = d₁f₁ = e₁f₁ = d₁e₁f₁ = |
| | L₁E₁F₁ = A₁₋₃₉ = B₂₆ B₁₄ |
| 40. | n₁o₁ = n₁p₁ = o₁p₁ = n₁o₁p₁ = d₁e₁ = d₁f₁ = e₁f₁ = d₁e₁f₁ = g₁h₁ = g₁j₁ = h₁j₁ = g₁h₁j₁ = |
| | L₁F₁G₁ = A₁₋₄₀ = B₂₆ B₂ |
| 41. | n₁o₁ = n₁p₁ = o₁p₁ = n₁o₁p₁ = g₁h₁ = g₁j₁ = h₁j₁ = g₁h₁j₁ = k₁l₁ = k₁m₁ = l₁m₁ = k₁l₁m₁ = |
| | L₁G₁H₁ = A₁₋₄₁ = B₂ B₄ |
| 42. | q₁r₁ = q₁s₁ = r₁s₁ = q₁r₁s₁ = a₁b₁ = a₁c₁ = b₁c₁ = a₁b₁c₁ = d₁e₁ = d₁f₁ = e₁f₁ = d₁e₁f₁ = |
| | k₁E₁F₁ = A₁₋₄₂ = B₆ B₁₄ |
| 43. | q₁r₁ = q₁s₁ = r₁s₁ = q₁r₁s₁ = d₁e₁ = d₁f₁ = e₁f₁ = d₁e₁f₁ = g₁h₁ = g₁j₁ = h₁j₁ = g₁h₁j₁ = |
| | k₁ F₁G₁ = A₁₋₄₃ = B₆ B₁₂ |
| 44. | q₁r₁ = q₁s₁ = r₁s₁ = q₁r₁s₁ = g₁h₁ = g₁j₁ = h₁j₁ = g₁h₁j₁ = k₁l₁ = k₁m₁ = l₁m₁ = k₁l₁m₁ = |
| | k₁G₁H₁ = A₁₋₄₄ = B₆ B₂ |
| 45. | q₁r₁ = q₁s₁ = r₁s₁ = q₁r₁s₁ = k₁l₁ = k₁m₁ = l₁m₁ = k₁l₁m₁ = n₁o₁ = n₁p₁ = o₁p₁ = n₁o₁p₁ = |
| | k₁H₁L₁ = A₁₋₄₅ = B₆ B₄ |
| 46. | a₁b₁ = a₁c₁ = b₁c₁ = a₁b₁c₁ = g₁h₁ = g₁j₁ = h₁j₁ = g₁h₁j₁ = n₁o₁ = n₁p₁ = o₁p₁ = n₁o₁p₁ = |
| | E₁G₁L₁ = A₁₋₄₆ = B₂ B₂₆ |
| 47. | a₁b₁ = a₁c₁ = b₁c₁ = a₁b₁c₁ = k₁l₁ = k₁m₁ = l₁m₁ = k₁l₁m₁ = q₁r₁ = q₁s₁ = r₁s₁ = q₁r₁s₁ = |
| | E₁H₁k₁ = A₁₋₄₇ = B₄ B₆ |
| 48. | d₁e₁ = d₁f₁ = e₁f₁ = d₁e₁f₁ = k₁l₁ = k₁m₁ = l₁m₁ = k₁l₁m₁ = q₁r₁ = q₁s₁ = r₁s₁ = q₁r₁s₁ = |
| | F₁ H₁k₁ = A₁₋₄₈ = B₄ B₆ |
| 49. | d₁e₁ = d₁f₁ = e₁f₁ = d₁e₁f₁ = n₁o₁ = n₁p₁ = o₁p₁ = n₁o₁p₁ = a₁b₁ = a₁c₁ = b₁c₁ = a₁b₁c₁ = |
| | F₁L₁E₁ = A₁₋₄₉ = B₂₆ B₁₄ |
| 50. | g₁h₁ = g₁j₁ = h₁j₁ = g₁h₁j₁ = n₁o₁ = n₁p₁ = o₁p₁ = n₁o₁p₁ = a₁b₁ = a₁c₁ = b₁c₁ = a₁b₁c₁ = |
| | G₁L₁E₁ = A₁₋₅₀ = B₂ B₂₆ |
| 51. | g₁h₁ = g₁j₁ = h₁j₁ = g₁h₁j₁ = q₁r₁ = q₁s₁ = r₁s₁ = q₁r₁s₁ = d₁e₁ = d₁f₁ = e₁f₁ = d₁e₁f₁ = |
| | Gk₁F₁ = A₁₋₅₁ = B₂ B₆ |
| 52. | k₁l₁ = k₁m₁ = l₁m₁ = k₁l₁m₁ = q₁r₁ = q₁s₁ = r₁s₁ = q₁r₁s₁ = d₁e₁ = d₁f₁ = e₁f₁ = d₁e₁f₁ = |
| | H₁ k₁F₁ = A₁₋₅₂ = B₄ B₆ |
| 53. | k₁l₁ = k₁m₁ = l₁m₁ = k₁l₁m₁ = a₁b₁ = a₁c₁ = b₁c₁ = a₁b₁c₁ = g₁h₁ = g₁j₁ = h₁j₁ = g₁h₁j₁ = |
| | H₁E₁G₁ = A₁₋₅₃ = B₄ B₂ |
| 54. | n₁o₁ = n₁p₁ = o₁p₁ = n₁o₁p₁ = a₁b₁ = a₁c₁ = b₁c₁ = a₁b₁c₁ = g₁h₁ = g₁j₁ = h₁j₁ = g₁h₁j₁ = |
| | L₁E₁G₁ = A₁₋₅₄ = B₂₆ B₂ |
| 55. | n₁o₁ = n₁p₁ = o₁p₁ = n₁o₁p₁ = d₁e₁ = d₁f₁ = e₁f₁ = d₁e₁f₁ = k₁l₁ = k₁m₁ = l₁m₁ = k₁l₁m₁ = |
| | L₁F₁H₁ = A₁₋₅₅ = B₂₆ B₄ |
| 56. | q₁r₁ = q₁s₁ = r₁s₁ = q₁r₁s₁ = d₁e₁ = d₁f₁ = e₁f₁ = d₁e₁f₁ = k₁l₁ = k₁m₁ = l₁m₁ = k₁l₁m₁ = |
| | k₁ F₁H₁ = A₁₋₅₆ = B₆ B₄ |
| 57. | q₁r₁ = q₁s₁ = r₁s₁ = q₁r₁s₁ = g₁h₁ = g₁j₁ = h₁j₁ = g₁h₁j₁ = n₁o₁ = n₁p₁ = o₁p₁ = n₁o₁p₁ = |
| | k₁G₁L₁ = A₁₋₅₇ = B₆ B₂ |
| 58. | a₁b₁ = a₁c₁ = b₁c₁ = a₁b₁c₁ = d₁e₁ = d₁f₁ = e₁f₁ = d₁e₁f₁ = g₁h₁ = g₁j₁ = h₁j₁ = g₁h₁j₁ = |
| | k₁l₁ = k₁m₁ = l₁m₁ = k₁l₁m₁ = E₁F₁G₁H₁ = A₁₋₅₈ = B₂ B₄ |
| 59. | a₁b₁ = a₁c₁ = b₁c₁ = a₁b₁c₁ = g₁h₁ = g₁j₁ = h₁j₁ = g₁h₁j₁ = k₁l₁ = k₁m₁ = l₁m₁ = k₁l₁m₁ = |
| | n₁o₁ = n₁p₁ = o₁p₁ = n₁o₁p₁ = E₁G₁H₁L₁ = A₁₋₅₉ = B₄ B₂₆ |
| 60. | a₁b₁ = a₁c₁ = b₁c₁ = a₁b₁c₁ = k₁l₁ = k₁m₁ = l₁m₁ = k₁l₁m₁ = n₁o₁ = n₁p₁ = o₁p₁ = n₁o₁p₁ = |
| | q₁r₁ = q₁s₁ = r₁s₁ = q₁r₁s₁ = E₁H₁L₁k₁ = A₁₋₆₀ = B₄ B₆ |
| 61. | d₁e₁ = d₁f₁ = e₁f₁ = d₁e₁f₁ = g₁h₁ = g₁j₁ = h₁j₁ = g₁h₁j₁ = k₁l₁ = k₁m₁ = l₁m₁ = k₁l₁m₁ = n₁o₁ = |
| | n₁p₁ = o₁p₁ = n₁o₁p₁ = F₁G₁H₁L₁ = A₁₋₆₁ = B₄ B₂₆ |
| 62. | d₁e₁ = d₁f₁ = e₁f₁ = d₁e₁f₁ = k₁l₁ = k₁m₁ = l₁m₁ = k₁l₁m₁ = n₁o₁ = n₁p₁ = o₁p₁ = n₁o₁p₁ = |
| | q₁r₁ = q₁s₁ = r₁s₁ = q₁r₁s₁ = F₁H₁L₁k₁ = A₁₋₆₂ = B₄ B₆ |
| 63. | d₁e₁ = d₁f₁ = e₁f₁ = d₁e₁f₁ = n₁o₁ = n₁p₁ = o₁p₁ = n₁o₁p₁ = q₁r₁ = q₁s₁ = r₁s₁ = |
| | q₁r₁s₁ = a₁b₁ = a₁c₁ = b₁c₁ = a₁b₁c₁ = F₁L₁k₁E₁ = A₁₋₆₃ = B₂₆ B₆ |
| 64. | g₁h₁ = g₁j₁ = h₁j₁ = g₁h₁j₁ = k₁l₁ = k₁m₁ = l₁m₁ = k₁l₁m₁ = n₁o₁ = n₁p₁ = o₁p₁ = n₁o₁p₁ = |
| | q₁r₁ = q₁s₁ = r₁s₁ = q₁r₁s₁ = G₁H₁L₁k₁ = A₁₋₆₄ = B₂ B₆ |
| 65. | g₁h₁ = g₁j₁ = h₁j₁ = g₁h₁j₁ = n₁o₁ = n₁p₁ = o₁p₁ = n₁o₁p₁ = q₁r₁ = q₁s₁ = r₁s₁ = |
| | q₁r₁s₁ = a₁b₁ = a₁c₁ = b₁c₁ = a₁b₁c₁ == G₁L₁k₁E₁ = A₁₋₆₅ = B₂ B₆ |
| 66. | g₁h₁ = g₁j₁ = h₁j₁ = g₁h₁j₁ = q₁r₁ = q₁s₁ = r₁s₁ = q₁r₁s₁ = a₁b₁ = a₁c₁ = b₁c₁ = |
| | a₁b₁c₁ = d₁e₁ = d₁f₁ = e₁f₁ = d₁e₁f₁ = G₁k₁E₁F₁ = A₁₋₆₆ = B₆ B₄ |
| 67. | k₁l₁ = k₁m₁ = l₁m₁ = k₁l₁m₁ = n₁o₁ = n₁p₁ = o₁p₁ = n₁o₁p₁ = q₁r₁ = q₁s₁ = r₁s₁ = q₁r₁s₁ = |
| | a₁b₁ = a₁c₁ = b₁c₁ = a₁b₁c₁ = H₁L₁k₁E₁ = A₁₋₆₇ = B₄ B₆ |
| 68. | k₁l₁ = k₁m₁ = l₁m₁ = k₁l₁m₁ = q₁r₁ = q₁s₁ = r₁s₁ = q₁r₁s₁ = a₁b₁ = a₁c₁ = b₁c₁ = |
| | a₁b₁c₁ = d₁e₁ = d₁f₁ = e₁f₁ = d₁e₁f₁ = H₁k₁E₁F₁ = A₁₋₆₈ = B₄ B₆ |
| 69. | k₁l₁ = k₁m₁ = l₁m₁ = k₁l₁m₁ = a₁b₁ = a₁c₁ = b₁c₁ = a₁b₁c₁ = d₁e₁ = d₁f₁ = e₁f₁ = |
| | d₁e₁f₁ = g₁h₁ = g₁j₁ = h₁j₁ = g₁h₁j₁ = H₁E₁F₁G₁ = A₁₋₆₉ = B₄ B₂ |
| 70. | n₁o₁ = n₁p₁ = o₁p₁ = n₁o₁p₁ = q₁r₁ = q₁s₁ = r₁s₁ = q₁r₁s₁ = a₁b₁ = a₁c₁ = b₁c₁ = a₁b₁c₁ = |
| | d₁e₁ = d₁f₁ = e₁f₁ = d₁e₁f₁ = L₁k₁E₁F₁ = A₁₋₇₀ = B₂₆ B₆ |
| 71. | n₁o₁ = n₁p₁ = o₁p₁ = n₁o₁p₁ = a₁b₁ = a₁c₁ = b₁c₁ = a₁b₁c₁ = d₁e₁ = d₁f₁ = e₁f₁ = d₁e₁f₁ = |
| | g₁h₁ = g₁j₁ = h₁j₁ = g₁h₁j₁ = L₁E₁F₁G₁ = A₁₋₇₁ = B₂₆ B₂ |
| 72. | n₁o₁ = n₁p₁ = o₁p₁ = n₁o₁p₁d₁e₁ = d₁f₁ = e₁f₁ = d₁e₁f₁ = g₁h₁ = g₁j₁ = h₁j₁ = g₁h₁j₁ = |
| | k₁l₁ = k₁m₁ = l₁m₁ = k₁l₁m₁ = L₁F₁G₁H₁ = A₁₋₇₂ = B₂ B₄ |
| 73. | q₁r₁ = q₁s₁ = r₁s₁ = q₁r₁s₁ = a₁b₁ = a₁c₁ = b₁c₁ = a₁b₁c₁ = d₁e₁ = d₁f₁ = e₁f₁ = d₁e₁f₁ = |
| | g₁h₁ = g₁j₁ = h₁j₁ = g₁h₁j₁ = k₁E₁G₁F₁ = A₁₋₇₃ = B₆ B₂ |
| 74. | q₁r₁ = q₁s₁ = r₁s₁ = q₁r₁s₁ = d₁e₁ = d₁f₁ = e₁f₁ = d₁e₁f₁ = g₁h₁ = g₁j₁ = h₁j₁ = g₁h₁j₁ = |
| | k₁l₁ = k₁m₁ = l₁m₁ = k₁l₁m₁ = k₁F₁G₁H₁ = A₁₋₇₄ = B₆ B₂ |
| 75. | q₁r₁ = q₁s₁ = r₁s₁ = q₁r₁s₁ = g₁h₁ = g₁j₁ = h₁j₁ = g₁h₁j₁ = k₁l₁ = k₁m₁ = l₁m₁ = k₁l₁m₁ = |
| | n₁o₁ = n₁p₁ = o₁p₁ = n₁o₁p₁ = k₁L₁H₁G₁ = A₁₋₇₅ = B₆ B₄ |
| 76. | a₁b₁ = a₁c₁ = b₁c₁ = a₁b₁c₁ = d₁e₁ = d₁f₁ = e₁f₁ = d₁e₁f₁ = k₁l₁ = k₁m₁ = l₁m₁ = k₁l₁m₁ = |
| | n₁o₁ = n₁p₁ = o₁p₁ = n₁o₁p₁ = E₁F₁H₁L₁ = A₁₋₇₆ = B₄ B₂₆ |
| 77. | a₁b₁ = a₁c₁ = b₁c₁ = a₁b₁c₁ = d₁e₁ = d₁f₁ = e₁f₁ = d₁e₁f₁ = n₁o₁ = n₁p₁ = o₁p₁ = n₁o₁p₁ = |
| | q₁r₁ = q₁s₁ = r₁s₁ = q₁r₁s₁ = k₁F₁L₁E₁ = A₁₋₇₇ = B₂₆ B₆ |
| 78. | d₁e₁ = d₁f₁ = e₁f₁ = d₁e₁f₁ = F₁ = g₁h₁ = g₁j₁ = h₁j₁ = g₁h₁j₁ = n₁o₁ = n₁p₁ = o₁p₁ = n₁o₁p₁ = |
| | q₁r₁ =q₁s₁ = r₁s₁ = q₁r₁s₁ = A₁G₁L₁k₁ = A₁₋₇₈ = B₂ B₆ |
| 79. | d₁e₁ = d₁f₁ = e₁f₁ = d₁e₁f₁ = g₁h₁ = g₁j₁ = h₁j₁ = g₁h₁j₁ = q₁r₁ = q₁s₁ = r₁s₁ = q₁r₁s₁ = |
| | a₁b₁ = a₁c₁ = b₁c₁ = a₁b₁c₁ = F₁G₁k₁E₁ = A₁₋₇₉ = B₂ B₆ |
| 80. | g₁h₁ = g₁j₁ = h₁j₁ = g₁h₁j₁ = k₁l₁ = k₁m₁ = l₁m₁ = k₁l₁m₁ = q₁r₁ = q₁s₁ = r₁s₁ = q₁r₁s₁ = |
| | a₁b₁ = a₁c₁ = b₁c₁ = a₁b₁c₁ = G₁H₁k₁E₁ = A₁₋₈₀ = B₂ B₆ |
| 81. | g₁h₁ = g₁j₁ = h₁j₁ = g₁h₁j₁ = k₁l₁ = k₁m₁ = l₁m₁ = k₁l₁m₁ = a₁b₁ = a₁c₁ = b₁c₁ = |
| | a₁b₁c₁ = d₁e₁ = d₁f₁ = e₁f₁ = d₁e₁f₁ = G₁H₁E₁F₁ = A₁₋₈₁ = B₂ B₄ |
| 82. | k₁l₁ = k₁m₁ = l₁m₁ = k₁l₁m₁ = n₁o₁ = n₁p₁ = o₁p₁ = n₁o₁p₁ = a₁b₁ = a₁c₁ = b₁c₁ = |
| | a₁b₁c₁ = d₁e₁ = d₁f₁ = e₁f₁ = d₁e₁f₁ = H₁L₁E₁F₁ = A₁₋₈₂ = B₄ B₂₆ |
| 83. | k₁l₁ = k₁m₁ = l₁m₁ = k₁l₁m₁ = n₁o₁ = n₁p₁ = o₁p₁ = n₁o₁p₁ = d₁e₁ = d₁f₁ = e₁f₁ = d₁e₁f₁ = |
| | g₁h₁ = g₁j₁ = h₁j₁ = g₁h₁j₁ = H₁L₁F₁G₁ = A₁₋₈₃ = B₄ B₂ |
| 84. | n₁o₁ = n₁p₁ = o₁p₁ = n₁o₁p₁ = q₁r₁ = q₁s₁ = r₁s₁ = q₁r₁s₁ = g₁h₁ = g₁j₁ = h₁j₁ = |
| | g₁h₁j₁ = k₁l₁ = k₁m₁ = l₁m₁ = k₁l₁m₁ = L₁k₁G₁H₁ = A₁₋₈₄ = B₂B₄ |
| 85. | q₁r₁ = q₁s₁ = r₁s₁ = q₁r₁s₁ = a₁b₁ = a₁c₁ = b₁c₁ = a₁b₁c₁ = g₁h₁ = g₁j₁ = h₁j₁ = |
| | g₁h₁j₁ = k₁l₁ = k₁m₁ = l₁m₁ = k₁l₁m₁ = k₁E₁G₁H₁ = A₁₋₈₅ = B₆ B₂ |
| 86. | q₁r₁ = q₁s₁ = r₁s₁ = q₁r₁s₁ = a₁b₁ = a₁c₁ = b₁c₁ = a₁b₁c₁ = k₁l₁ = k₁m₁ = l₁m₁ = |
| | k₁l₁m₁ = n₁o₁ = n₁p₁ = o₁p₁ = n₁o₁p₁ = k₁E₁H₁L₁ = A₁₋₈₆ = B₆ B₄ |
| 87. | a₁b₁ = a₁c₁ = b₁c₁ = a₁b₁c₁ = g₁h₁ = g₁j₁ = h₁j₁ = g₁h₁j₁ = n₁o₁ = n₁p₁ = o₁p₁ = |
| | n₁o₁p₁ = q₁r₁ = q₁s₁ = r₁s₁ = q₁r₁s₁ = E₁G₁L₁k₁ = A₁₋₈₇ = B₂ B₆ |
| 88. | d₁e₁ = d₁f₁ = e₁f₁ = d₁e₁f₁ = k₁l₁ = k₁m₁ = l₁m₁ = k₁l₁m₁ = q₁r₁ = q₁s₁ = r₁s₁ = q₁r₁s₁ = |
| | a₁b₁ = a₁c₁ = b₁c₁ = a₁b₁c₁ = F₁H₁k₁E₁ = A₁₋₈₈ = B₄ B₆ |
| 89. | g₁h₁ = g₁j₁ = h₁j₁ = g₁h₁j₁ = n₁o₁ = n₁p₁ = o₁p₁ = n₁o₁p₁ = a₁b₁ = a₁c₁ = b₁c₁ = |
| | a₁b₁c₁ = d₁e₁ = d₁f₁ = e₁f₁ = d₁e₁f₁ = G₁L₁E₁F₁ = A₁₋₈₉ = B₂ B₂₆ |
| 90. | k₁l₁ = k₁m₁ = l₁m₁ = k₁l₁m₁ = q₁r₁ = q₁s₁ = r₁s₁ = q₁r₁s₁ = d₁e₁ = d₁f₁ = e₁f₁ = d₁e₁f₁ = |
| | g₁h₁ = g₁j₁ = h₁j₁ = g₁h₁j₁ = H₁k₁F₁G₁ = A₁₋₉₀ = B₆ B₂ |
| 91. | n₁o₁ = n₁p₁ = o₁p₁ = n₁o₁p₁ = a₁b₁ = a₁c₁ = b₁c₁ = a₁b₁c₁ = g₁h₁ = g₁j₁ = h₁j₁ = g₁h₁j₁ = k₁l₁ = |
| | k₁m₁ = l₁m₁ = k₁l₁m₁ = L₁E₁G₁H₁ = A₁₋₉₁ = B₂ B₄ |
| 92. | q₁r₁ = q₁s₁ = r₁s₁ = q₁r₁s₁ = d₁e₁ = d₁f₁ = e₁f₁ = d₁e₁f₁ = k₁l₁ = k₁m₁ = l₁m₁ = k₁l₁m₁ = |
| | n₁o₁ = n₁p₁ = o₁p₁ = n₁o₁p₁ = k₁F₁H₁L₁ = A₁₋₉₂ = B₆ B₄ |

TABLE 125
A₁ Macula resolving and acne formula label

| | |
|---|---|
| Concentrated Powder from Buffalo Horn | 1.66% |
| Dried Garden Ginseng | 6.66% |
| Lucid Ganoderma | 12.5% |
| Dried rhizome of Rehmannia | 33.34% |
| Fruit of Beautiful Sweetgum | 12.5% |
| Root of Costal Glehnia | 4.18% |
| Motherwort Herb | 16.66% |
| Root of Tonkin Sophora | 12.5% |
| Total | 100% |

TABLE 126
A₂ Senile cretinism formula label

| | |
|---|---|
| Rhizome of Grassleaf Sweetflag | 8.45% |
| Dried Rhizome of Adhesive Rehnmannia | 11.66% |
| Tuber of Dwarf Lilyturf | 11.66% |
| Root of Tuber Fleece flower | 5.63% |
| Radix Salviae Miltiorrhizae | 5.63% |
| Radix Notoginseng | 3.52% |
| Ginseng | 5.63% |
| Rhizome of Oriental Waterplantain | 5.63% |
| Liquorice Root | 5.63% |
| Herb of Shorthorned Epimedium | 5.63% |
| Root of Thinleaf Milkwort | 2.82% |
| Fruit of Chinese Magnoliavine | 5.63% |
| Fruit of Asiatic Cornelian | 5.63% |
| Eucommia Bark | 5.63% |
| Bulb of Tendrilleaf Fritillary | 5.63% |
| Total | 100% |

TABLE 127
A₃ Anemia formula label

| | |
|---|---|
| Root of Mongolian Milkvetch | 13.42% |
| Chinese Angelica | 10.83% |
| Rhizome of Szechwan Lovage | 8.87% |
| Motherdwort Herb | 26.85% |
| Dodder Seed | 8.87% |
| Adhesive Rehmannica | 13.42% |
| Root of Tuber Fleeceflower | 8.87% |
| Herb of Shorthorned Epimedium | 8.87% |
| Total | 100% |

TABLE 128
A₄ Neurasthenia formula label

| | |
|---|---|
| Jujube | 33.21% |
| Radix Salviae Miltiorrhizae | 23.72% |
| Prepared Rhizome of Adhesive Rehmannia | 11.86% |
| Tangerine Peel | 5.98% |
| Rhizome of Largehead Atractyloades | 8.92% |
| Stem of Tuber Fleeceflower | 11.86% |
| Root of Thinleaf Milkwort | 4.45% |
| Total | 100% |

TABLE 129
A₅ Arthritis formula label

| | |
|---|---|
| Herb of Common St.Paulswort | 9.72% |
| Rhizome of East Asian Tree Fern | 13.49% |
| Herb of Common Clubmoss | 13.49% |
| Rhiazome of Szechwan Lovage | 6.49% |
| Cassia Bark | 1.62% |
| Cosrusroot | 1.62% |
| Stem of Suberect Spatholobus | 3.89% |
| Root of Largeeaf Gentian | 13.49% |
| Herb of Wilford Cranesbill | 6.49% |
| Root of Fourstamen Stephania | 9.72% |
| Root of Doubleteeth Pubscent Angelica | 6.24% |
| Mulberry Twig | 6.49% |
| Root-bark of Slenderslyle Acanthopanax | 6.24% |
| Total | 100% |

TABLE 130
A₆ Tracheal catarrh formula label

| | |
|---|---|
| Honeysuckle Flower | 29.18% |
| Capsule of Weeping Forsythia | 29.18% |
| Root of Baikal Skullcap | 14.40% |
| Red Peony Root | 13.51% |
| Rhubarb | 9.73% |
| Total | 100% |

TABLE 131
A₇ Vaginitis formula label

| | |
|---|---|
| Honetsuckle Stem | 24.39% |
| Stem of Sargentgloryvine | 24.39% |
| Leaf of Indigowoad | 7.32% |
| Rhizoma Corydalis | 7.32% |
| Rhizome of Oriental Waterplantain | 4.88% |
| Liquorice Root | 2.44% |
| Red Peony Root | 7.32% |
| Dandelion | 7.32% |
| Tree Peony Bark | 7.32% |
| Fruit of Szechwan Chinaberry | 7.32% |
| Total | 100% |

TABLE 132
A₈ Long term apocamnosis formula label

| | |
|---|---|
| Dried Garden Ginseng | 25% |
| Adhesive Rehmannia | 25% |
| Rhizome of Oriental Waterplantain | 25% |
| Herb of Shorthorned Epimedium | 25% |
| Total | 100% |

TABLE 133
A₉ Rheum formula label

| | |
|---|---|
| Root of Lobed Kudzuvine | 13.91% |
| Herb of Wild Mint | 5.56% |
| Cicade Slough | 2.80% |
| Rhizome of Lalang Grass | 8.30% |
| Safflower | 2.80% |
| Raw Gypsum | 19.42% |
| Root of Indigowoad | 11.1% |
| Rhizome of Asiatic Moonsead | 8.31% |
| Honeysuckle Flower | 5.56% |
| Reed Rhizome | 8.30% |
| Herb of Spreading Hedyotis | 13.91% |
| Total | 100% |

TABLE 134
A₁₀ Coronary heart disease formula label

| | |
|---|---|
| Radix Salviae Miltiorrhizae | 12% |
| Radix Notoginseng | 3% |
| Rhizome of Szechwan Lovage | 9% |
| Safflower | 8% |
| Herb of Shorthorned Epimedium | 10% |
| Root of Lobed Kudzuvine | 7% |
| Root of Twotooth Achyranthes | 8% |
| Ginseng | 12% |
| Root of Mongolian Milkvetch | 12% |
| Fruit of Chinese Magnoliavine | 7% |
| Root of Tuber Fleece flower | 7% |
| Cassia Bark | 5% |
| Total | 100% |

TABLE 135
A₁₁ Diabetes formula label

| | |
|---|---|
| Lucid Ganoderma | 14.81% |
| Fruit of Chinese Magnoliavine | 7.41% |
| Dogger Seed | 5.56% |
| Ginseng | 5.56% |
| Root of Mongolian Milkvetch | 7.41% |
| Figdwort Angelica | 5.56% |
| Chinese Angelica | 7.41% |
| Dendrobium Stem | 5.56% |
| Tree Peony Bark | 7.41% |
| Fruit of Glossy Privet | 5.56% |
| Root of Lobed Kudzuvine | 5.56% |
| Radix Salviae Miltiorrhizae | 7.41% |
| Rhizome of Siberian Solomon seal | 7.41% |
| Root bark of Chinese Wolfberry | 7.41% |
| Total | 100% |

TABLE 136
A₁₂ Dermatosis formula label

| | |
|---|---|
| Dictammus Dasycarpus | 17.14% |
| Fruit of Malaytea Scurfpea | 14.29% |
| Fruit of Common Cnidium | 8.57% |
| Root of Dahurian Angelica | 14.29% |
| Herb of Fineleaf Schizonepeta | 11.43% |
| Adhesive Rehmannia | 8.57% |
| Root of Divaricate Saposhnikovia | 14.29% |
| Herb of Common Andrographis | 11.43% |
| Total | 100% |

TABLE 137
A₁₃ Elevated blo d fat formula label

| | |
|---|---|
| Rhizome of Oriental Waterplantain | 25% |
| Turmeric | 16.67% |
| Fiveleaf Gynostemma | 20.83% |
| Fruit of Glossy Privet | 20.83% |
| Herb of Shorthorned Epimedium | 16.67% |
| Total | 100% |

TABLE 138
A₁₄ Decline of sexual function formula label

| | |
|---|---|
| Male Silk Moth | 62.24% |
| Dried Garden Ginseng | 6.22% |
| Herb of Shorthorned Epimedium | 4.15% |
| Hairy Antler | 1.037% |
| Rhizima Corydalis | 5.15% |
| Fruit of Chinese Magnoliavine | 2.075% |
| Dodder Seed | 2.075% |
| Root of Twotooth Achyranthes | 4.15% |
| Fruit if Common Cnidium | 1.037% |
| Rhizome of Common Curculigo | 3.32% |
| Cassia Bark | 2.075% |
| Seed of Common Fenugreek | 3.32% |
| Fennel Fruit | 1.037% |
| Seed of Tuber Onion | 2.075% |
| Desert living Cistanche | 1.037% |
| Total | 100% |

TABLE 139
A₁₅ Cholecystitis formula label

| | |
|---|---|
| Herb of Christina Loosestrife | 16.39% |
| Herb of Virgate Wormwood | 16.39% |
| Chinese Gentian Herb | 16.39% |
| Root of Baikal Skullcap | 4.92% |
| Root tuber of Aromatic Herb | 4.92% |
| Root of Chinese Thorowax | 8.196% |
| Spores of Japanese Climbing Fern | 6.39% |
| Costusroot | 4.92% |
| Rhizome of Figwortflower Picrorhiza | 8.196% |
| Bank of officinal Magnolia | 3.28% |
| Total | 100% |

TABLE 140
A₁₆ Edema formula label

| | |
|---|---|
| Herb of Christina Loosestrife | 21.74% |
| Herb of Oriental Waterplantain | 21.74% |
| Common Knotgrass | 17.39% |
| Rhizome of Largehead Atractylodes | 21.74% |
| Plantain Seed | 17.39% |
| Total | 100% |

TABLE 141
A₁₇ Fraumatic injury formula label

| | |
|---|---|
| Radix Notoginseng | 24.39% |
| Root of Dahurian Angelica | 14.63% |
| Chinese Angelica | 19.51% |
| Rhizome of Szechwan Lovage | 14.63% |
| Safflower | 12.2% |
| Rhizoma Corydalis | 14.63% |
| Total | 100% |

TABLE 142
A₁₈ Hemorrhoid formula label

| | |
|---|---|
| Copis Root | 1.54% |
| Pod of Japanese Pagodatree | 17.22% |
| Root of Baikal Skullcap | 1.566% |
| Radix Notoginseng | 3.76% |
| Root of Garden Burnet | 6.263% |
| Smoked Plum | 3.131% |
| Chinese Angelica | 29.75% |
| Root of Divaricate Saposhnikovia | 0.78% |
| Bitter Orange | 3.131% |
| Fruit of Medicine Terminalia | 3.131% |
| Pomegranate Rind | 29.77% |
| Total | 100% |

TABLE 143
A₁₉ Hepatitis formula label

| | |
|---|---|
| Root of Chinese Thorowax | 16.61% |
| Herb of Virgate Wormwood | 16.61% |
| Madras Grangea | 11.13% |
| Herb of Heartleaf Houttuynia | 11.13% |
| Rhizome of Giant Knotweed | 11.13% |
| Dandelion | 11.13% |
| Herb of Christina Lossestrife | 11.13% |
| Chinese Gentian Herb | 11.13% |
| Total | 100% |

TABLE 144
A₂₀ Hypertension formula label

| | |
|---|---|
| Fruit spike of Common Selfheal | 13.29% |
| Root of Lobed Kudzuvine | 13.29% |
| Root of Twotooth Achyranthes | 13.29% |
| Gambirplant | 13.29% |
| Adhesive Rehmannia | 6.64% |
| Herb of Common Lophantherum | 13.29% |
| Jointfir | 0.335% |
| Herb of Colored Mistoletoe | 13.29% |
| Root of Baikal Skullcap | 13.29% |
| Total | 100% |

TABLE 145
A₂₁ Diarrhea formula label

| | |
|---|---|
| Hexb of Common Andrographis | 33.3% |
| Root of Lightyellow Sophora | 16.7% |
| Costusroot | 8.33% |
| Howthorn Fruit | 4.7% |
| Ringed Dichanthium | 8.33% |
| Root of Chinese Pulsatilla | 16.7% |
| Total | 100% |

TABLE 146
A₂₂ Pain formula label

| | |
|---|---|
| Rhizoma Corydalis | 68.11% |
| Root of Dahurian Angelica | 31.89% |
| Total | 100% |

TABLE 147
A₂₃ Nehhritis formula label

| | |
|---|---|
| Fruit of Cherokee Rose | 12.31% |
| Dodder Seed | 8.197% |
| Rhizome of Lalang Grass | 7.38% |
| Herb of Yerbadetajo | 7.38% |
| Herb of Heartleaf Houttuynia | 2.31% |
| Fruit of Glossy Privet | 7.38% |
| Lotus Stamen | 4.93% |
| Fruit of Belvedere | 17.94% |
| Rhizome of Oriental Water-plantain | 4.93% |
| Plantain Herb | 4.93% |
| Motherwort Herb | 12.31% |
| Total | 100% |

TABLE 148
A₂₄ Dyspepsia formula label

| | |
|---|---|
| Rhizome of Common Yam | 9.542% |
| Rhizome of Largehead Atractylodes | 9.542% |
| Rhizome of Oriental Waterplantain | 9.542% |
| Jujude | 20% |
| Chinese Angelica | 4.8% |
| Membrane of Chicken Gizzard | 9.542% |
| Root of Tuber Fleeceflower | 9.542% |
| Dried Longan Pulp | 9.542% |
| Immature Bitter Orange | 2.86% |
| Areca Seed | 4.8% |
| Howthorn Fruit | 9.542% |
| Total | 100% |

TABLE 149
A₂₅ Clinmacteric syndrome formula label

| | |
|---|---|
| Motherwort Herb | 17.94% |
| Root of Baikal Skullcap | 2.87% |
| Rhizome of Nutgrass Galingale | 6.10% |
| Chinese Angelica | 6.10% |
| Root of Fourleaf Ladybell | 6.10% |
| Root of Combined Spicebush | 6.10% |
| Rhizome of Largehead Atractylodes | 6.10% |
| Adhesive Rehmannia | 6.10% |
| Root of Tuber Fleeceflower | 6.46% |
| Root of Twotooth Achyranthes | 6.10% |
| Fruit of Lobed Kudzuvine | 6.10% |
| Root-bark of Chinese Worfberry | 6.10% |
| Wood of Chinese Wolfberry | 0.610% |
| Rhizome of Szechwan Lovage | 6.10% |
| Costusroot | 2.87% |
| Dodder Seed | 6.46% |
| Liquorice Root | 1.794% |
| Total | 100% |

TABLE 150
A₂₆ Headache formula label

| | |
|---|---|
| Root of Lobed Kudzuvine | 100% |
| Total | 100% |

TABLE 151
A₂₇ Osteoporosis formula label

| | |
|---|---|
| Rhizome of Fortune's Drynaria | 25% |
| Herb of Shorthorned Epimedium | 12.5% |
| Eucommia Bark | 7.5% |
| Bone Bark | 2.5% |
| Rhizome of Szechwan Lovage | 6.25% |
| Radix Notoginseng | 5% |
| Aculeate Staff-tree | 10% |
| Chinese Angelica | 6.25% |
| Root of Himalayan Teasel | 12.5% |
| Root of Mongolian Milkvetch | 12.5% |
| Total | 100% |

TABLE 152
A₂₈ Obesity formula label

| | |
|---|---|
| Leaf of Dogbane | 12.82% |
| Rhizome of Oriental Waterkplantain | 10.26% |
| Lotus Leaf | 10.26% |
| Vegetable Sponge of Luffa | 10.26% |
| Rhizome of Szechwan Lovage | 10.26% |
| Howthorm Fruit | 10.26% |
| Pokeberry Root | 5.13% |
| Root of Fourstamen Stephania | 10.26% |
| Read Rhizome | 10.26% |
| Herb of Longtube Ground Ivy | 10.26% |
| Total | 100% |

TABLE 153
A₂₉ Hyperplasia of mammary glands formula label

| | |
|---|---|
| Dandelion | 14.6% |
| Spine of Chinese Honeylocust | 9.73% |
| Radix Salviae Miltiorrhizae | 14.6% |
| Radix Notoginseng | 7.08% |
| Safflower | 5.31% |
| Figwort Root | 9.73% |
| Seed of Cowherb | 9.73% |
| Stem of Suberect Spatholobus | 14.6% |
| Root of Uniflower Swisscentaury | 14.6% |
| Total | 100% |

TABLE 154
A₃₀ Cough formula label

| | |
|---|---|
| Tangerine Peel | 13.17% |
| Root of Baikal Skullacap | 13.17% |
| Bark of Chinese Corktree | 13.17% |
| Root of Sessile Stemona | 9.88% |
| Jack in the Pulpit Tuber | 4.53% |
| Perilla Seed | 6.584% |
| Root of Whiteflower Hogfennel | 2.4% |
| Apricot Kernel | 6.584% |
| Ephedra | 6.584% |
| Platycodon Root | 6.584% |
| Root-bark of White Mulberry | 6.584% |
| Liquorice Root | 6.584% |
| Total | 100% |

TABLE 155
A₃₁ Stomach pain formula label

| | |
|---|---|
| Root of Chinese Thorowax | 15.87% |
| Root of Coastal Gehnia | 4.76% |
| Zedoray | 4.76% |
| Liquorice Root | 9.523% |
| Rhizome of Nutgrass Galingale | 4.76% |
| Costusroot | 12.7% |
| Root of Baikal Skullcap | 15.87% |
| Root of Shinyleaf Pricklyash | 15.87% |
| Rhizoma Corydalis | 15.87% |
| Total | 100% |

TABLE 156
A₃₂ Menalgia formula label

| | |
|---|---|
| Chinese Angelica | 10.81% |
| Radix Salviae Miltiorrhizae | 8.11% |
| Prepared Rhizome of Adhesive Rehmannia | 10.81% |
| Rhizoma Corydalis | 16.22% |
| Safflower | 5.41% |
| Motherwort Herb | 32.43% |
| Rhizome of Szechwan Lovage | 4.054% |
| Cassia Bark | 1.351% |
| Costusroot | 1.351% |
| Rhizome of Nutgrass Galingale | 8.11% |
| Dried Ginger | 1.351% |
| Total | 100% |

TABLE 157
A₃₃ Prostatic hyperplasia formula label

| | |
|---|---|
| Herb of Chinese Siphonostegia | 50% |
| Lotus Stamen | 50% |
| Total | 100% |

TABLE 158
A₃₄ Haryngitis formula label

| | |
|---|---|
| Root of Baikal Skullcap | 12% |
| Capsule of Weeping Forsythia | 20% |
| Flower of Indian Dendranthema | 15% |
| Buffalo Horn | 10% |
| Spine of Chinese Honeylocust | 4.5% |
| Rhubarb | 4.5% |
| Herb of Fineleaf Schizonepeta | 15% |
| Figwort Root | 15% |
| Wesps Nest | 4% |
| Total | 100% |

TABLE 159
A₃₅ Hyperosteogeny formula label

| | |
|---|---|
| Safflower | 4.504% |
| Root of Doubleteeth Pubscent Angelica | 9.01% |
| Root of Twotooth Achyranthes | 7.21% |
| Root of Dahurian Angelica | 5.41% |
| Root of Lobed Kudzuvine | 7.21% |
| Rhizome of Fortune's Drynaria | 7.21% |
| Chinese Angelica | 5.41% |
| Rhizome of Szechwan Lovage | 7.21% |
| Root of Divaricate Saposhnikovia | 7.21% |
| Root of Largeleaf Gentian | 7.21% |
| Rhizoma Corydalis | 9.01% |
| Root of Himalayan Teasel | 7.21% |
| Herb of Shorthorned Epimedium | 9.01% |
| Root of Chinese Clematis | 7.21% |
| Total | 100% |

TABLE 160
A₃₆ Rhinitis formula label

| | |
|---|---|
| Fruit of Siberian Cocklebur | 23.9% |
| Flower of Indian Dendranthema | 9.514% |
| Herb of Small Centipeda | 14.3% |
| Root of Dahurian Angelica | 7.15% |
| Liquorice Root | 4.79% |
| Fruit of Puncturesine Caltrop | 14.3% |
| Root of Divaricate Saposhnikovia | 7.15% |
| Herb of Yerbadetajo | 14.3% |
| Arisaema with Bile | 4.6% |
| Total | 100% |

TABLE 161
A₃₇ Sequela of apoplexy formula label

| | |
|---|---|
| Rhizome of Grassleaf Sweetflag | 25% |
| Red Peony Root | 17% |
| Earth-worm | 17% |
| Radix Codonopsis | 25% |
| Leech | 17% |
| Total | 100% |

TABLE 162
A₃₈ Presenility formula label

| | |
|---|---|
| Radix Codonopsis | 23.05% |
| Root of Mongolian Milkvetch | 7.2% |
| Rhizome of Largehead Atractylodes | 3.63% |
| Root of Twotooth Achyranthes | 7.191% |
| Fruit of Chinese Magnoliavine | 2.86% |
| Eucommia Bark | 3.63% |
| Adhesive Rehmannia | 4.3% |
| Chinese Angelica | 4.55% |
| Rhizome of Szechwan Lovage | 3.63% |
| Root of Divaricate Saposhnikovia | 3.63% |
| Tuber of Dwarf Liliturf | 3.63% |
| Rhizome or root of Incised Notopterygium | 2.86% |
| Herb of Shorthorned Epimedium | 7.2% |
| Cassia Bark | 2.86% |
| Fruit of Barbary Wolfberry | 3.63% |
| Prepared Rhizome of Adhesive Rehmannia | 5.38% |
| Tangerine Peel | 3.63% |
| Root of Tuber Fleece flower | 7.2% |
| Total | 100% |

TABLE 163
A₃₉ Low grade fever formula label

| | |
|---|---|
| Rhizome of Common Anemarrhena | 6.9% |
| Bark of Chinese Corktree | 6.9% |
| Prepared Rhizome of Adhesive Rehmannia | 27.6% |
| Fruit of Asiatic Cornelian Cherry | 13.8% |
| Tree Peony Bark | 10.34% |
| Root-bark of Chinese Wolfberry | 13.8% |
| Rhizome of Oriental Waterplantain | 10.34% |
| Fruit of Chinese Magnoliavine | 10.34% |
| Total | 100% |

TABLE 164
A₄₀ Carbuncle and sore formula label

| | |
|---|---|
| Capsule of Weeping Forsythia | 15.2% |
| Figwort Root | 15.2% |
| Coptis Root | 1.27% |
| Adhesive Rehmannia | 12.7% |
| Root of Baikal Skullcap | 15.2% |
| Achene of Great Burdock | 12.7% |
| Red Peony Root | 12.7% |
| Rhizome of Common Anemarrhena | 10.13% |
| Concentrated Powder from Buffalo Horn | 5.06% |
| Total | 100% |

TABLE 165
B₁ Pangent warm diaphoretic formula label

| | |
|---|---|
| Ephedra | 20% |
| Cassia Twig | 27% |
| Root of Divaricate Saposhnikovia | 33% |
| Liquorice Root | 20% |
| Total | 100% |

TABLE 166
B₂ Pungent cool diaphoresis formula label

| | |
|---|---|
| Herb of Wild Mint | 19% |
| Mulberry Leaf | 31% |
| Chrysanthemum | 25% |
| Capsule of Weeping Forsythia | 25% |
| Total | 100% |

TABLE 167
B₃ Clearing away heat and purging pathogenic fire formula label

| | |
|---|---|
| Rhizome of Common Anemarrhena | 23.5% |
| Fruit-spike of Common Selfheal | 29.5% |
| Reed Rhizome | 23.5% |
| Ringed Dichanthium | 23.5% |
| Total | 100% |

TABLE 168
B₄ Inducing diuresis and resolving heat formula label

| | |
|---|---|
| Rhizome of Lalang Grass | 31% |
| Rhizome of Swordlike A | 25% |
| Bark of Chinese Corktree | 25% |
| Root of Twotooth | 19% |
| Total | 100% |

TABLE 169
B₅ Clearing away the heat and cooling the blood formula label

| | |
|---|---|
| Dried Rhizome of Rehmannia | 31% |
| Red Peony Root | 19% |
| Tree Peony Bark | 25% |
| Radix Salviae Miltiorrhizae | 25% |
| Total | 100% |

TABLE 170
B₆ Clearing away the heat and toxic materials formula label

| | |
|---|---|
| Coplis Root | 21.5% |
| Bark of Chinese Corktree | 21.5% |
| Fruit of Cape Jasmine | 21.5% |
| Root of Baikal Skullcap | 35.5% |
| Total | 100% |

TABLE 171
B₇ Nourishing yin and clearing away the fire formula label

| | |
|---|---|
| Startwort Root | 24% |
| Root-bark of Chinese Wolfberry | 24% |
| Rhizome of Common Anemarrhena | 24% |
| Herb of Sweet Wormwood | 28% |
| Total | 100% |

TABLE 172
B₈ Promoting digestion and resolving stagnation formula label

| | |
|---|---|
| Howthorn Fruit | 21.5% |
| Radish Seed | 35.5% |
| Membrane of Chicken Gizzard | 21.5% |
| Bark of Officinal Magnolia | 21.5% |
| Total | 100% |

TABLE 173
B₉ Expelling wind to regulate meridian formula label

| | |
|---|---|
| Radix Salviae Miltiorrhizae | 19% |
| Root of Fourstamen Stephania | 19% |
| Root of Largeleaf Gentian | 19% |
| Root of Divaricate Saposhnikovia | 23.1% |
| Stem of Suberect Spatholobus | 19% |
| Total | 100% |

TABLE 174
B₁₀ Clearing away summer heat and excreting damp formula label

| | |
|---|---|
| Rhizome of Swordlike Atractylodes | 45.5% |
| Herb of Wrinkled Gianthyssop | 27% |
| Herb of Fortune Eupatorium | 27% |
| Total | 100% |

TABLE 175
B₁₁ Regulating qi to promote diuresis formula label

| | |
|---|---|
| Rhizome of Oriental Waterplantain | 31% |
| Plantain Seed | 25% |
| Rhizome of Largehead Atractylodes | 25% |
| Cassia Twig | 19% |
| Total | 100% |

TABLE 176
B₁₂ Warming middle-heater to eliminate damp formula label

| | |
|---|---|
| Dried Ginger | 33% |
| Rhigome of Largehead Atractylodes | 27% |
| Fruit of Medicinal Evodia | 20% |
| Liquorice Root | 20% |
| Total | 100% |

TABLE 177
B₁₃ Regulating qi and invigorating the distending formula label

| | |
|---|---|
| Costusroot | 33% |
| Rhizome of Nutgrass Galingale | 27% |
| Bark of Officinal Magnolia | 20% |
| Liquorice Root | 20% |
| Total | 100% |

TABLE 178
B₁ Promoting circulation f gi and blood formula label

| | |
|---|---|
| Root-tuber of Aromatic Turmeric | 25% |
| Radix Salviae Miltiorrhizae | 31% |
| Rhizoma Corydalis | 25% |
| Fruit of Szechwan Chinaberry | 19% |
| Total | 100% |

TABLE 179
B₁₅ Activating blood and eliminating
the sedimentation formula label

| | |
|---|---|
| Rhizome of Szechwan Lovage | 20% |
| Radix Salviae Miltiorrhizae | 33% |
| Safflower | 20% |
| Rhizoma Corydalis | 27% |
| Total | 100% |

TABLE 180
B₁₆ Purging phlem heat formula label

| | |
|---|---|
| Fritillary | 30% |
| Tuber of Pinellia | 23% |
| Root of Baikal Skullcap | 30% |
| Rhizome of Common Anemarrhena | 17% |
| Total | 100% |

TABLE 181
B₁₇ Clearting the liver and enriching the spleen formula label

| | |
|---|---|
| Root of Chinese Thorowax | 25% |
| Costusroot | 25% |
| Rhizome of Nutgrass Galingale | 31% |
| Rhizome of Szechwan Lovage | 19% |
| Total | 100% |

TABLE 182
B₁₈ Promoting digestion and cathasis formula label

| | |
|---|---|
| Ginseng | 25% |
| Root of Mongolian Milkvetch | 31% |
| Rhizome of Largehead Atractylodes | 25% |
| Root of Chinese Thorowax | 19% |
| Total | 100% |

TABLE 183
B₁₉ Warming kidney to activate yang formula label

| | |
|---|---|
| Herb of Shorthorned Epimedium | 33% |
| Desertliving Cistanche | 20% |
| Rhizome of Common Curculigo | 20% |
| Root of Medicinal Indian Mulberry | 27% |
| Total | 100% |

TABLE 184
B₂₀ Tonifying qi and blood formula label

| | |
|---|---|
| Chinese Angelice | 28% |
| Root of Tuber Fleeceflower | 22% |
| Root of Mongolian Milkvetch | 28% |
| Ginseng | 22% |
| Total | 100% |

TABLE 185
B₂₁ Stimuting circulation to end stasis formula label

| | |
|---|---|
| Upright Ladybell | 30% |
| Tuber of Dwarf Lilyturf | 23% |
| Rhizome of Fragrant Solomonseal | 17% |
| Rhizome of Siberian Solomonseal | 30% |
| Total | 100% |

TABLE 186
B₂₂ Restraining the hyperactivity of the liver-yang formula label

| | |
|---|---|
| Gambirplant | 33% |
| Tuber of Tall Gastrodia | 20% |
| Fruit-spike of Common Selfheal | 27% |
| Chrysanthemum | 20% |
| Total | 100% |

TABLE 187
B₂₃ N urishing yin and preserving one' s health formula label

| | |
|---|---|
| Radix Codonopsis | 25% |
| Seed of Spine Date | 25% |
| Radix Salviae Miltiorrhizae | 31% |
| Root of Thinleaf Milkwort | 19% |
| Total | 100% |

TABLE 188
B₂₄ Invigorating the liver and kidney formula label

| | |
|---|---|
| Prepared Rhizome of Adhesive Rehmannia | 33% |
| Pulp of Asiatic Cornelian Cherry | 20% |
| Fruit of Barbary Wolfberry | 20% |
| Chinese Angelica | 27% |
| Total | 100% |

TABLE 189
B₂₅ Streng thening the spleen and
tonifying the kidney formula label

| | |
|---|---|
| Ginseng | 22% |
| Root of Mongolian Milkvetch | 28% |
| Rhizome of Largehead Atractylodes | 22% |
| Herb of Shorthomed Epimedium | 28% |
| Total | 100% |

TABLE 190
B₂₆ Drying damp and eliminating phlegm formula label

| | |
|---|---|
| Tuber of Pinellia | 25% |
| Fritillary | 25% |
| Tangerine Peel | 19% |
| Root of Sessile Stemona | 31% |
| Total | 100% |

TABLE 191
B₂₇ Clearing liver and benefiting gallbladder formula label

| | |
|---|---|
| Chinese Gentian Herb | 33% |
| Root of Chinese Thorowax | 20% |
| Root of Baikal Skullcap | 27% |
| Fruit of Cape Jasmine | 20% |
| Total | 100% |

TABLE 192
B₂₈ Nourishing yin and purging fire formula label

| | |
|---|---|
| Rhizome of Common Anemarrhena | 31% |
| Bark of Chinese Corktree | 25% |
| Herb of Sweet Wormwood | 25% |
| Tree Peony Bark | 19% |
| Total | 100% |

TABLE 193
B₂₉ Dispelling coldness regulate the meridians formula label

| | |
|---|---|
| Stem of Suberect Spatholobus | 30% |
| Cassia Twig | 17% |
| Radix Salviae Miltiorrhizae | 30% |
| Tree Peony Bark | 23% |
| Total | 100% |

TABLE 194
B₃₀ Promoting digestion and resolving stagnation formula label

| | |
|---|---|
| Chinese Angelica | 31% |
| Dried Rhizome of Rehmannia | 25% |
| Hemp Seed | 25% |
| Senna Leaf | 19% |
| Total | 100% |

### DETAILED DESCRIPTION OF THE INVENTION

1. A network hospital method to classify the diagnosed disease detailedly includes electronic software dictionary content on the screen and concrete health information system by knocking keyboard. It is characterized in the 40 kinds of disease; symptom of 40 kinds of disease; one of the symptoms among the 40 kinds of disease; detail classification type and treatment principle of one of the 40 kinds of diseases; treatment formula label of 40 kinds of diseases; figure, phrases, words description of treatment formula label of 30 kinds of classification listed in the contents on the screen, number and determine the position respectively as per characters on the keyboard. Knocking screen number 1-40 can open the information base EMS memory, pick up necessary information and obtain health result.

2. According to the description of detailed description of the invention, “A network hospital method to classify the diagnosed disease detailedly”, which can apply and outspread the information to obtain personal health consulting results by two special facilities. The aforesaid facilities are computer processing device, storage device, displayer, keyboard. Use computer to handle facilities to make a dictionary-like, figures and words description for 40 diseases (Form 3), symptoms of 40 diseases (Form 4-Form 43), reclassificatory symptoms of 40 diseases (Form 44-Form 83), classification and tailored treatment principle of 40 diseases (Form 84-Form 123), intelligent treatment plan of one disease as an example after being classified (Form 124), health supplementary formula label for 40 diseases treatment (Form 125-Form 164), health supplementary formula label for 30 types classification treatment (Form 165-Form 194) in the storage device data base, realize correspondence by knocking the code and keyboard and pick up and inquire individual healthy information and results.

3. The following procedure starts from filling “apply to enter network hospital member list (form 1)”. Fill in form 1, after obtaining network hospital member qualification and member code, input the member code, knock “OK” on the keyboard, personal description form of members (form 2) can be obtained. Fill in the personal description form of members, knock “OK”, 40 kinds of diagnosed diseases form can be obtained (form 3).

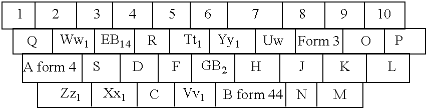

Knocking A on the keyboard will show A₁-t₁u₁y₁w₁x₁y₁z₁i₁ (form 4)
Knocking T, U, V, W, X, Z, I on the keyboard will show A₁ (form 3)
Knocking A on the keyboard will show A₁ formula label words (form 125)
Knocking OK on the keyboard will show A₁-a₁b₁c₁d₁e₁f₁g₁h₁i₁j₁k₁l₁m₁n₁o₁p₁q₁r₁s₁ figure and words (form 44).
Knocking ABGH on the keyboard will show E₁ G₁ figure and words (form 84)
Knocking EG on the keyboard will show B₂B₁₄ figure and words (form 124)
Knocking B₂ on the keyboard will show B₂ formula label words (form 166)
Knocking B₁₄ on the keyboard will show B₁₄ formula label words (form 178)
Knocking OK on the keyboard will confirm the combination of healthy supplementary things of A₁, B₂, B₁₄.

1. I claim “a sort of network hospital method of reclassifying the diseases which have been diagnosed” as my invention:
I think my invention is concrete healthy information appearing on the screen, dictionary contents of electric software, and keyboard knocking, and reclassify the diseases which have been diagnosed by computer device and keyboard to obtain the result of treatment.
I think the characters of my invention are to use computer processing device, storage device, displayer, keyboard to make a dictionary-like description for 40 diseases (Form 3), symptoms of 40 diseases (Form 4-Form 43), reclassificatory symptoms of 40 diseases (Form 44-Form 83), classification and tailored treatment principle of 40 diseases (Form 84-Form 123), treatment plan of one disease as an example after being classified (Form 124), formula label for 40 diseases treatment (Form 125-Form 164), formula label for 30 types classification treatment (Form 165-Form 194) in the storage device data base, number these information to code by knocking the code and keyboard, picking up and inquiring individual healthy result, by which has solved treatment for patients with same disease but different symptoms by intelligentization, and this innovates a medical scientific system.
